(19) United States
(12) Patent Application Publication
(10) Pub. No.: US 2023/0200480 A1
(43) Pub. Date: Jun. 29, 2023

(54) STRUCTURALLY-COLORED ARTICLES AND METHODS FOR MAKING AND USING STRUCTURALLY-COLORED ARTICLES

(71) Applicant: NIKE, Inc., Beaverton, OR (US)

(72) Inventors: Jeremy Gantz, Lake Oswego, OR (US); Kim Kovel, Portland, OR (US); Yuanmin Wang, Portland, OR (US)

(21) Appl. No.: 17/660,682

(22) Filed: Apr. 26, 2022

Related U.S. Application Data
(60) Provisional application No. 63/266,130, filed on Dec. 29, 2021.
(60) Provisional application No. 63/266,133, filed on Dec. 29, 2021.
(60) Provisional application No. 63/266,135, filed on Dec. 29, 2021.

(51) Int. Cl. A43B 1/00; A41D 13/01; A41D 31/32; A42B 1/009

(52) U.S. Cl. CPC A43B 1/0027; A41D 13/01; A41D 31/325; A42B 1/009

(57) ABSTRACT

As described above, one or more aspects of the present disclosure provide articles having structural color, and methods of making articles having structural color. The present disclosure provides for articles that exhibit structural colors using one or more optical elements. The optical element(s) is disposed on a substrate (e.g., the surface of the article) and when exposed to visible light, the optical element imparts a structural color to the article, where the structural color (e.g., single color, multicolor such as iridescent) is visible color produced, at least in part, through optical effects (e.g., through scattering, refraction, reflection, interference, and/or diffraction of visible wavelengths of light). Different optical elements can impart the same or different structural colors.

### CLAIM OF PRIORITY TO RELATED APPLICATION

This application claims the benefit of and priority to U.S. Provisional Application Serial No. 63/266,130, having the title “STRUCTURALLY-COLORED ARTICLES AND METHODS FOR MAKING AND USING STRUCTURALLY-COLORED ARTICLES”, filed on Dec. 29, 2021, the contents of which is hereby incorporated by reference in its entirety.

In addition, this application claims the benefit of and priority to U.S. Provisional Application Serial No. 63/266,133, having the title “STRUCTURALLY-COLORED ARTICLES AND METHODS FOR MAKING AND USING STRUCTURALLY-COLORED ARTICLES”, filed on Dec. 29, 2021, the contents of which is hereby incorporated by reference in its entirety.

In addition, this application claims the benefit of and priority to U.S. Provisional Application Serial No. 63/266,135, having the title “STRUCTURALLY-COLORED ARTICLES AND METHODS FOR MAKING AND USING STRUCTURALLY-COLORED ARTICLES”, filed on Dec. 29, 2021, the contents of which is hereby incorporated by reference in its entirety.

### BACKGROUND

Structural color is caused by the physical interaction of light with the micro- or nano-features of a surface and the bulk material as compared to color derived from the presence of dyes or pigments that absorb or reflect specific wavelengths of light based on the chemical properties of the dyes or pigments. Color from dyes and pigments can be problematic in a number of ways. For example, dyes and pigments and their associated chemistries for fabrication and incorporation into finished goods may not be environmentally friendly.

### BRIEF DESCRIPTION OF THE DRAWINGS

Further embodiments of the present disclosure will be more readily appreciated upon review of the detailed description of its various embodiments, described below, when taken in conjunction with the accompanying drawings.

FIGS. 1A-1M shows various articles of footwear, apparel, athletic equipment, container, electronic equipment, and vision wear that include the primer layer in accordance with the present disclosure, while FIG. 1N(a)-1Q(e) illustrate additional details regarding different types of footwear.

FIGS. 2A and 2B are transverse cross-section illustrations of optical element having a textured surface and a substantially flat surface, respectively.

FIG. 3A is a top view of a substrate having multiple optical elements disposed thereon. FIG. 3B illustrates an expanded region of the substrate in FIG. 3A, where the expanded region illustrates the top view of the main body and transition region of the optical element and the underlying substrate.

FIG. 4A illustrates an expanded view of the A-A cross-section (top) shown in FIG. 3B and the expanded view of the top view (bottom).

FIG. 4B illustrates an expanded view of the B-B cross-section (top) shown in FIG. 3B and the expanded view of the top view (bottom).

FIG. 4C illustrates an expanded view of the C-C cross-section (top) shown in FIG. 3B and the expanded view of the top view (bottom).

### DESCRIPTION

The present disclosure provides for articles that exhibit structural colors using one or more optical elements. The optical element(s) is disposed on a substrate (e.g., the surface of the article) and when exposed to visible light, the optical element imparts a structural color to the article, where the structural color (e.g., single color, multicolor such as iridescent) is visible color produced, at least in part, through optical effects (e.g., through scattering, refraction, reflection, interference, and/or diffraction of visible wavelengths of light). Different optical elements and/or different regions of the optical element can impart the same or different structural colors.

The optical element can include a main body and at the edge of the optical element there is a transition region, where the main body has a main body color (e.g., a first structural color) and the transition region has a transition region color (e.g., structural color or non-structural color) that can change relative to the main body color due to the change in the number and/or thickness of the optical layers of the optical element in the transition region versus the main body. Thus, while the main body of the optical element and the transition region share some structural features (e.g., one or more optical layers), the transition region can have a different color than the main body of the optical element.

The transition region can be formed during the process of forming the optical element (e.g., using a mask, reaching the limiting of the deposition process, and the like), where the edges of the optical element having a different number and/or thickness of the optical layers that make up the main body of the optical element. In addition to or in the alternative, the transition region can be formed through an abrasive force that has removed part of the optical element so the transition region has a different number and/or thickness of the optical layers that make up the main body of the optical element. The transition region can have a relatively narrow width that can be less than 1 millimeter wide or wider, for example about 1 to 5 millimeter wide, while the length can be in the centimeter range (e.g., about 1 to 100 centimeters) or more. The transition region can be different than the main body of the intact optical element in one or more of the following ways: the number of layers, the thickness of the layers, or the width of the layers. The combination of these differences can contribute to the color of the transition region.

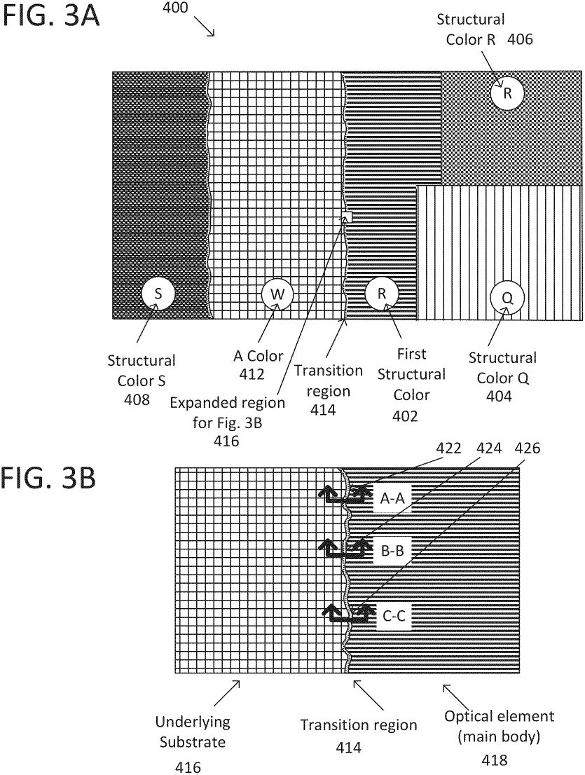

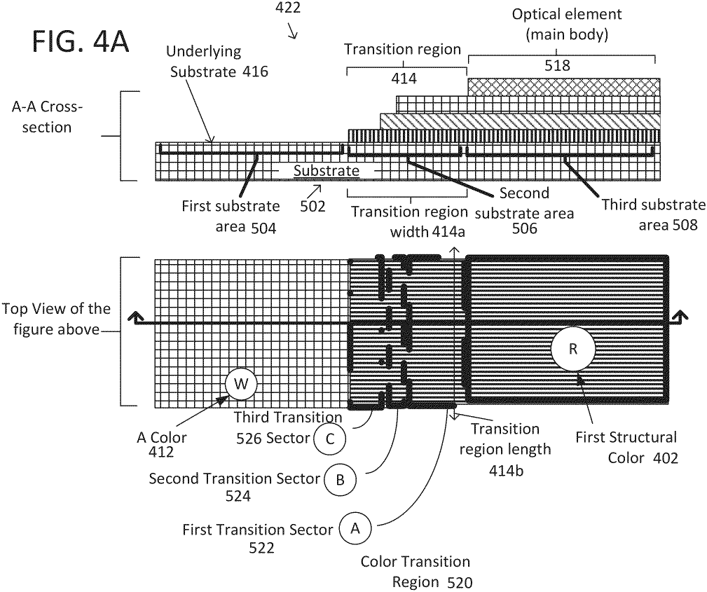

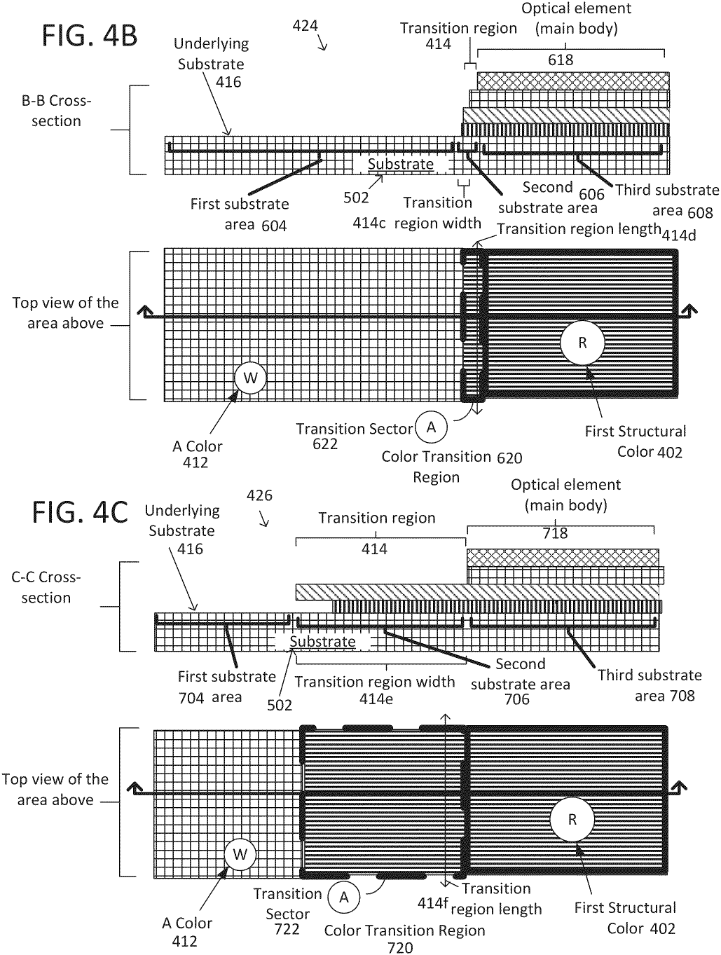

Also, the differences between the main body and the transition region can vary as a function of the length and/or width of the transition region. For example, along the length of the transition region there can be a first transition region, a second transition region, and so on (See FIG. 3B, and cross-sections A-A 422, B-B 424, and C-C 426), where each region can include one or more of the differences described above and herein and each region can have its own color (e.g., structural color or non-structural color). In another example, along the width of each transition region (e.g., the first transition region), the transition region can include a first transition sector, a second transition sector, and so on (See FIG. 4A, top view of the A-A cross-section), where each sector can include one or more of the differences described above and herein and each sector can have its own color (e.g., structural color or non-structural color). The result can be an aesthetically pleasing appearance.

The substrate has a first color (e.g., the color of the surface of the substrate). The main body of the optical element has a main body color (e.g., structural or non-structural color) and the transition region of the optical element has a transition region color (e.g., structural or non-structural color), where the transition region color can vary along the length and/or width of the transition region. The structural color(s) imparted by the main body of the optical element, the transition region color and the first color attributed to the substrate can be different in one or more of a hue, a value, a chroma, or any combination thereof when viewed from the same angle of observation from someone with 20 20 visual acuity from a distance of about 1 meter from the article under the same lighting conditions. In another aspect, the structural color(s) imparted by the main body of the optical element and the transition region color may be the same or similar at one observation angle and then different at another observation angle (e.g., at an able that is about 30 degrees, about 45 degrees, or about 60 degrees (e.g., about 30 to 60 degrees) different than the first observation angle) in a hue, a value, a chroma, or any combination thereof when viewed by someone with 20 20 visual acuity from a distance of about 1 meter from the article under the same lighting conditions.

The main body of the optical element can include two or more layers (e.g., a reflective layer(s), a constituent layer(s), and the like). The main body of the optical element is adjacent the transition region of the optical element, where the transition region includes at least one fewer layers than the main body of the optical element, where at least one layer is of the main body and the transition region are made of the same material. The main body and/or the transition region of the optical element can be a multilayer reflector or a multilayer filter.

In addition, the optical element can include an optional textured surface, where the optical element is disposed on a surface of the article with the optional textured surface between the optical element and the surface or where the textured surface is part of the optical element, depending upon the design. The combination of the optical element and the optional textured surface can impart structural color (e.g., and optionally the second structural color) to the article, where the first structural color can be designed to be different than the color of the components of the optical element and/or the underlying material.

The article can be a finished article such as, for example, an article of footwear, apparel or sporting equipment. The article can be a component of an article of footwear, apparel or sporting equipment, such as, for example, an upper or a sole for an article of footwear, a waistband or arm or hood of an article of apparel, a brim of a hat, a portion of a backpack, or a panel of a soccer ball, and the like. The optical element can be disposed on the surface so that the optical element is parallel or substantially parallel the surface (e.g., the plane of the optical element is parallel the plane of the surface of the article) (also referred to as “in-line”, or “in-line” configuration) or so that the optical element is perpendicular or substantially perpendicular the surface (also referred to as the optical element laying “on its side”, or “on its side” configuration). The optical element that is on the opposite side from the surface of the article and optionally on the other exposed sides of the article where visible light can contact.

The optical element can be disposed (e.g., affixed, attached, adhered, bonded, joined) on a surface of one or more components of the footwear, such as on the shoe upper and/or the sole. The optical element can be incorporated into the sole by incorporating it into a cushioning element such as a bladder or a foam. The sole and/or upper can be designed so that one or more portions of the optical element are visible in the finished article, by including an opening, or a transparent component covering the optical element, and the like.

The present disclosure provides for an article comprising: a substrate on at least a portion of an exterior-facing surface of the article, the substrate having a first surface and an opposing second surface, wherein the first surface of the substrate includes a first substrate area, a second substrate area, and a third substrate area, each of which is distinct from the other, wherein the first substrate area has a first substrate area color; an optical element comprising two or more optical layers, wherein the optical element is disposed on the first surface of the substrate in the second substrate area and the third substrate area, wherein the optical element includes an optical element main body disposed on the third substrate area and a transition region disposed on the second substrate area, wherein the optical element main body imparts a main body color to the third substrate area and the transition region imparts a transition region color to the second substrate area, and wherein the main body color is a first structural color; and wherein the main body color and the transition region color differ in at least one of hue, value, and chroma when illuminated under the same lighting conditions at the same observation angle, or wherein the main body color and the transition region color differ in at least one of hue, value and chroma when illuminated under the same lighting conditions at different two different observation angles at least 60 degrees apart, or both.

The present disclosure will be better understood upon reading the following numbered aspects, which should not be confused with the claims. Any of the numbered aspects below can, in some instances, can be combined with aspects described elsewhere in this disclosure and such combinations are intended to form part of the disclosure.

Aspect 1. An article comprising:
a substrate on at least a portion of an exterior-facing surface of the article, the substrate having a first surface and an opposing second surface, wherein the first surface of the substrate includes a first substrate area, a second substrate area, and a third substrate area, each of which is distinct from the other, wherein the first substrate area has a first substrate area color;
an optical element comprising two or more optical layers, wherein the optical element is disposed on the first surface of the substrate in the second substrate area and the third substrate area, wherein the optical element includes an optical element main body disposed on the third substrate area and a transition region disposed on the second substrate area, wherein the optical element main body imparts a main body color to the third substrate area and the transition region imparts a transition region color to the second substrate area, and wherein the main body color is a first structural color; and
wherein the main body color and the transition region color differ in at least one of hue, value, and chroma when illuminated under the same lighting conditions at the same observation angle, or
wherein the main body color and the transition region color differ in at least one of hue, value and chroma when illuminated under the same lighting conditions at different two different observation angles at least 60 degrees apart, or both.

Article 2. The article of article 1, wherein the difference in at least one of the hue, the value, and the chroma of the main body color and the transition region color are detectable when the article is viewed by someone with 20/20 visual acuity from a distance of about 1 meter from the article.

Aspect 3. The article of aspect 1 or 2, wherein the transition region color is a second structural color.

Aspect 4. The article of any preceding aspect, wherein the transition region of the optical element includes at least one less optical layer than the main body of the optical element, or the transition region includes at least one optical layer having a thinner cross-sectional height than a corresponding optical layer of the main body optical element, or both.

Aspect 5. The article of any preceding aspect, wherein the first substrate area color differs from the main body color, or differs from the transition region color, or differs from both the main body color and the transition region color, in at least one of hue, value and chroma.

Aspect 6. The article of any preceding aspect, wherein the first substrate area abuts the second substrate area and the third substrate area abuts the second substrate area on the side opposite of the first substrate area.

Aspect 7. The article of any preceding aspect, wherein the second substrate area is spaced apart from the third substrate area

Aspect 8. The article of any preceding aspect, wherein the article includes exposed first substrate area is between the first substrate area and the second substrate area.

Aspect 9. The article of any preceding aspect, wherein the transition region includes at least two fewer optical layers than the main body of the optical element.

Aspect 10. The article of any preceding aspect, wherein the transition region includes only one optical layer.

Aspect 11. The article of any preceding aspect, wherein the transition region is less than 1 millimeter wide.

Aspect 12. The article of any preceding aspect, wherein the transition region is about 1 to 35 centimeters wide or about 1 to 10 centimeters wide.

Aspect 13. The article of any preceding aspect, wherein the transition region is about 1 to 10 millimeters wide or about 1 to 5 millimeters wide or about 1 to 3 millimeters wide.

Aspect 14. The article of any preceding aspect, wherein the transition region includes a first transition region and a second transition region along the length of the transition region, wherein first transition region and the second transition region are different in one or more of the following: the number of layers, the thickness of the layers, the width of the layers.

Aspect 15. The article of any preceding aspect, wherein the transition region includes a first transition region and a second transition region, wherein the first transition region has a first transition region color and a second transition region has a second transition region color, wherein the first transition region color and the second transition region color differ (optionally wherein the first transition region color, the second transition region color or both is a structural color) in a hue, a value, a chroma, or any combination thereof when viewed by someone with 20 20 visual acuity from a distance of about 1 meter from the article under the same lighting conditions and from the same observation angle.

Aspect 16. The article of any one of the aspects herein, wherein the first transition region has a first transition sector that has a first transition sector color, optionally wherein the first transition region has a second transition sector that has a second transition sector color, wherein a first side of the first transition sector abuts the main body of the optical element and the second transition sector is on a second side of the first transition sector that is opposite the first side of the first transition sector, wherein the first transition sector color and the second transition sector color are different in a hue, a value, a chroma, or any combination thereof when viewed by someone with 20 20 visual acuity from a distance of about 1 meter from the article under the same lighting conditions and from the same observation angle.

Aspect 17. A method of making an aspect, comprising: disposing the optical element of any one of articles 1 to 16 onto the surface of the article.

Aspect 18. An article comprising: a product of the method of aspect 17.

Aspect 19. A method of making an article, comprising:

disposing, applying or positioning an optical element as described in aspects 1 to 16 onto the surface of a substrate.

Aspect 20. An article comprising: a product of the method of aspect 19.

Aspect 21. The methods and/or articles of any one of the aspects, wherein the optical element is a single layer reflector, a single layer filter, a multilayer reflector or a multilayer filter.

Aspect 22. The methods and/or articles of any one of the aspects, wherein the optical element (e.g., main body of the optical element) includes at least two layers (optionally the transition region has at least one less layer than the optical element), optionally wherein the at least two layers includes at least one constituent layer, optionally wherein the at least two layers includes at least one reflective layer, optionally wherein the at least two layers includes at least one constituent layer and at least one reflective layer, optionally wherein the one or more layers of the transition region has a corresponding layer of the optical element (main body).

Aspect 23. The methods and/or articles of any one of the aspects, wherein the optical element is selected from an inorganic optical element, an organic optical element, or a mixed inorganic/organic optical element, optionally wherein the transition region is selected from an inorganic transition region, an organic transition region, or a mixed inorganic/organic transition region; optionally, wherein the organic optical element has at least two layers or the organic transition region has one less layer than the organic optical element, where these are made of an organic material, optionally wherein the at least two layers are made of a non-metal or non-metal oxide or non-alloy material, optionally, wherein at least two layers are made of a polymeric material (optionally a synthetic polymeric material), optionally wherein the at least two layers are made of an organic material that does not include a metal or metal oxide or alloy, optionally wherein the at least two layers are made of a polymeric (optionally a synthetic polymeric material) that does not include a metal or metal oxide or alloy, optionally wherein at least two layers are made of stainless steel.

Aspect 24. The methods and/or articles of any one of the aspects, wherein the optical element (main body) has 1 to 20 layer, 2 to 20 layers, 3 to 20 layer, 4 to 20 layers, 5 to 20 layers 1 to 10 layer, 2 to 10 layers, 3 to 10 layer, 4, to 10 layers, 5 to 10 layers, wherein the transition region has at least one fewer layers than the optical element; optionally, wherein each of the layers have different refractive indices.

Aspect 25. The methods and/or articles of any one of the aspects, each layer has a thickness of at least 10 nanometers (optionally at least 30 nanometers, optionally at least 40 nanometers, optionally at least 50 nanometers, optionally at least 60 nanometers, optionally a thickness of from about 10 nanometers to about 100 nanometers, or of from about 30 nanometers to about 80 nanometers, or from about 40 nanometers to about 60 nanometers), or optionally, each layer has a thickness of about one quarter of the wavelength of the wavelength to be reflected.

Aspect 26. The methods and/or articles of any one of the aspects, wherein the optical element and the transition region independently has a thickness of about 20 to about 200 nanometers, about 20 to about 700 nanometers, or of about 20 to about 500 nanometers. Aspect 27. The methods and/or articles of any one of the aspects, wherein the at least one layers is made of a material selected from a metal or a metal oxide or an alloy.

Aspect 28. The article of any one of the aspects, wherein the at least one layer is made of a metal.

Aspect 29. The methods and/or articles of any one of the aspects, wherein the metal is selected from the group consisting of: titanium, aluminum, silver, zirconium, chromium, magnesium, silicon, gold, platinum, and a combination thereof.

Aspect 30. The methods and/or articles of any one of the aspects, wherein at least one of the constituent layers comprises a metal selected from the group consisting of: titanium, aluminum, silver, zirconium, chromium, magnesium, silicon, gold, platinum, niobium, an oxide of any of these, and a combination thereof.

Aspect 31. The methods and/or articles of any one of the aspects, wherein at least one of the constituent layers is made of a material selected from the group consisting of: silicon dioxide, titanium dioxide, zinc sulfide, magnesium fluoride, tantalum pentoxide, and a combination thereof.

Aspect 32. The methods and/or articles of any one of the aspects, wherein the optical element (main body) includes 2-6 layers, 3-6 layers, 4-6 layers or optionally 3-5 layers.

Aspect 33. The methods and/or articles of any one of the articles, wherein when measured according to the CIE 1976 color space under a given illumination condition at a first observation angle of about -15 to 180 degrees or about or about -15 degrees and +60 degrees, the article has a first color measurement having coordinates L₁* and a₁* and b₁* as measured from a first position in the optical element, and the article has a second color measurement having coordinates L₂* and a₂* and b₂* as measured from the transition region of the optical element, where ΔE*_{ab}= [(L₁*-L₂*)² + (a₁*-a₂*)² + (b₁*-b₂*)²]^{½}, wherein the ΔE*_{ab} between the first color measurement and the second color measurement is greater than about 2.2, or optionally the ΔE*_{ab} is greater than about 3, or optionally is greater than 4, or optionally is greater than 5, the first structural color and the second color are different.

Aspect 34. The methods and/or articles of any one of the aspects, wherein the optical element and the transition region is on and visible from an outside surface of the article or the optical element and the transition region is on and visible from an inside surface of the article.

Aspect 35. The methods and/or articles of any one of the preceding aspects, wherein the surface of the article is made of a material is selected from: a thermoplastic polymer or, a thermoset polymer.

Aspect 36. The methods and/or articles of any one of the preceding aspects, wherein the at least one constituent layer further comprises a textured surface, and the textured surface and the optical element imparts the first structural color and the second structural color or optionally wherein the surface of the article is a textured surface, wherein the at least one constituent layer is on the textured surface, and the textured surface of the substrate and the optical element imparts the first structural color and the second structural color.

Aspect 37. The methods and/or articles of any one of the preceding aspects, wherein the textured surface includes a plurality of profile features and flat planar areas, wherein the profile features extend above the flat areas of the textured surface, optionally wherein the dimensions of the profile features, a shape of the profile features, a spacing among the plurality of the profile features, in combination with the optical element create the first structural color and/or the second structural color, optionally wherein the profile features are in random positions relative to one another for a specific area, optionally wherein the spacing among the profile features is set to reduce distortion effects of the profile features from interfering with one another in regard to the first structural color and/or the second structural color of the article, optionally wherein the profile features and the flat areas result in at least one layer of the optical element having an undulating topography across the textured surface, wherein there is a planar region between neighboring profile features that is planar with the flat planar areas of the textured surface, wherein the planar region has dimensions relative to the profile features to impart the first structural color and/or the second structural color optionally wherein the profile features and the flat areas result in each layer of the optical element having an undulating topography across the textured surface.

Aspect 38. The article and/or method of any of the preceding aspects, wherein the height of the profile feature is about 50 micrometers to 250 micrometers, optionally wherein at least one of the length and width of the profile feature is less than 250 micrometers or both the length and the width of the profile feature is less than 250 micrometers.

Aspect 39. The article and/or method of any of the preceding aspects, wherein at least one of the dimensions of the profile feature is in the nanometer range, while at least one other dimension is in the micrometer range.

Aspect 40. The article and/or method of any of the preceding aspects, wherein the nanometer range is about 10 nanometers to about 1000 nanometers, while the micrometer range is about 5 micrometers to 250 micrometers.

Aspect 41. The article and/or method of any of the preceding aspects, wherein at least one of the length and width of the profile feature is in the nanometer range, while the other of the length and the width of the profile feature is in the micrometer range.

Aspect 42. The article and/or method of any of the preceding aspects, wherein at least one of the length and width of the profile feature is in the nanometer range and the other in the micrometer range, where the height is about 250 nanometers to 250 micrometers.

Aspect 43. The article and/or method of any of the preceding aspects, wherein spatial orientation of the profile features is periodic.

Aspect 44. The article and/or method of any of the preceding aspects, wherein spatial orientation of the profile features is a semi-random pattern or a set pattern.

Aspect 45. The article and/or method of any of the preceding aspects, wherein the surface of the layers of the optical element are a substantially three-dimensional flat planar surface or a three dimensional flat planar surface.

Aspect 46. The methods and/or articles of any one of the preceding aspects, wherein the first structural color, the second structural color, or both exhibits a single hue or multiple different hues when viewed from different viewing angles at least 15 degrees apart.

Aspect 47. The methods and/or articles of any one of the preceding aspects, wherein the article is a fiber.

Aspect 48. The methods and/or articles of any one of the preceding aspects, wherein the article is a yarn.

Aspect 49. The methods and/or articles of any one of the preceding aspects, wherein the article is a monofilament yarn.

Aspect 50. The methods and/or articles of any one of the preceding aspects, wherein the article is a textile.

Aspect 51. The methods and/or articles of any one of the preceding aspects, wherein the article is a knit textile.

Aspect 52. The methods and/or articles of any one of the preceding aspects, wherein the article is a non-woven textile.

Aspect 53. The methods and/or articles of any one of the preceding aspects, wherein the article is a synthetic leather.

Aspect 54. The methods and/or articles of any one of the preceding aspects, wherein the article is a film.

Aspect 55. The methods and/or articles of any one of the preceding aspects, wherein the article is an article of footwear, a component of footwear, an article of apparel, a component of apparel, an article of sporting equipment, or a component of sporting equipment.

Aspect 56. The methods and/or articles of any one of the preceding aspects, wherein the article is an article of footwear.

Aspect 57. The methods and/or articles of any one of the preceding aspects, wherein the article is a sole component of an article of footwear.

Aspect 58. The methods and/or articles of any one of the preceding aspects, wherein the article is foam midsole component of an article of footwear.

Aspect 59. The methods and/or articles of any one of the preceding aspects, wherein the article is an upper component of an article of footwear.

Aspect 60. The methods and/or articles of any one of the preceding aspects, wherein the article is a knit upper component of an article of footwear.

Aspect 61. The methods and/or articles of any one of the preceding aspects, wherein the article is a non-woven synthetic leather upper for an article of footwear.

Aspect 62. The methods and/or articles of any one of the preceding aspects, wherein the article is a bladder including a volume of a fluid, wherein the bladder has a first bladder wall having a first bladder wall thickness, wherein the first bladder wall has a gas transmission rate of 15 cm³/m²•atm•day or less for nitrogen for an average wall thickness of 20 mils.

Aspect 63. The methods and/or articles of any one of the preceding aspects, wherein the article is a bladder, and the optical element and the transition region is optionally on an inside surface of the bladder or optionally the optical element and the transition region is on an outside surface of the bladder.

Aspect 65. The methods and/or articles of any preceding aspect, wherein the first structural color, the second structural color, or both is iridescent.

Aspect 66. The methods and/or articles of any preceding aspect, wherein the first structural color, the second structural color, or both has limited iridescence.

Aspect 67. The methods and/or articles of any preceding aspect, wherein the first structural color, the second structural color, or both has limited iridescence such that, when each color is visible at each possible angle of observation is, independently, assigned to a single hue selected from the group consisting of the primary, secondary and tertiary colors on the red yellow blue (RYB) color wheel, all of the assigned hues fall into a single hue group, wherein the single hue group is one of a) green-yellow, yellow, and yellow-orange; b) yellow, yellow-orange and orange; c) yellow-orange, orange, and orange-red; d) orange-red, and red-purple; e) red, red-purple, and purple; f) red-purple, purple, and purple-blue; g) purple, purple-blue, and blue; h) purple-blue, blue, and blue-green; i) blue, blue-green and green; and j) blue-green, green, and green-yellow.

Aspect 68. The methods and/or articles of any preceding aspect, wherein the first structural color, the second structural color, or both is a chromatic color.

Aspect 69. The methods and/or articles of any preceding aspect, wherein one of the first structural color and the second structural color is achromatic.

Aspect 70. The methods and/or articles of any preceding aspect, wherein the chromatic color is a red/yellow/blue (RYB) primary color, a RYB secondary color, a RYB tertiary color, a RYB quaternary color, a RYB quinary color, or a chromatic color that is a combination thereof

Aspect 71. The methods and/or articles of any preceding aspect, wherein the chromatic color is cyan, blue, indigo, violet, or a chromatic color that is a combination thereof

Aspect 72. The methods and/or articles of any preceding aspect, wherein the achromatic color is selected from black, white, or neutral gray.

Aspect 73. The methods and/or articles of any preceding aspect, wherein the chromatic color is red, yellow, blue, green, orange, purple, or a chromatic color that is a combination thereof.

Aspect 74. The methods and/or articles of any preceding aspect, wherein the chromatic color is red, orange, yellow, green, blue, indigo, violet, or a chromatic color that is a combination thereof.

Aspect 75. The article of any one of the preceding aspects, wherein a layer of the optical element and the transition region further comprises a textured surface.

Aspect 76. The article of aspect 75, wherein a layer of the optical element further comprises a textured surface, wherein the optical element is on the textured surface, and a hue of the first structural color, an intensity of the first structural color, a viewing angle at which the first structural color is visible, a hue of the second structural color, an intensity of the second structural color, a viewing angle at which the second structural color is visible, or any combination thereof, is altered by the textured surface, as determined by comparing the optical element comprising the textured surface of a substantially identical optical element which is free of the textured surface.

Aspect 77. The article of aspect 75, wherein a layer of the optical element further comprises a textured surface, wherein the optical element is on the textured surface, wherein the textured surface reduces or eliminates shift of the first structural color or the second structural color as a viewing angle is varied from a first viewing angle to a second viewing angle, as compared to a substantially identical optical element which is free of the textured surface.

Aspect 78. The article of aspect 75, wherein a layer of the optical element further comprises a textured surface, wherein the optical element is on the textured surface, and a hue of the first structural color, an intensity of the first structural color, a viewing angle at which the first structural color is visible, a hue of the second structural color, an intensity of the second structural color, a viewing angle at which the second structural color is visible, or any combination thereof, is unaffected by or substantially unaffected by the textured surface, as determined by comparing the optical element comprising the textured surface to a substantially identical optical element which is free of the textured surface.

Aspect 79. The article of aspect 75, wherein a layer of the optical element further comprises a textured surface, wherein the optical element is on the textured surface, wherein shift of the first structural color or the second structural color is unaltered by or substantially the same as a viewing angle is varied from a first viewing angle to a second viewing angle, as compared to a substantially identical optical element which is free of the textured surface.

Aspect 80. The article of any one of the preceding aspects, wherein the surface of the article is a textured surface, wherein the optical element and the transition region is on the textured surface.

Aspect 81. The article of aspect 80, wherein the surface of the article is a textured surface, wherein the optical element is on the textured surface, and a hue of the first structural color, an intensity of the first structural color, a viewing angle at which the first structural color is visible, a hue of the second structural color, an intensity of the second structural color, a viewing angle at which the second structural color is visible, or any combination thereof, is altered by the textured surface, as determined by comparing the optical element comprising the textured surface of a substantially identical optical element on a surface of a substantially identical article which is free of the textured surface.

Aspect 82. The article of aspect 80, wherein the surface of the article is a textured surface, wherein the optical element is on the textured surface, wherein the textured surface reduces or eliminates shift of the first structural color or the second structural color as a viewing angle is varied from a first viewing angle to a second viewing angle, as compared to a substantially identical optical element on a surface of a substantially identical article which is free of the textured surface.

Aspect 83. The article of aspect 80, wherein the surface of the article is a textured surface, wherein the optical element is on the textured surface, and a hue of the first structural color, an intensity of the first structural color, a viewing angle at which the first structural color is visible, a hue of the second structural color, an intensity of the second structural color, a viewing angle at which the second structural color is visible, or any combination thereof, is unaffected by or substantially unaffected by the textured surface, as determined by comparing the optical element comprising the textured surface to a substantially identical optical element on a surface of a substantially identical article which is free of the textured surface.

Aspect 84. The article of aspect 80, wherein the surface of the article is a textured surface, wherein the optical element is on the textured surface, wherein shift of the first structural color or the second structural color is unaltered by or substantially the same as a viewing angle is varied from a first viewing angle to a second viewing angle, as compared to a substantially identical optical element on a surface of a substantially identical article which is free of the textured surface.

Aspect 85. The article of any one of the preceding aspects, wherein the textured surface includes a plurality of profile features and flat planar areas, wherein the profile features extend above the flat areas of the textured surface.

Aspect 86. The article of aspect 85, wherein dimensions of the profile features, a shape of the profile features, a spacing among the plurality of the profile features, or any combination thereof, in combination with the optical element, affect a hue of the first structural color, a hue of the second structural color, an intensity of the first structural color, an intensity of the second structural color, a viewing angle at which the first structural color is visible, a viewing angle at which the second structural color is visible, shift of the first structural color to the second structural color as a viewing angle is varied from a first viewing angle to a second viewing angle, or any combination thereof.

Aspect 87. The article of aspect 85, wherein dimensions of the profile features, a shape of the profile features, a spacing among the plurality of the profile features, or any combination thereof, in combination with the optical element, affect a hue of the second structural color, an intensity of the second structural color, a viewing angle at which the second structural color is visible, shift of the second structural color as a viewing angle is varied from a first viewing angle to a second viewing angle, or any combination thereof. Aspect 88. The article of aspect 85, wherein a hue of the first structural color, a hue of the second structural color, an intensity of the first structural color, an intensity of the second structural color, a viewing angle at which the first structural color is visible, a viewing angle at which the second structural color is visible, shift of the first structural color to the second structural color as a viewing angle is varied from a first viewing angle to a second viewing angle, or any combination thereof, are unaffected or substantially unaffected by dimensions of the profile features, a shape of the profile features, a spacing among the plurality of the profile features, or any combination thereof, of the textured surface.

Aspect 89. The article of aspect 85, wherein the profile features of the textured surface are in random positions relative to one another within a specific area and/or wherein spacing among the profile features is random within a specific area.

Aspect 90. The article of aspect 89, wherein spacing between the profile features, in combination with the optical element, affects a hue of the first structural color, a hue of the second structural color, an intensity of the first structural color, an intensity of the second structural color, a viewing angle at which the first structural color is visible, a viewing angle at which the second structural color is visible, shift of the first structural color to the second structural color as a viewing angle is varied from a first viewing angle to a second viewing angle, or any combination thereof.

Aspect 91. The article of aspect 89, wherein a hue of the first structural color, a hue of the second structural color, an intensity of the first structural color, an intensity of the second structural color, a viewing angle at which the first structural color is visible, a viewing angle at which the second structural color is visible, shift of the first structural color to the second structural color as a viewing angle is varied from a first viewing angle to a second viewing angle, or any combination thereof, is unaffected by, or substantially unaffected by, spacing between the profile features in combination with the optical element.

Aspect 92. The article of any one of the preceding aspects, wherein the profile features and the flat areas result in at least one layer of the optical element and the transition region have an undulating topography across the textured surface, and wherein there is a planar region between neighboring profile features that is planar with the flat planar areas of the textured surface.

Aspect 93. The article of aspect 92, wherein dimensions of the planar region relative to the profile features affect a hue of the first structural color, a hue of the second structural color, an intensity of the first structural color, an intensity of the second structural color, a viewing angle at which the first structural color is visible, a viewing angle at which the second structural color is visible, shift of the first structural color to the second structural color as a viewing angle is varied from a first viewing angle to a second viewing angle, or any combination thereof.

Aspect 94. The article of aspect 92, wherein a hue of the first structural color, an intensity of the first structural color, a viewing angle at which the first structural color is visible, shift of the first structural color as a viewing angle is varied from a first viewing angle to a second viewing angle, a hue of the second structural color, an intensity of the second structural color, a viewing angle at which the second structural color is visible, shift of the second structural color as a viewing angle is varied from a first viewing angle to a second viewing angle, or any combination thereof, is unaffected by or substantially unaffected by dimensions of the planar region relative to the profile features.

Aspect 95. The article of any one of the preceding aspect, wherein the profile features and the flat areas result in each layer of the optical element and the transition region has an undulating topography across the textured surface.

Aspect 96. The article of aspect 95, wherein the undulating topography of the optical element affects a hue of the first structural color, a hue of the second structural color, an intensity of the first structural color, an intensity of the second structural color, a viewing angle at which the first structural color is visible, a viewing angle at which the second structural color is visible, shift of the first structural color to the second structural color as a viewing angle is varied from a first viewing angle to a second viewing angle, or any combination thereof.

Aspect 97. The article of aspect 95, wherein a hue of the first structural color, a hue of the second structural color, an intensity of the first structural color, an intensity of the second structural color, a viewing angle at which the first structural color is visible, a viewing angle at which the second structural color is visible, shift of the first structural color to the second structural color as a viewing angle is varied from a first viewing angle to a second viewing angle, or any combination thereof, is unaffected by or substantially unaffected by the undulating topography of the optical element.

Now having described embodiments of the present disclosure generally, additional discussion regarding embodiments will be described in greater details.

This disclosure is not limited to particular embodiments described, and as such may, of course, vary. The terminology used herein serves the purpose of describing particular embodiments only, and is not intended to be limiting, since the scope of the present disclosure will be limited only by the appended claims.

Where a range of values is provided, each intervening value, to the tenth of the element of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method may be carried out in the order of events recited or in any other order that is logically possible.

Embodiments of the present disclosure will employ, unless otherwise indicated, techniques of material science, chemistry, textiles, polymer chemistry, and the like, which are within the skill of the art. Such techniques are explained fully in the literature.

Unless otherwise defined, all technical and scientific terms used herein have the same meaning as commonly understood by one of ordinary skill in the art of material science, chemistry, textiles, polymer chemistry, and the like. Although methods and materials similar or equivalent to those described herein can be used in the practice or testing of the present disclosure, suitable methods and materials are described herein.

As used in the specification and the appended claims, the singular forms “a,” “an,” and “the” may include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

The present disclosure provides for articles (e.g., structural color article) that exhibit areas having a structural color (e.g., main body of the optical element), areas having non-structural (e.g., surface of the substrate), and areas of transition (e.g., a transition region of the optical element). An optical element(s) can be incorporated onto one or more components of an article, for example, when the article is an article of footwear, on an upper or sole of an article of footwear. The optical element includes one or more layers that produce visible color, at least in part, through optical effects such as through scattering, refraction, reflection, interference, and/or diffraction of visible wavelengths of light. At the edge (e.g., adjacent) of the optical element exists the transition region between the main body of the optical element and the underlying substrate, which may include one or more optical layers that are the same or similar to that of the main body of the optical element. The optical element includes the main body region that imparts the main body color (e.g., a first structural color) and the transition region that imparts the transition region color (e.g., a second structural color or a non-structural color). The substrate upon which the optical element is disposed has a first color (e.g., non-structural color). The main body color, the transition region color, and/or the first color of the substrate can be different in a hue, a value, a chroma, or any combination thereof when viewed from the same angle of observation from someone with 20 20 visual acuity from a distance of about 1 meter from the article under the same lighting conditions. The main body color and the transition region color can have the same color (e.g., structural color) at certain observation angles but different colors (e.g., structural color and non-structural color) at other observation angles so that a hue, a value, a chroma, or any combination thereof are different to someone with 20 20 visual acuity from a distance of about 1 meter from the article under the same lighting conditions. For example, if the observation angle is about 90 degrees (e.g., looking straight down onto the article surface) the main body color and the transition region color may be the same, but as the observation able moves to 60 degrees (e.g., about 30 to 60 degrees different than a certain observation angle) or 120 degrees, the main body color and the transition region color are different based on differences in the number of layers, width of the layers, etc. In another example, the main body color and the transition region color may be the same over a wide set of observation angles (e.g., from about 60 to 120 degrees) but are different outside of that range of angles.

Also, the transition region can include one or more transition regions (e.g., a first transition region, a second transition region) along the length of the transition region, where each region along the length can be the same or a different color (e.g., structural color or non-structural color). In addition, each transition region can include one or more transition sectors (e.g., a first transition sector, a second transition sector) along the width of the transition region, where each transition sector can have the same or a different color (e.g., structural color or non-structural color). The color in each transition region and/or transition sector can be different, at least in part, because the main body region of the optical element includes all of the layers (e.g., has the same or substantially the same cross-section and it imparts the first structural color) while each of the transition region and/or transition sectors can have a cross-section that is different in one or more of the following ways: the number of layers, the thickness (or height) of the layers, or the width of the layers. As can be appreciated, these differences can vary as a function of the length and width of the transition region and can produce a striking, unique, and aesthetically pleasing appearance for the article including the substrate.

The structural color (e.g., first structural color and the second structural color) imparted by the optical element (e.g., the main body and/or transition region) can be a single color, multicolor, or iridescent, based, partly, on the changing angle of observation. The first structural color and the second structural colors can be different in a hue, a value, a chroma, or any combination thereof when viewed from the same angle of observation from someone with 20 20 visual acuity from a distance of about 1 meter from the article under the same lighting conditions.

The optical element can be a single layer reflector, a single layer filter, a multilayer reflector or a multilayer filter. Generally, the main body optical element can include two or more layers (e.g., constituent layers, reflective layers), while the transition region include at least one fewer layers than the main body of the optical element. The main body of the optical element has at least one more layer than the transition region. Also as described herein, the optical element can optionally include a textured surface, such as a textured layer and/or a textured structure, where the textured surface is of a different dimensional scale and distinguishable from the protrusion(s) and/or indentation(s) provided herein. Optionally, the optical element can include one or more layers (e.g., protection layer, and the like) to provide or give one or more characteristics to the optical element (e.g., better wear characteristic, better adhesion characteristic, and the like).

The optical element can be disposed on a surface in a variety of ways. For example, the optical element can be disposed on the surface so that each of the layers of the optical element are parallel or substantially parallel the surface (e.g., disposed “in line”). In other words, the length and width of the layers of the optical element define the plane, while the thickness of the layer is the smallest dimension. In another example, each of the layers of the optical element are perpendicular or substantially perpendicular the surface. In either configuration, the optical element can produce an aesthetically pleasing appearance.

In one or more embodiments of the present disclosure the surface of the article includes the optical element and is optionally a textured surface, where the optical element and optionally the textured surface impart the structural color (e.g., first structural color, the second structural color). The optional textured surface can be disposed between the optical element and the surface or be part of the optical element, depending upon the design. Additional details are provided herein.

In an embodiment, the structural color may not be used in combination with a pigment and/or dye, so the structural color is independent of a pigment and/or dye. In another aspect, the structural color can be used in combination with a pigment and/or dye, but the structural color is not the same color, shade, and/or hue as the pigment and/or dye. In this regard, the structural color is the product of the textured surface, the optical element, and/or the pigment and/or dye. In an embodiment, the structural color can be used in combination with a pigment and/or dye to enhance the color of the pigment and/or dye in regard to the color of the pigment and/or dye or enhance a tone, tint, shade, or hue associated with the pigment and/or dye.

As will be described herein, the optical element can be formed using one of a number of processes. The transition region of the optical element can be formed through the process of forming the optical element using a masking process or the deposition process has a limited range so it does not cover the entire substrate, where these processes are described herein. In the alternative or in addition to, the transition region can be formed by abrasive forces that remove part of the optical element to expose the underlying substrate.

The dimensions of the main body and the transition region can be designed (e.g., using a masking technique) or formed randomly (e.g., they are caused abrasive forces). In general, the transition region can have a narrow width that can be less (e.g., about 0.01 millimeter) than 1 millimeter wide or can have a wider width such as about 1 to 3 millimeter wide or about 1 to 5 millimeter wide. Along the width of the transition region, each transition region can have one or more transition sectors that can have differences that can include: the number of layers (e.g., at least one less than the main body of the optical element), the thickness of one or more of the layers (e.g., a portion of the thickness of one or more layers is reduced relative to the layers of the optical element), and the width of the layers, where these differences can contribute to different colors in each transition sector. Also, the width as a function of the length can change as well so in one transition region the width can be about 1 millimeter and in another transition region it can be 2 millimeter and in yet another transition region it can be 0.5 millimeters. The length can be in the centimeter range (e.g., 1 to 3 centimeters or about 1 to 5 centimeters or about 1 to 10 centimeters, or about 1 to 100 centimeters or about 1 to 1000 centimeters) or more. The transition region can be different than the main body of the optical element at various points along the length of the transition region, where these differences include: the number of layers (e.g., at least one less than the main body of the optical element), the thickness (e.g., height) of one or more of the layers (e.g., a portion of the thickness of one or more layers is reduced relative to the layers of the optical element), and the width of the layers. As a result, the color (e.g., structural color and/or non-structural color) in different transition regions can be attributed, at least in part, to this combination of these differences, where the color is a function of the length of the transition region.

Portions of the substrate (e.g., a first substrate area) including the optical element can have a first color associated with the material used to make the substrate, which may or may not include colorants to provide the substrate with the first color. In contrast, the main body of the optical element imparts main body color (e.g., a first structural color) to the third substrate area of the article. The transition region imparts a transition region color (e.g., structural color or non-structural color) to a second substrate area. A hue, a value, a chroma, or any combination thereof of the first color, the main body color, and/or the transition region color can different when viewed from the same angle of observation under the same lighting conditions from about 1 meter away from someone with 20 20 vision acuity.

The article can be an article of manufacture or a component of the article. The article of manufacture can include footwear, apparel (e.g., shirts, jerseys, pants, shorts, gloves, glasses, socks, hats, caps, jackets, undergarments), containers (e.g., backpacks, bags), and upholstery for furniture (e.g., chairs, couches, car seats), bed coverings (e.g., sheets, blankets), table coverings, towels, flags, tents, sails, and parachutes, or components of any one of these. In addition, the optical element can be used with or disposed on textiles or other items such as striking devices (e.g., bats, rackets, sticks, mallets, golf clubs, paddles, etc.), athletic equipment (e.g., golf bags, baseball and football gloves, soccer ball restriction structures), protective equipment (e.g., pads, helmets, guards, visors, masks, goggles, etc.), locomotive equipment (e.g., bicycles, motorcycles, skateboards, cars, trucks, boats, surfboards, skis, snowboards, etc.), balls or pucks for use in various sports, fishing or hunting equipment, furniture, electronic equipment, construction materials, eyewear, timepieces, jewelry, and the like.

The article can be an article of footwear. The article of footwear can be designed for a variety of uses, such as sporting, athletic, military, work-related, recreational, or casual use. Primarily, the article of footwear is intended for outdoor use on unpaved surfaces (in part or in whole), such as on a ground surface including one or more of grass, turf, gravel, sand, dirt, clay, mud, pavement, and the like, whether as an athletic performance surface or as a general outdoor surface. However, the article of footwear may also be desirable for indoor applications, such as indoor sports including dirt playing surfaces for example (e.g., indoor baseball fields with dirt infields).

In particular, the article of footwear can be designed for use in indoor or outdoor sporting activities, such as global football/soccer, golf, American football, rugby, baseball, running, track and field, cycling (e.g., road cycling and mountain biking), and the like. The article of footwear can optionally include traction elements (e.g., lugs, cleats, studs, and spikes as well as tread patterns) to provide traction on soft and slippery surfaces, where components of the present disclosure can be used or applied between or among the traction elements and optionally on the sides of the traction elements but on the surface of the traction element that contacts the ground or surface. Cleats, studs and spikes are commonly included in footwear designed for use in sports such as global football/soccer, golf, American football, rugby, baseball, and the like, which are frequently played on unpaved surfaces. Lugs and/or exaggerated tread patterns are commonly included in footwear including boots design for use under rugged outdoor conditions, such as trail running, hiking, and military use.

In particular, the article can be an article of apparel (i.e., a garment). The article of apparel can be an article of apparel designed for athletic or leisure activities. The article of apparel can be an article of apparel designed to provide protection from the elements (e.g., wind and/or rain), or from impacts.

In particular, the article can be an article of sporting equipment. The article of sporting equipment can be designed for use in indoor or outdoor sporting activities, such as global football/soccer, golf, American football, rugby, baseball, running, track and field, cycling (e.g., road cycling and mountain biking), and the like.

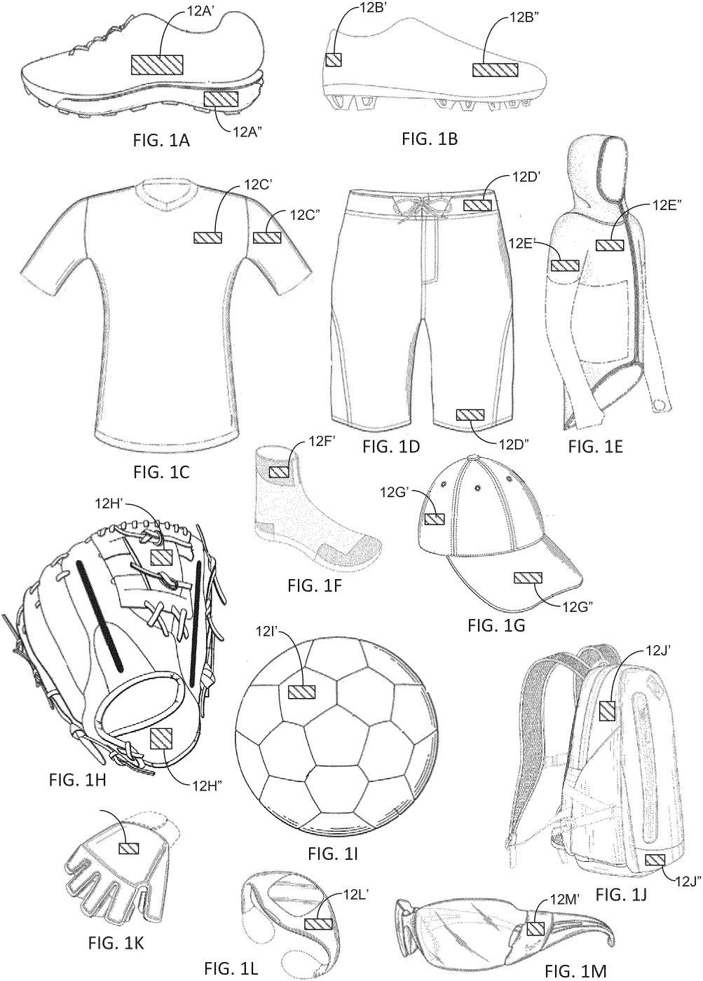

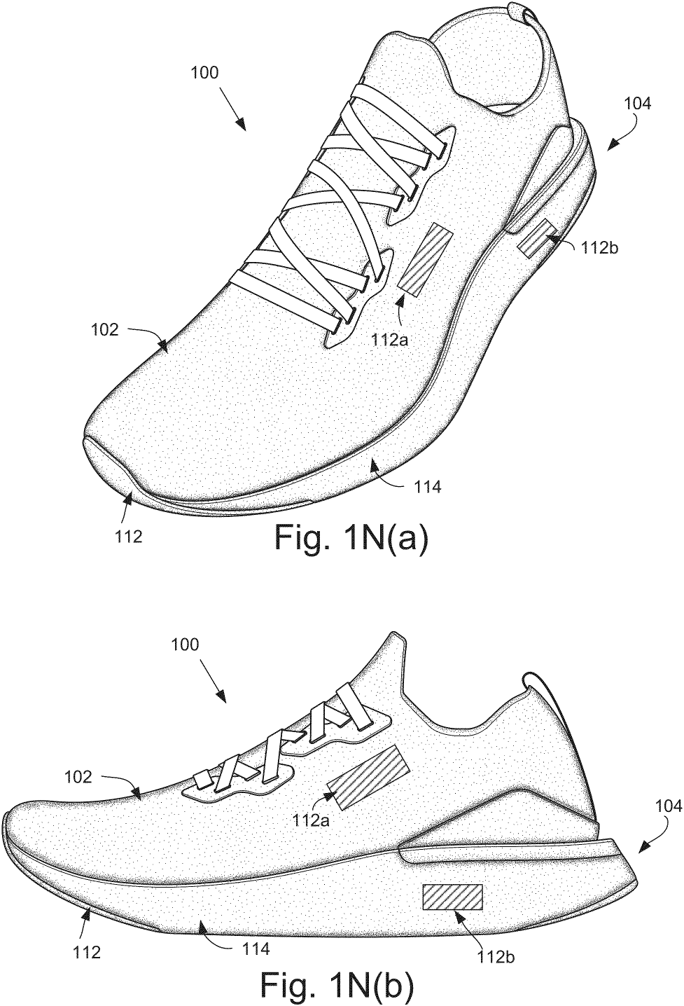

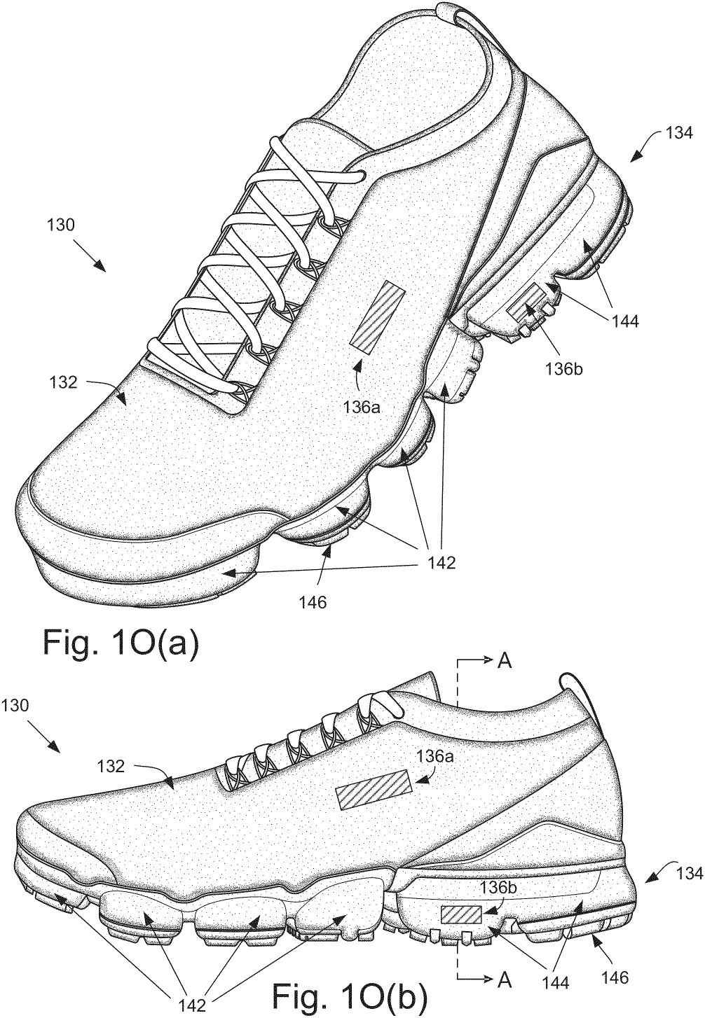

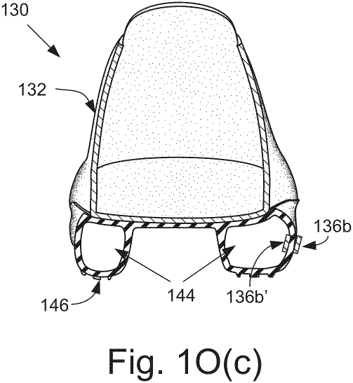

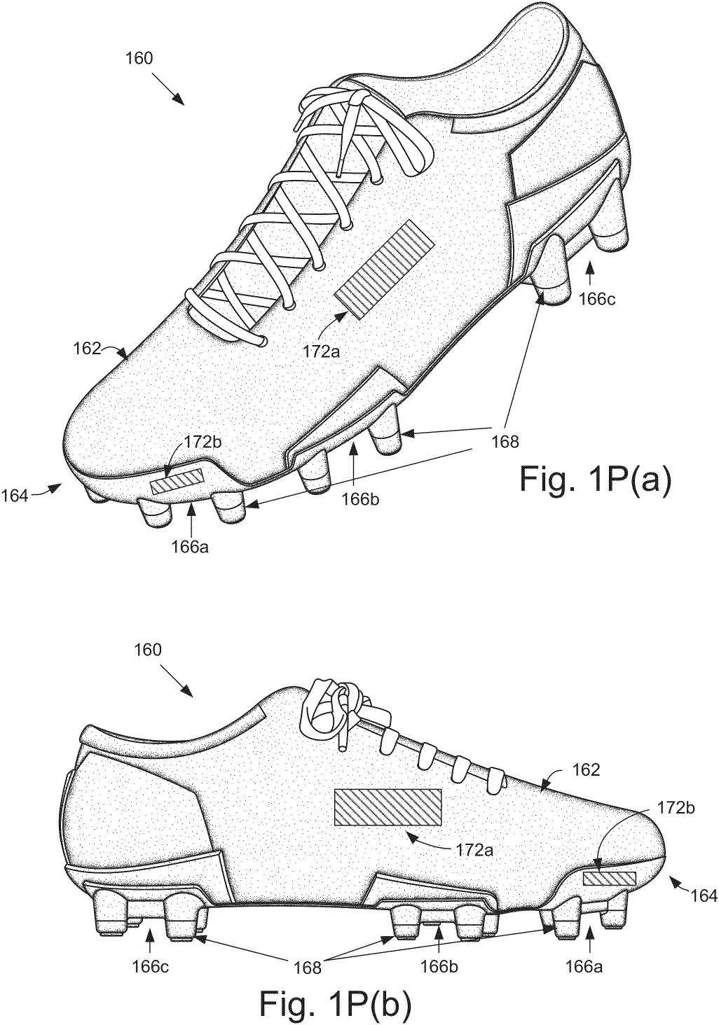

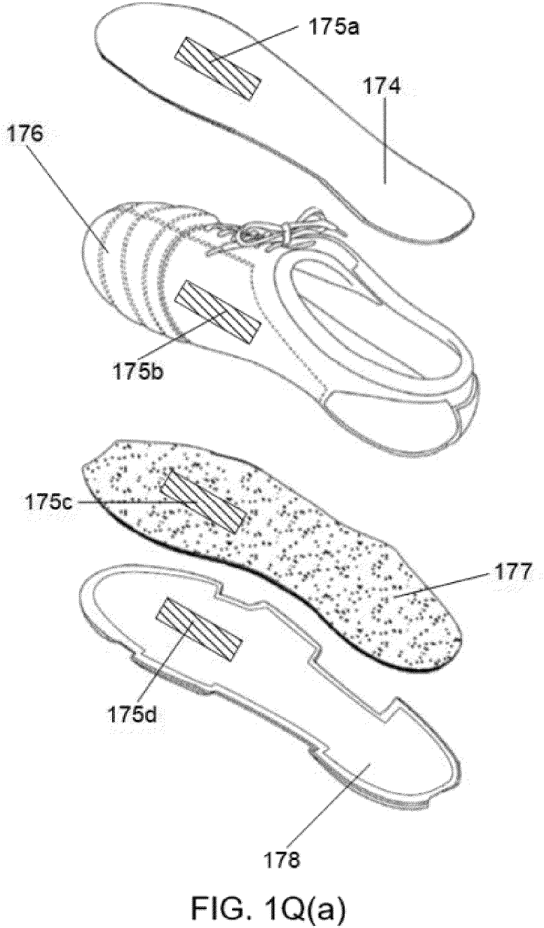

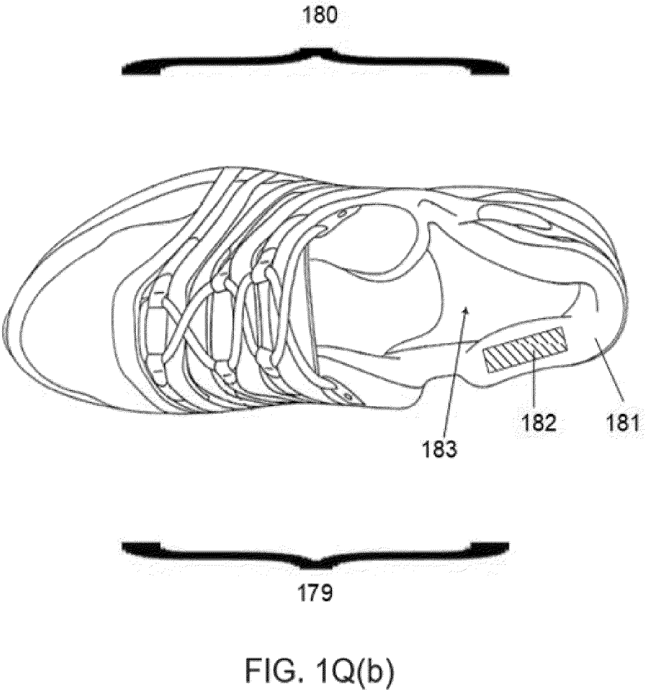

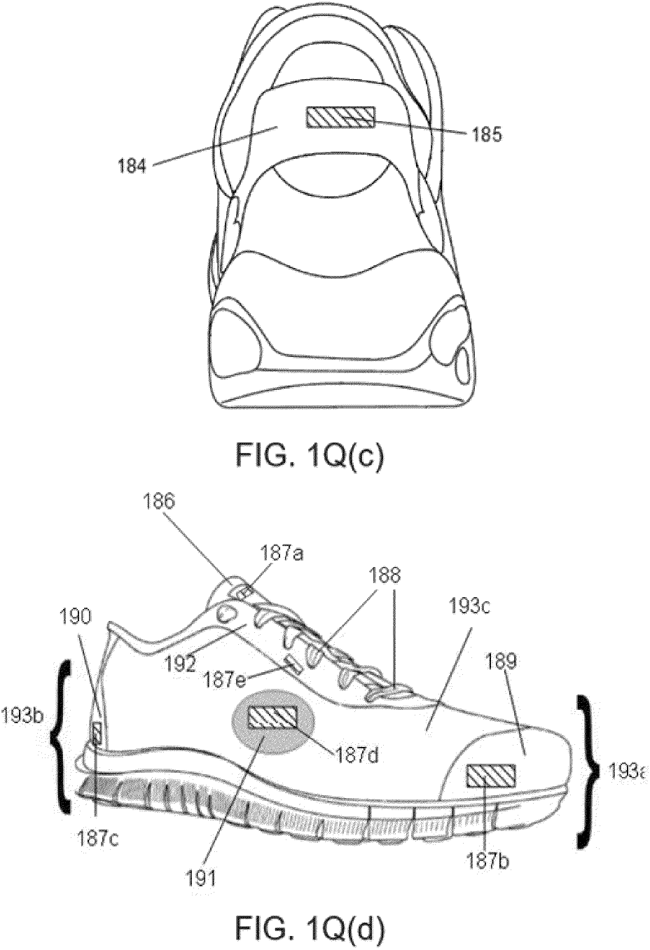

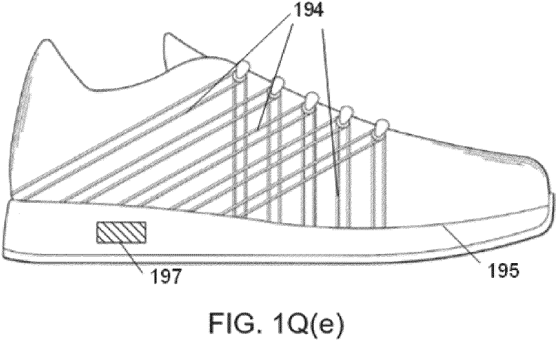

FIGS. 1A-1M illustrates footwear, apparel, athletic equipment, container, electronic equipment, and vision wear that include the structure (e.g., the optical element, optionally the textured surface) of the present disclosure. The structure can include the optical element in the “in-line” configuration and/or the “on its side” configuration. The structure including the optical element is represented by hashed areas 12A′/12M′ - 12A″/12M′. The location of the structure is provided only to indicate one possible area that the structure can be located. Also, two locations are illustrated in some of the figures and one location is illustrated in other figures, but this is done only for illustration purposes as the items can include one or a plurality of structure, where the size and location can be determined based on the item. The structure(s) located on each item can represent a number, letter, symbol, design, emblem, graphic mark, icon, logo, or the like.

FIGS. 1N(a) and 1N(b) illustrate a perspective view and a side view of an article of footwear 100 that include a sole structure 104 and an upper 102. The structure including the optical element is represented by 122a and 122b. The sole structure 104 is secured to the upper 102 and extends between the foot and the ground when the article of footwear 100 is worn. The primary elements of the sole structure 104 are a midsole 114 and an outsole 112. The midsole 114 is secured to a lower area of the upper 102 and may be formed of a polymer foam or another appropriate material. In other configurations, the midsole 114 can incorporate fluid-filled chambers, plates, moderators, and/or other elements that further attenuate forces, enhance stability, or influence motions of the foot. The outsole 112 is secured to a lower surface of the midsole 114 and may be formed from a wear-resistant rubber material that is textured to impart traction, for example. The upper 102 can be formed from various elements (e.g., lace, tongue, collar) that combine to provide a structure for securely and comfortably receiving a foot. Although the configuration of the upper 102 may vary significantly, the various elements generally define a void within the upper 102 for receiving and securing the foot relative to sole structure 104. Surfaces of the void within upper 102 are shaped to accommodate the foot and extend over the instep and toe areas of the foot, along the medial and lateral sides of the foot, under the foot, and around the heel area of the foot. The upper 102 can be made of one or more materials such as textiles, a polymer foam, leather, synthetic leather, and the like that are stitched or bonded together. Although this configuration for the sole structure 104 and the upper 102 provides an example of a sole structure that may be used in connection with an upper, a variety of other conventional or nonconventional configurations for the sole structure 104 and/or the upper 102 can also be utilized. Accordingly, the configuration and features of the sole structure 104 and/or the upper 102 can vary considerably.

FIGS. 10(a) and 10(b) illustrate a perspective view and a side view of an article of footwear 130 that include a sole structure 134 and an upper 132. The structure including the optical element is represented by 136a and 136b/136b′. The sole structure 134 is secured to the upper 132 and extends between the foot and the ground when the article of footwear 130 is worn. The upper 132 can be formed from various elements (e.g., lace, tongue, collar) that combine to provide a structure for securely and comfortably receiving a foot. Although the configuration of the upper 132 may vary significantly, the various elements generally define a void within the upper 132 for receiving and securing the foot relative to the sole structure 134. Surfaces of the void within the upper 132 are shaped to accommodate the foot and extend over the instep and toe areas of the foot, along the medial and lateral sides of the foot, under the foot, and around the heel area of the foot. The upper 132 can be made of one or more materials such as textiles, polymer foam, leather, synthetic leather, and the like that are stitched or bonded together.

The primary elements of the sole structure 134 are a forefoot component 142, a heel component 144, and an outsole 146. Each of the forefoot component 142 and the heel component 144 are directly or indirectly secured to a lower area of the upper 132 and formed from a polymer material that encloses a fluid, which may be a gas, liquid, or gel. During walking and running, for example, the forefoot component 142 and the heel component 144 compress between the foot and the ground, thereby attenuating ground reaction forces. That is, the forefoot component 142 and the heel component 144 are inflated and generally pressurized with the fluid to cushion the foot. The outsole 146 is secured to lower areas of the forefoot component 142 and the heel component 144 and may be formed from a wear-resistant rubber material that is textured to impart traction. The forefoot component 142 can be made of one or more polymers (e.g., layers of one or more polymers films) that form a plurality of chambers that includes a fluid such as a gas. The plurality of chambers can be independent or fluidically interconnected. Similarly, the heel component 144 can be made of one or more polymers (e.g., layers of one or more polymers films) that form a plurality of chambers that includes a fluid such as a gas and can also be independent or fluidically interconnected. In some configurations, the sole structure 134 may include a foam layer, for example, that extends between the upper 132 and one or both of the forefoot component 142 and the heel component 144, or a foam element may be located within indentations in the lower areas of the forefoot component 142 and the heel component 144. In other configurations, the sole structure 132 may incorporate plates, moderators, lasting elements, or motion control members that further attenuate forces, enhance stability, or influence the motions of the foot, for example. Although the depicted configuration for the sole structure 134 and the upper 132 provides an example of a sole structure that may be used in connection with an upper, a variety of other conventional or nonconventional configurations for the sole structure 134 and/or the upper 132 can also be utilized. Accordingly, the configuration and features of the sole structure 134 and/or the upper 132 can vary considerably.

FIG. 1O(c) is a cross-sectional view of A-A that depicts the upper 132 and the heel component 144. The optical element 136b can be disposed on the outside wall of the heel component 144 or alternatively or optionally the optical element 136b′ can be disposed on the inside wall of the heel component 144.

FIGS. 1P(a) and 1P(b) illustrate a perspective view and a side view of an article of footwear 160 that includes traction elements 168. The structure including the optical element are represented by 172a and 172b. The article of footwear 160 includes an upper 162 and a sole structure 164, where the upper 162 is secured to the sole structure 164. The sole structure 164 can include a toe plate 166a, a mid-plate 166b, and a heel plate 166c as well as traction elements 168. The traction elements 168 can include lugs, cleats, studs, and spikes as well as tread patterns to provide traction on soft and slippery surfaces. In general, the cleats, studs and spikes are commonly included in footwear designed for use in sports such as global football/soccer, golf, American football, rugby, baseball, and the like, while lugs and/or exaggerated tread patterns are commonly included in footwear (not shown) including boots design for use under rugged outdoor conditions, such as trail running, hiking, and military use. The sole structure 164 is secured to the upper 162 and extends between the foot and the ground when the article of footwear 160 is worn. The upper 162 can be formed from various elements (e.g., lace, tongue, collar) that combine to provide a structure for securely and comfortably receiving a foot. Although the configuration of the upper 162 may vary significantly, the various elements generally define a void within the upper 162 for receiving and securing the foot relative to the sole structure 164. Surfaces of the void within upper 162 are shaped to accommodate the foot and extend over the instep and toe areas of the foot, along the medial and lateral sides of the foot, under the foot, and around the heel area of the foot. The upper 162 can be made of one or more materials such as textiles, a polymer foam, leather, synthetic leather, and the like that are stitched or bonded together. In other aspects not depicted, the sole structure 164 may incorporate foam, one or more fluid-filled chambers, plates, moderators, or other elements that further attenuate forces, enhance stability, or influence the motions of the foot. Although the depicted configuration for the sole structure 164 and the upper 162 provides an example of a sole structure that may be used in connection with an upper, a variety of other conventional or nonconventional configurations for the sole structure 164 and/or the upper 162 can also be utilized. Accordingly, the configuration and features of the sole structure 164 and/or the upper 162 can vary considerably.

FIG. 1Q(a)-1Q(e) illustrate additional views of exemplary articles of athletic footwear including various configurations of upper 176. FIG. 1Q(a) is an exploded perspective view of an exemplary article of athletic footwear showing insole 174, upper 176. optional midsole or optional lasting board 177, and outsole 178. which can take the form of a plate. Structures including optical elements are represented by 175a-175d. FIG. 1Q(b) is a top view of an exemplary article of athletic footwear indicating an opening 183 configured to receive a wearer’s foot as well as an ankle collar 181 which may include optical element 182. The ankle collar is configured to be positioned around a wearer’s ankle during wear, and optionally can include a cushioning element. Also illustrated are the lateral side 180 and medial side 179 of the exemplary article of athletic footwear. FIG. 1Q(c) is a back view of the article of footwear depicted in FIG. 1Q(b), showing an optional heel clip 184 that can include optical element 185. FIG. 1Q(d) shows a side view of an exemplary article of athletic footwear, which may optionally also include a tongue 186. laces 188, a toe cap 189, a heel counter 190, a decorative element such as a logo 191, and/or eyestays for the laces 192 as well as a toe area 193a, a heel area 193b, and a vamp 193c. In some aspects, the heel counter 190 can be covered by a layer of knitted, woven, or nonwoven fabric, natural or synthetic leather, film, or other shoe upper material. In some aspects, the eyestays 192 are formed as one continuous piece; however, they can also comprise several separate pieces or cables individually surrounding a single eyelet or a plurality of eyelets. Structures including optical elements are represented by 187a-187e. While not depicted, optical elements can be present on the eyestays 192 and/or the laces 188. In some configurations, the sole structure can include a sole structure, such as a midsole having a cushioning element in part or substantially all of the midsole, and the optical element can be disposed on an externally-facing side of the sole structure, including on an externally-facing side of the midsole. FIG. 1Q(e) is a side view of another exemplary article of athletic footwear. In certain aspects, the upper can comprise one or more containment elements 194 such as wires, cables or molded polymeric component extending from the lace structure over portions of the medial and lateral sides of the exemplary article of athletic footwear to the top of the sole structure to provide lockdown of the foot to the sole structure, where the containment element(s) can have an optical element (not shown) disposed on an externally-facing side thereon. In some configurations, a rand (not shown) can be present across part or all of the biteline 195.

Now having described embodiments of the present disclosure generally, additional details are provided. In regard to non-structural color, the non-structural color can be chromatic or achromatic. In an aspect the non-structural color may be the natural color of the material or can be altered by a colorant such as a pigment or dye. The material may be recycled material and take on a gray or an off-white or darker shade of red/yellow/blue or a combination thereof.

The optical element (e.g., main body, transition region) can produce the structural color upon exposure to visible light. The structural color (e.g., first structural color, second structural color) can be achromatic structural color (e.g., black, white, or neutral gray) or chromatic structural color. A “chromatic color” is a color in which one particular wavelength or hue predominates, while an “achromatic color” is a color in which no particular wavelength or hue predominates, as all wavelengths or hues are present in equal parts or substantially equal parts. The chromatic color can be selected from a red/yellow/blue (RYB) primary color, a RYB secondary color, a RYB tertiary color, a RYB quaternary color, a RYB quinary color, or a chromatic color that is a combination thereof. The chromatic color can be red, yellow, blue, green, orange, purple, or a chromatic color that is a combination thereof. The chromatic color can be red, orange, yellow, green, blue, indigo, violet, or a chromatic color that is a combination thereof. The chromatic color has hue and/or chroma according the Munsell color system. The chromatic color does not include black, white, or neutral gray. In an aspect, chromatic color and achromatic color are mutually exclusive of one another.

The achromatic color can be selected from black, white, or neutral gray. When the achromatic color is black, white, or a neutral gray, the phrase “pure achromatic color” can be used. As used herein, the achromatic color excludes the following colors: a warm gray, a warm brown, a warm tan, a cool gray, a cool brown, a cool tan, each of which is considered a chromatic color. For example, a warm gray, a warm brown, and a warm tan would be colors in which yellow or red predominates and so would not be achromatic. Similarly, a cool gray, a cool brown, and a cool tan would be colors in which blue or green predominates, and so would not be achromatic. Achromatic gray can include gainsboro gray, light gray, silver gray, medium gray, spanish gray, gray, dim gray, Davy’s gray, jet gray, and the middle grays.

The structural color of an article as perceived by a viewer can differ from the actual structural color of the article, as the structural color perceived by a viewer is determined by the actual structural color of the article (e.g., the structural color of the light leaving the surface of the article), by the presence of the optical element which may absorb, refract, interfere with, or otherwise alter light reflected by the article, the viewer’s visual acuity, by the viewer’s ability to detect the wavelengths of light reflected by the article, by the characteristics of the perceiving eye and brain, by the intensity and type of light used to illuminate the article (e.g., sunlight, incandescent light, fluorescent light, and the like), as well as other factors such as the coloration of the environment of the article. As a result, the structural color of an object as perceived by a viewer can differ from the actual color of the article.

Conventionally, color is imparted to man-made objects by applying colored pigments or dyes to the object. Non-structurally colored materials are made of molecules which absorb all but particular wavelengths of light and reflect back the unabsorbed wavelengths, or which absorb and emit particular wavelengths of light. In non-structural color, it is the unabsorbed and/or the emitted wavelengths of light which impart the color to the article. As the color-imparting property is due to molecule’s chemical structure, the only way to remove or eliminate the color is to remove the molecules or alter their chemical structure.

More recently, methods of imparting “structural color” to man-made objects have been developed. Structural color is color that is produced, at least in part, by microscopically structured surfaces that interfere with visible light contacting the surface. The structural color is color caused by physical phenomena including the scattering, refraction, reflection, interference, and/or diffraction of light, unlike color caused by the absorption or emission of visible light through coloring matters. For example, optical phenomena which impart structural color can include single- or multi-layer interference, thin-film interference, refraction, dispersion, light scattering, Mie scattering, diffraction, and diffraction grating. As structural color is produced by physical structures, destroying or altering the physical structures can eliminate or alter the imparted color. The ability to eliminate color by destroying the physical structure, such as by grinding or melting an article can facilitate recycling and reuse colored materials. In various aspects described herein, structural color imparted to an article can be visible to an observer having 20/20 visual acuity and normal color vision from a distance of about 1 meter from the article, when the structurally-colored region is illuminated by about 30 lux of sunlight, incandescent light, or fluorescent light. In some such aspects, the structurally-colored region is at least one square centimeter in size to 10s of centimeters in size.

As described herein, structural color is produced, at least in part, by the optical element, as opposed to the color being produced solely by pigments and/or dyes. The coloration of an article can be due solely to structural color (i.e., the article, a colored portion of the article, or a colored outer layer of the article can be substantially free of pigments and/or dyes). Structural color can also be used in combination with pigments and/or dyes, for example, to alter all or a portion of the structural color.

In another aspect, the optical element can impart a “combined color,” where a “combined color” can be described as having a structural color component and a non-structural color component. For example, the structural color can be used in combination with pigments and/or dyes to alter all or a portion of the structural color, forming a combined structural color. In a combined color, the structural color component, when viewed without the non-structural color component, imparts a structural color having a first structural color and the non-structural color component, when viewed without the structural color component imparts a second color, where the first structural color and the second color differ. Further in this aspect, when viewed together, the first structural color and the second color combine to form a third combined color, which differs from either the first structural color or the second color, for example, through shifting the reflectance spectrum of the optical element.

In another aspect, an optical element can impart a “modified color,” where a “modified color” can be described as having a structural color component and a modifier component. In a modified color, the structural color component, when viewed without the modifier component, imparts a structural color and the modifier component, when viewed without the structural color component, does not impart any color, hue, or chroma. Further in this aspect, when viewed together, the modifier component can expand, narrow, or shift the range of wavelengths of light reflected or absorbed by the structural color component. In still another aspect, an optical element can impart a “modified combined color,” where a “modified combined color” can be described as having a structural color component having a first structural color, a non-structural color component having a second color, and a modifier component not imparting a color but instead functioning to expand, narrow, or shift the range of wavelengths of light reflected by the combined color formed from the structural color component and the non-structural color component.

In one aspect, the structural color component, combined color component, or modified color component disclosed herein is opaque; that is, it prevents light from passing through any articles to which they are applied. Further in this aspect, most wavelengths of light are absorbed by one or more layers of the structural color, combined color, or modified color component, with only a narrow band of light reflected about the wavelength of maximum reflectance.

“Hue” is commonly used to describe the property of color which is discernible based on a dominant wavelength(s) of visible light, and is often described using terms such as magenta, red, orange, yellow, green, cyan, blue, indigo, violet, etc. or can be described in relation (e.g., as similar or dissimilar) to one of these. The hue of a color is generally considered to be independent of the intensity or lightness of the color. For achromatic color, the hue is typically zero and lightness imparts the white, black, or gray color (or shade) as opposed to chromatic where hue and lightness can have zero or non-zero values depending upon the chromatic color. For example, in the Munsell color system, the properties of color include hue, value (lightness) and chroma (color purity) (e.g., achromatic has a zero or close to zero value for hue and chroma, whereas chromatic can have zero or non-zero values depending upon the chromatic color). Particular hues are commonly associated with particular ranges of wavelengths in the visible spectrum (e.g., about 380 to 740 nanometers): wavelengths in the range of about 700 to 635 nanometers are associated with red, the range of about 635 to 590 nanometers is associated with orange, the range of about 590 to 560 nanometers is associated with yellow, the range of about 560 to 520 nanometers is associated with green, the range of about 520 to 490 nanometers is associated with cyan, the range of about 490 nanometers to 450 nanometers is associated with blue, and the range of about 450 to 400 nanometers is associated with violet. As described herein, that achromatic color can have no hue or chroma and the achromatic color is a color in which no particular wavelength or hue predominates, as all wavelengths or hues are present in equal parts or substantially equal parts. The achromatic color can be selected from black, white, or neutral gray. The chromatic color can be selected from a red/yellow/blue (RYB) primary color, a RYB secondary color, a RYB tertiary color, a RYB quaternary color, a RYB quinary color, or a chromatic color that is a combination thereof. The chromatic color can be red, yellow, blue, green, orange, purple, or a chromatic color that is a combination thereof. The chromatic color can be red, orange, yellow, green, blue, indigo, violet, or a chromatic color that is a combination thereof. The wavelength range can be about 380 to 740 nanometers and can be measured as a function of absorbance or reflectance, each of which can be used to define the chromatic or achromatic structural color imparted by the optical element.

While the optical element may impart a first structural color, the presence of an optional textured surface can alter the structural color or in the alternative have no impact on the first structural color. Other factors such as coatings or transparent elements may further alter the perceived structural color.

In some embodiments, the structural color of a structurally-colored article does not change substantially, if at all, depending upon the angle at which the article is observed or illuminated. In instances such as this the structural color can be an angle-independent or when observed is substantially independent or is independent of the angle of observation.

Other factors such as coatings or transparent elements may further alter the perceived structural color. The structural color can be referred to as a “non-shifting” (i.e., the color remains substantially the same, regardless of the angle of observation and/or illumination), or “shifting” (i.e., the structural color varies depending upon the angle of observation and/or illumination). For example, a shift can occur over a small change in the angle of observation and/or illumination (e.g., less than 5 degrees, less than 7 degrees, or less than 10 degrees, but this is dependent upon the particular optical element). In another example, the shift can occur over a larger angle of observation and/or illumination (e.g., greater than 10 degrees, greater than 12 degrees, greater than 15 degrees but this is dependent upon the particular optical element). In an aspect, the shifting color can change gradually (e.g., as the angle changes by 4 or 5 degrees) over two or more shades or colors. In as aspect, the shifting color can shift upon reaching a threshold change (e.g., an abrupt (e.g., a change of 1 to 3 degrees) or the change is gradual (e.g., a change of about 4 to 8 degrees), and not abrupt, in angle of observation or illumination (e.g., a change of more than 10, 12, or 15 degrees). For example, an abrupt change can occur as the angle changes from 14 to 15 degrees, whereas a gradual change can occur as the angle changes from 13 to 17 degrees. Thus, the shifting of the structural color can change gradually or abruptly as the angle of observation or illumination changes, which can be determined by the design of the optical element.

In an example, the shift in structural color can be observed as the angle of observation or illumination changes from 13 to 15 degree (an abrupt change). In another example, the shift in structural color can be observed as the angle of observation or illumination changes from 12 to 17 degree (a gradual change). These examples simply illustrate that the shifting can be varied and diverse and the optical element can be designed according to the desired outcome.

As discussed above, the color of a structurally-colored article (e.g., an article include structural color) can be independent of or vary depending upon the angle at which the structurally-colored article is observed or illuminated. As used herein, the “angle” of illumination or viewing is the angle measured from an axis or plane that is orthogonal to the surface. The viewing or illuminating angles can be set between about 0 and 180 degrees. The viewing or illuminating angles can be set at 0 degrees, 5 degrees, 10 degrees, 15 degrees, 30 degrees, 45 degrees, 60 degrees, and -15 degrees (as well as increments of 1 within the ranges described above and herein) and the color can be measured using a colorimeter or spectrophotometer (e.g., Konica Minolta), which focuses on a particular area of the article to measure the color. The viewing or illuminating angles can be set at 0 degrees, 5 degrees, 10 degrees, 15 degrees, 30 degrees, 45 degrees, 60 degrees, 75 degrees, 90 degrees, 105 degrees, 120 degrees, 135 degrees, 150 degrees, 165 degrees, 180 degrees, 195 degrees, 210 degrees, 225 degrees, 240 degrees, 255 degrees, 270 degrees, 285 degrees, 300 degrees, 315 degrees, 330 degrees, and 345 degrees and the color can be measured using a colorimeter or spectrophotometer

Various methodologies for defining color coordinate systems exist. One example is L*a*b* color space, where, for a given illumination condition, L* is a value for lightness, and a* and b* are values for color-opponent dimensions based on the CIE coordinates (CIE 1976 color space or CIELAB) (e.g., a* and b* are 0 or close to 0). In an embodiment, a structural color can be considered as having a “single” color when the change in color measured for the article is within about 10 percent or within about 5 percent of the total scale of the a* or b* coordinate of the L*a*b* scale (CIE 1976 color space) at three or more measured observation or illumination angles selected from measured at observation or illumination angles of 0 degrees, 15 degrees, 30 degrees, 45 degrees, 60 degrees, and -15 degrees.

Another example of a color scale is the CIELCH color space, where, for a given illumination condition, L* is a value for lightness, C* is a value for chroma, and h° denotes a hue as an angular measurement (e.g., C* and h° are 0 or close to 0). In an embodiment, a structural color can be considered as having a “single” color when the color measured for the article is less than 10 degrees different or less than 5 degrees different at the h° angular coordinate of the CIELCH color space, at three or more measured observation or illumination angles selected from measured at observation or illumination angles of 0 degrees, 15 degrees, 30 degrees, 45 degrees, 60 degrees, and -15 degrees. In certain embodiments, colors which, when measured and assigned values in the CIELCH system that vary by at least 45 degrees in the h° measurements, are considered to be different colors.

Another system for characterizing color includes the “PANTONE” Matching System (Pantone LLC, Carlstadt, New Jersey, USA), which provides a visual color standard system to provide an accurate method for selecting, specifying, broadcasting, and matching colors through any medium. In an example, an optical element at different angles (or different areas of the optical element: main body and transition region) can be said to have the same color when the color measured for the optical element is within a certain number of adjacent standards, e.g., within 20 adjacent PANTONE standards, at three or more measured observation or illumination angles selected from 0 degrees, 15 degrees, 30 degrees, 45 degrees, 60 degrees, and 75 degrees. In an alternative aspect, the optical element (or different areas of the optical element: main body and transition region) at different angles can be said to have different colors when the color measured for the optical element is outside a certain number of adjacent standards, e.g., at least 20 adjacent PANTONE standards or farther apart, at three or more measured observation or illumination angles selected from 0 degrees, 15 degrees, 30 degrees, 45 degrees, 60 degrees, and 75 degrees. In another aspect, an optical element can be said to be single color when all areas of the optical element have the same PANTONE color as defined herein, or can be multi-colored when at least two areas of the optical element have different PANTONE colors. In another aspect, a single optical element can be said to have a non-shifting color if it exhibits the same PANTONE color as defined herein at three or more measured observation or illumination angles (e.g., 0 degrees, 15 degrees, 30 degrees, 45 degrees, 60 degrees, and -15 degrees). In an alternative aspect, a single optical element can be said to be shifting if it exhibits two, three, or four different PANTONE colors as defined herein at two or more measured observation or illumination angles (e.g., 0 degrees, 15 degrees, 30 degrees, 45 degrees, 60 degrees, and -15 degrees).

Another example of a color scale is the Natural Color System® or NCS, which is built on principles of human physiological vision and describes color by using color similarity relationships. The NCS is based on the premise that the human visual system consists of six elementary color precepts, or colors that can be challenging to define perceptually in terms of other colors. These colors consist of three pairs: (i) the achromatic colors of black (S) and white (W), (ii) the opposing primary color pair of red (R) and green (G), and (iii) the opposing primary color pair of yellow (Y) and blue (B). In the NCS, any color that can be perceived by the human eye can be similar to the two achromatic colors and a maximum of two non-opposing primary colors. Thus, for example, a perceived color can have similarities to red and blue but not to red and green. NCS descriptions of colors are useful for colors that belong to the surfaces of materials, so long as the surfaces are not fluorescent, translucent, luminescent, or the like; the NCS does not encompass other visual properties of the surface such as, for example, gloss and texture.

The NCS color space is a three dimensional model consisting of a flat circle at which the four primary colors are positioned in order at 0 degrees, 90 degrees, 180 degrees, and 270 degrees. For example, if yellow is at 0 degrees, red is at 90 degrees, blue is at 180 degrees, and green is at 270 degrees. White is represented above the circle and black below such that a hue triangle forms between the black/white (grayscale) axis and any point on the circle.

Percentage “blackness” (s) is defined in the NCS as a color’s similarity to the elementary color black. Percentage “chromaticness” (c) represents similarity to the most saturated color in a hue triangle. “Hue” (ϕ) in the NCS, meanwhile, represents similarity of a color to one or at most two non-opposing primary colors. Blackness and chromaticness add up to a value less than or equal to 100 percent; any remaining value is referred to as “whiteness” (w) of a color. In some cases, the NCS can be used to further describe “saturation” (m), a value from 0 to 1 determined in terms of chromaticness and whiteness (e.g., m = c/(w+c)). NCS can further be used to describe “lightness” (v), a description of whether the color contains more of the achromatic elementary colors black or white. A pure black article would have a lightness of 0 and a pure white article would have a lightness of 1. Purely neutral grays (c = 0) have lightness defined by v = (100-s)/100, while chromatic colors are first compared to a reference scale of grays and lightness is then calculated as for grays.

NCS notation takes the generic form sc-AϕB, where sc defines “nuance,” ss is the percent blackness and cc refers to the chromaticity; A and B are the two primary colors to which the color relates; and ϕ is a measure of where a color falls between A and B. Thus, a color (e.g., orange) that has equal amounts of yellow and red could be represented such that AϕB = Y50R (e.g., yellow with 50 percent red), whereas a color having relatively more red than yellow is represented such that AϕB = Y60R, Y70R, Y80R, Y90R, or the like. The color having equal amounts of yellow and red with a relatively low (10 percent) amount of darkness and a medium (50 percent) level of chromaticity would thus be represented as 1050-Y50R. In this system, neutral colors having no primary color components are represented by sc-N, where sc is defined in the same manner as with a non-neutral color and N indicates neutrality, while a pure color would have a notation such as, for example, 3050-B (for a blue with 30 percent darkness and 50 percent chromaticity). A capital “S” in front of the notation indicates that a value was present in the NCS 1950 Standard, a reduced set of samples. As of 2004, the NCS system contains 1950 standard colors.

The NCS is more fully described in ASTM E2970 - 15, “Standard Practice for Specifying Color by the Natural Colour System (NCS).” Although the NCS is based on human perception and other color scales such as the CIELAB or CIELCH spaces may be based on physical properties of objects, NCS and CIE tristimulus values are interconvertible.

In an example, an optical element at different angles or different areas of the optical element (e.g., main body and transition region) can be considered as being the same structural color when the structural colors measured for the optical element (or different areas) are within a certain number of adjacent standards, e.g., within 20 adjacent NCS values, at three or more measured observation or illumination angles selected from 0 degrees, 15 degrees, 30 degrees, 45 degrees, 60 degrees, and -15 degrees. In another example, the optical element at different angles or different areas of the optical element (e.g., main body and transition region) can be considered as being different structural colors when the colors measured for the optical element or different areas are outside a certain number of adjacent standards, e.g., farther apart than at least 20 adjacent NCS values, at three or more measured observation or illumination angles selected from 0 degrees, 15 degrees, 30 degrees, 45 degrees, 60 degrees, and -15 degrees. In another aspect, an optical element can be said to be a single structural color when it has the same NCS color as defined herein, or can be multi-colored when at least two areas of the optical element (e.g., main body and transition region) have different NCS colors. In another aspect, a single optical element can be said to have a non-shifting color if it exhibits the same NCS color as defined herein at three or more measured observation or illumination angles (e.g., 0 degrees, 15 degrees, 30 degrees, 45 degrees, 60 degrees, and -15 degrees). In an alternative aspect, a single optical element can be said to be shifting color if it exhibits two, three, or four different NCS colors as defined herein at two or more measured observation or illumination angles (e.g., 0 degrees, 10 degree, 15 degrees, 30 degrees, 45 degrees, 60 degrees, and -15 degrees).

A change or difference in color between two measurements (the same or different angles for a single structural color) and/or two colors (e.g., first structural color and the second structural color from the same of different angles) in the CIELAB space can be determined mathematically. For example, a first measurement (e.g., a first structural color) has coordinates L₁*, a₁* and b₁*, and a second measurement (e.g., a second structural color or the first structural color from a different angle) has coordinates L₂*, a₂* and b₂*. The total difference between these two measurements on the CIELAB scale can be expressed as ΔE*_{ab}, which is calculated as follows: ΔE*_{ab}= [(L₁*-L₂*)² + (a₁*-a₂*)² + (b₁*-b₂*)²]^{½}. Generally speaking, if two colors (e.g., first structural color and the second structural color) have a ΔE*_{ab} of less than or equal to 1, the difference in color is not perceptible to human eyes, and if two colors (e.g., first structural color and the second structural color (or the first structural color from a different angle)) have a ΔE*_{ab} of greater than 100 the colors are considered to be opposite colors, while a ΔE*_{ab} of about 2-3 is considered the threshold for perceivable color difference from someone with 20 20 visual acuity from a distance of about 1 meter from the article under the same lighting conditions.

In certain embodiments, a structural color (e.g., first structural color) can be considered as having a “single” color when the ΔE*_{ab} is less than 2, or less than 3, between three or more measured observation or illumination angles selected from measured at observation or illumination angles of 0 degrees, 10 degrees, 15 degrees, 30 degrees, 45 degrees, 60 degrees, and -15 degrees.

In regard to a potential difference between structural color, at the same area of the optical element the structural color can be observed at two different angles of observation. The difference can be determined in the CIELAB space mathematically. For example, a first measurement (e.g., obtained from a first angle) has coordinates L₁*, a₁* and b₁*, and a second measurement (e.g., obtained from a second angle) has coordinates L₂*, a₂* and b₂*. The total difference between these two measurements on the CIELAB scale can be expressed as ΔE*_{ab}, which is calculated as follows: ΔE*_{ab}= [(L₁*-L₂*)² + (a₁*-a₂*)² + (b₁*-b₂*)²]^{½}. Generally speaking, if two structural colors have a ΔE*_{ab} of less than or equal to 1, the difference in color is not perceptible to human eyes, and if two structural colors have a ΔE*_{ab} of greater than 100 the colors are considered to be opposite colors, while a ΔE*_{ab} of about 2-3 is considered the threshold for perceivable color difference and can depend upon the person perceiving the structural colors, the illumination considerations, and the like. The first structural color and the second structural color (or first structural color from a different angle) can be different in that they can have a ΔE*_{ab} of greater than about 2.2, greater than about 3, greater than about 4, greater than about 5, or greater than about 10 or more. The first structural color and the second structural color can be the same or substantially the same in that they can have a ΔE*_{ab} of less than about 3 or less than about 2. Since the threshold of perceivable color difference is about 2-3 and the perception is depended upon the person perceiving, the conditions, and the like, the first structural color and the second structural color may be subjectively the same or different depending upon the circumstance from someone with 20 20 visual acuity from a distance of about 1 meter from the article under the same lighting conditions.

The method of making the structurally colored article can include disposing (e.g., affixing, attaching, bonding, fastening, joining, appending, connecting, binding) the optical element onto an article (e.g., an article of footwear, an article of apparel, an article of sporting equipment, etc.) in an “in-line” or “on its side” configuration. The article includes a component, and the component has a surface upon which the optical element can be disposed. The surface of the article can be made of a material such as a thermoplastic material or thermoset material, as described herein. For example, the article has a surface including a thermoplastic material (i.e., a first thermoplastic material), for example an externally-facing surface of the component or an internally-facing surface of the component (e.g., an externally-facing surface or an internally-facing surface a bladder). The optical element can be disposed onto the thermoplastic material, for example. The surface upon which the optical element is disposed is not opaque and is semi-transparent or transparent to light in from 380 to 740 nanometers, for example, the surface can have a minimum percent transmittance of about 30 percent or more, about 40 percent or more, or about 50 percent or more, for light in the visible spectrum.

In an aspect, the temperature of at least a portion of the first surface of the article including the thermoplastic material is increased to a temperature at or above creep relaxation temperature (Tcr), Vicat softening temperature (Tvs), heat deflection temperature (Thd), and/or melting temperature (Tm) of the thermoplastic material, for example to soften or melt the thermoplastic material. The temperature can be increased to a temperature at or above the creep relaxation temperature. The temperature can be increased to a temperature at or above the Vicat softening temperature. The temperature can be increased to a temperature at or above the heat deflection temperature. The temperature can be increased to a temperature at or above the melting temperature. While the temperature of the at least a portion of the first side of the article is at or above the increased temperature (e.g., at or above the creep relaxation temperature, the heat deflection temperature, the Vicat softening temperature, or the melting temperature of the thermoplastic material), the optical element is affixed to the thermoplastic material within the at least a portion of the first side of the article. Following the affixing, the temperature of the thermoplastic material is decreased to a temperature below its creep relaxation temperature to at least partially re-solidify the thermoplastic material. The thermoplastic material can be actively cooled (e.g., removing the source that increases the temperature and actively (e.g., flowing cooler gas adjacent the article reducing the temperature of the thermoplastic material) or passively cooled (e.g., removing the source that increases the temperature and allowing the thermoplastic layer to cool on its own).

Now having described color and other aspects generally, additional details regarding the optical element are provided. FIG. 3A is a top-view of a substrate 400 such as an article of footwear. This portion of the substrate 400 includes four optical elements that impart the first structural color 402, structural color Q 404, structural color R 406, and structural color S 408. In a region between optical elements is the underlying substrate upon which the four optical elements are disposed, where the substrate has a color W 412. Each of the first structural color 402, structural color Q 404, structural color R 406, structural color S 408, and color W 412 is different in one or more of a hue, a value, a chroma, or any combination thereof when viewed from the same angle of observation from someone with 20 20 visual acuity from a distance of about 1 meter from the article under the same lighting conditions.

FIG. 3B is an expanded top-view of a region 416 of FIG. 3A to better illustrate the transition region 414 of the optical element 418 and the underlying substrate 416. The transition region 414 can have a transition region color that can be a structural color or non-structural color. While reference is made to the transition region color, the transition region color represents one or more colors as the color of the transition region color can be the same or different as a function of the width of the transition region (e.g., transition sectors) and/or the length of the transition region (e.g., a first transition region, a second transition region, and the like). In other words, the transition region color can represent 2-10 or 2-100s or more of colors and it can be one or a combination of structural color and/or non-structural colors. FIGS. 4A-4C illustrate cross-sections of A-A (e.g., first transition region 422), B-B (e.g., second transition region 424), and C-C (e.g., third transition region 426) in FIG. 3B as well a top-views of each of those areas, where each pair of these areas can be adjacent one another or separated by about 0.01 millimeters to 0.1 millimeters, about 0.01 millimeters to 0.5 millimeters, about 1 millimeter to 10 millimeters, about 1 millimeter to 1 centimeter, about 1 centimeter to 5 centimeters, about 1 centimeter to 10 centimeters, or about 2 centimeters to 5 centimeters.

FIG. 4A is a cross-sectional view (top) and top-view of section A-A 422 in FIG. 3B. The cross-sectional view illustrates multiple layers of material disposed on a substrate 502. The substrate 502 can be a material such as a polymer (e.g., such as those described herein, e.g., synthetic leather), leather, a metal, wood, plastic, and other materials used to make articles of footwear, sporting equipment, or apparel, which may be part of the article or the substrate is disposed on the article. The first substrate area 504 does not include the optical element. The second substrate area 506 and the third substrate 508 area include the optical element (e.g., the main body of the optical element 518 and the transition region 414). The main body 518 of the optical element is on the third substrate area 508 and includes 4 optical layers, where the main body 518 of the optical element imparts a first structural color 402. The transition region 414 is in a second substrate area 506 and includes one or more fewer optical layers than the main body 518 of the optical element. The transition region 414 can include only one layer but can include 2 or 3. The transition region width 414a can be less than 1 millimeter wide or can be wider, such as about 1 to 3 millimeters wide or about 1 to 5 millimeters wide or 1 to 100 millimeters wide or 1 to 1000 millimeters wide or more. The transition region length 414b can have a length of about 1 to 3 centimeters or about 1 to 5 centimeters or about 1 to 10 centimeters, or about 1 to 100 centimeters or about 1 to 1000 centimeters. The transition region 414 includes 1, 2 and 3 layers along the width of the transition region. The transition region 414 can have a transition region color, where the transition region color can be a single color or multiple colors along the width of the transition region. For example, along the width of the transition region 414, the transition region 414 includes a first transition sector 522, a second transition sector 524, and a third transition sector 526, where each can have the same color or different colors. The transition region color(s) can be a structural color or a non-structural color, and when more than one color is present along the width, one or more colors can be a structural color and one or more can be a non-structural color. As shown in FIG. 4A, the width of each layer in the transition region is different, which can result in the different colors or the same along the width (as shown in the top view). Also, but not shown, the thickness of one or more layers can be less than that of a corresponding layer in the main body of the optical element. In general, the overall thickness of the transition region 414 decreases from the main body 518 of the optical element to the substrate 502, but it can vary as the width as well (not shown in the figures). For example, the thickness of the transition region 414 can decrease then increase before decreasing towards the end of the transition region 414.

The bottom diagram in FIG. 4A illustrates a top view of the A-A cross section. This diagram illustrates that the first structural color 402 imparted by the optical element is R and the color 412 of the substrate is W. The transition region, as illustrated, includes the first transition sector 522 having a color A, the second transition sector 524 having a color B, and the third transition sector 526 having a color C. These colors, independent of one another, can be structural and/or non-structural. The top view illustrates that the article including the substrate can be aesthetically appealing by the variation is color.

FIG. 4B is a cross-sectional view (top) and top-view of section B-B 424 (second transition region) in FIG. 3B. The cross-sectional view illustrates multiple layers of material disposed on a substrate 502. The first substrate area 604 illustrates the substrate surface 416 and has a color 412 W. The optical element is disposed on the second substrate area 606 and the third substrate area 608. The main body 618 is on the third substrate area 608 and has 4 optical layers, where the optical element imparts a first structural color 402. The transition region 414 is in a second substrate area 606 and includes 1, 2 and 3 layers along the width of the transition region 414, where the width in this region is much narrower than that illustrated in FIG. 4A, which illustrates that along the length of the transition region 414 the transition region color 620 can change (e.g., first transition region color 520 vs the second transition region color 620). The transition region width 414c can be less than 1 millimeter wide or can be wider, such as about 1 to 3 millimeters wide or about 1 to 5 millimeters wide or 1 to 100 millimeters wide or 1 to 1000 millimeters wide or more. The transition region length 414d can have a length of about 1 to 3 centimeters or about 1 to 5 centimeters or about 1 to 10 centimeters, or about 1 to 100 centimeters or about 1 to 1000 centimeters. The transition region color 620 can be a single color or multiple colors along the width of the transition region 414. The transition region color(s) can be a structural color or a non-structural color, and when more than one color is present along the width, one or more colors can be a structural color and one or more can be a non-structural color. As shown in FIG. 4B, the width of each layer in the transition region 414c is different, which can result in the different colors along the width but as compared to FIG. 4A is only a single transition region color. Also, but not shown, the thickness of one or more layers can be less than that of a corresponding layer in the main body 618 of the optical element.

The bottom diagram in FIG. 4B illustrates a top view of the B-B cross section. This diagram illustrates that the first structural color 402 imparted by the optical element is R and the color 412 of the substrate is W. The transition region 414 (which in this instance is identical to the transition sector in contrast to FIG. 4A), as illustrated, has a transition region color A 622. The top view illustrates that the article including the substrate 502 can be aesthetically appealing, which when viewed in conjunction with FIG. 4A shows that the “color” of the transition region 414 can vary as a function of width and length.

FIG. 4C is a cross-sectional view (top) and top-view of section C-C 426 (third transition region) in FIG. 3B. The cross-sectional view illustrates multiple layers of material disposed on a substrate 502. The first substrate area 704 illustrates the substrate surface 416 and has a color 412 W. The optical element is disposed on the second substrate area 706 and the third substrate area 708. The main body 718 is on the third substrate area 708 and has 4 optical layers, where the optical element imparts a first structural color 402. The transition region 414 is in a second substrate area 706. The transition region 414 includes 1 or 2 layers along the width of the transition region 414, where the width in this transition region 414 is larger than that illustrated in FIGS. 4A and 4B, which illustrates that along the length of the transition region the transition region color can change. The transition region width 414e can be less than 1 millimeter wide or can be wider, such as about 1 to 3 millimeters wide or about 1 to 5 millimeters wide or 1 to 100 millimeters wide or 1 to 1000 millimeters wide or more. The transition region length 414f can have a length of about 1 to 3 centimeters or about 1 to 5 centimeters or about 1 to 10 centimeters, or about 1 to 100 centimeters or about 1 to 1000 centimeters. The transition region 414 can be a transition region color 720, where the transition region color 720 can be a single color or multiple colors along the width of the transition region. The transition region color(s) can be a structural color or a non-structural color. As shown in FIG. 4C, the width of each layer in the transition region 414 is different, where an underlying layer is less than a layer above it, which may be due to the abrasive force applied, for example. Also, but not shown, the thickness of one or more layers can be less than that of a corresponding layer in the main body of the optical element.

The bottom diagram in FIG. 4C illustrates a top view of the C-C cross section. This diagram illustrates that the first structural color imparted by the optical element is R and the color of the substrate is W. The transition region 414 (which in this instance is identical to the transition sector in contrast to FIG. 4A), as illustrated, has a transition region color A 722. The top view illustrates that the article including the substrate 502 can be aesthetically appealing, which when viewed in conjunction with FIG. 4A shows that the “color” of the transition region can vary as a function of width and length.

As described herein, the optical element includes the main body and the transition region. The following discussion generally refers to the optical element, but the description applies to the main body and the transition region as is consistent with the differences described herein (e.g., transition region has few layers, etc.). The following provides a description of the optical element and this applies equally to the main body and the transition region. For example, the dimensions of the layers, the number (less at least 1) of layers, the material constitution of the layers, the method of making the layers, the use of textured layers, the refractive index of the layers, the type of layer (e.g., reflective or constituent layers), and the like of the optical element are the same or similar for the transition region and the main body.

The optical element can be an inorganic optical element, an organic optical element, or a mixed inorganic/organic optical element. The organic optical element has at least one layer and that layer is made of an organic material. The organic material can include a polymer, such as those described herein. The organic material is made of a non-metal or non-metal oxide material. The organic material that does not include a metal or metal oxide or alloy. The organic material is made of a polymeric material that does not include a metal or metal oxide or alloy.

The inorganic optical element has at least one layer and that layer is made of a non-organic material. As described in detail herein, the non-organic material can be a metal, metal oxide, and alloys. The non-organic material does not include any organic material.

The optical element can be a mixed inorganic/organic optical element, meaning that one or more of the layers can be made of an inorganic material, one or more layers can be made of an organic material, and/or one or more layers can be made of a layer of a mixture of inorganic and organic materials (e.g., a polymer include metal or metal oxide particles (e.g., micro- or nano-particles).

The optical element includes at least one layer, which can be at least one constituent layer and/or at least one reflective layer (e.g., intermediate and/or non-intermediate reflective layers). The optical element that can be or include a single layer reflector, a single layer filter, or multilayer reflector or a multilayer filter. The optical element can function to modify the light that impinges thereupon so that structural color is imparted to the article. The optical element can also optionally include one or more additional layers (e.g., a protective layer, the textured layer, a polymeric layer, and the like). The optical element can have a thickness (or height) of about 50 to 100 nanometers, about 50 to 150 nanometers, about 50 to 500 nanometers, about 100 to 1,500 nanometers, about 100 to 1,200 nanometers, about 100 to about 700 nanometers, or of about 200 to about 500 nanometers.

The optical element, or layers or portions thereof (e.g., reflective layer, constituent layer) can be formed using known techniques such as physical vapor deposition, electron beam deposition, atomic layer deposition, molecular beam epitaxy, cathodic arc deposition, pulsed laser deposition, sputtering deposition (e.g., radio frequency, direct current, reactive, non-reactive), chemical vapor deposition, plasma-enhanced chemical vapor deposition, low pressure chemical vapor deposition and wet chemistry techniques such as layer-by-layer deposition, sol-gel deposition, Langmuir blodgett, and the like, which can optionally use techniques (e.g., masks) to control the thickness of a layer in one or more areas of the surface of the article. The temperature of the first side can be adjusted using the technique to form the optical element and/or a separate system to adjust the temperature.

As stated herein, the optical element can comprise a single layer or multilayer reflector (e.g., reflective layer(s) and/or constituent layer(s)). The multilayer reflector can be configured to have a certain reflectivity at a given wavelength of light (or range of wavelengths) depending, at least in part, on the material selection, thickness and number of the layers of the multilayer reflector. In other words, one can judiciously select the materials, thicknesses, and numbers of the layers of a multilayer reflector and optionally its interaction with one or more other layers, so that it can reflect a certain wavelength of light (or range of wavelengths), to produce a desired structural color.

The optical element (main body) can include 1 to 20 layer, 2 to 20 layers, 3 to 20 layer, 4 to 20 layers, 5 to 20 layers 1 to 10 layer, 2 to 10 layers, 3 to 10 layers, 4, to 10 layers, 5 to 10 layers. Each layer can have a thickness that is about one-fourth of the wavelength of light to be reflected to produce the desired structural color. Each layer can have a thickness (or height) of at least 10 nanometers, optionally at least 30 nanometers, at least 40 nanometers, at least 50 nanometers, at least 60 nanometers, at least 100 nanometers, at least 150 nanometers, optionally a thickness of from about 10 nanometers to about 500 nanometers, about 10 nanometers to about 250 nanometers, about 10 nanometers to about 200 nanometers, about 10 nanometers to about 150 nanometers, about 10 nanometers to about 100 nanometers, or of from about 30 nanometers to about 80 nanometers, or from about 40 nanometers to about 60 nanometers. For example, the layer can be about 30 to 200 nanometers or about 30 to 150 nanometers, or about 20 to 50 nanometers thick.

The optical element can have an area of about 1 micrometer squared to 100 centimeters squared, about 1 centimeter squared to 50 centimeters squared, about 5 centimeters squared to 25 centimeters squared, about 5 centimeters squared to 10 centimeters squared, or about 1 centimeter squared to 5 centimeters squared. In an aspect, the second element can have a second element length of about 1 micrometer to 500 centimeters, 1 centimeter to 100 centimeters, about 5 centimeters to 25 centimeters, about 5 centimeters to 10 centimeters, or about 1 centimeter to about 5 centimeters. In an aspect, the second element can have a second element width of about 1 micrometer to 500 centimeters, 1 centimeter to 100 centimeters, about 5 centimeters to 25 centimeters, about 5 centimeters to 10 centimeters, or about 1 centimeter to about 5 centimeters. In an aspect, the opticll element can have a second element radius of about 1 micrometer to 500 centimeters, 1 centimeter to 100 centimeters, about 5 centimeters to 25 centimeters, about 5 centimeters to 10 centimeters, or about 1 centimeter to about 5 centimeters.

The optical element can comprise a single layer or multilayer filter. The single layer or multilayer filter destructively interferes with light that impinges upon the article, where the destructive interference of the light and optionally interaction with one or more other layers or structures of the optical element (e.g., a multilayer reflector, a textured structure) impart the structural color. In this regard, the layer of the single layer filter or the layers of the multilayer filter can be designed (e.g., material selection, thickness, number of layer, and the like) so that a single wavelength of light, or a particular range of wavelengths of light, make up the structural color. For example, the range of wavelengths of light can be limited to a range within plus or minus 30 percent or a single wavelength, or within plus or minus 20 percent of a single wavelength, or within plus or minus 10 percent of a single wavelength, or within plus or minus 5 percent or a single wavelength. The range of wavelengths can be broader to produce a more iridescent structural color.

Each layer of the optical element can independently include a metal layer, an oxide layer, a metal alloy, or stainless steel. The oxide layer can be a metal oxide, a doped metal oxide, or a combination thereof. The metal layer, the metal oxide or the doped metal oxide, or metal alloy can include the following: the transition metals, the metalloids, the lanthanides, and the actinides, as well as nitrides, oxynitrides, sulfides, sulfates, selenides, tellurides and a combination of these. The metal layer can be titanium, aluminum, silver, zirconium, chromium, magnesium, silicon, gold, platinum, and a combination thereof or alloys thereof. The metal oxide can include titanium oxide, silver oxide, aluminum oxide, silicon dioxide, tin dioxide, chromia, iron oxide, nickel oxide, silver oxide, cobalt oxide, zinc oxide, platinum oxide, palladium oxide, vanadium oxide, molybdenum oxide, lead oxide, and combinations thereof as well as doped versions of each. In some aspects, the layer can consist essentially of a metal oxide. In some aspects, the layer can consist essentially of titanium dioxide. The metal oxide can be doped with water, inert gasses (e.g., argon), reactive gasses (e.g., oxygen or nitrogen), metals, and a combination thereof. In some aspects, the reflective layer can consist essentially of a doped metal oxide or a doped metal oxynitride or both. In an aspect, the reflective layer can be made of Ti or TiTiOₓ (x=1-2). The density of the Ti layer or TiOₓ layer can be about 3 to 6 grams per centimeter cubed, about 3 to 5 grams per centimeter cubed, about 4 to 5 grams per centimeter cubed, or 4.5 grams per centimeter cubed.

In addition, each layer can be made of liquid crystals. Each layer can be made of a material such as: silicon dioxide, titanium dioxide, zinc sulfide, magnesium fluoride, tantalum pentoxide, aluminum oxide, or a combination thereof. To improve adhesion between layers, a metal layer is adjacent a metal oxide layer formed of the same metal. For example, Ti and TiOₓ can be positioned adjacent one another to improve adhesion.

The material of the layer can be selected based on the desired structural color to be produced. Select materials reflect some wavelengths more than other wavelengths. In this way, the material of the layer can be selected based on the desired structural color. The optical element can be made with a combination of constituent layers and/or reflective layers so that the desired structural color is imparted. The optical element can include a reflective layer can have a minimum percent reflectance of about 50 percent or more (e.g., up to about 70 percent, about 80 percent, about 90 percent, about 95 percent, about 99 percent, or 100 percent) or optionally about 60 percent or more, about 70 percent or more, about 80 percent or more, about 90 percent or more, or about 95 percent or more. The optical element can include a reflective layer can have a minimum percent reflectance for one or more of the following wavelength ranges: violet 380 to 450 nanometer, blue 450 to 485 nanometer, cyan 485 to 500 nanometer, green 500 to 565 nanometer, yellow 564 to 590 nanometer, orange 590 to 625 nanometer, or red 625 to 740 nanometer. The reflective layer can have a minimum percent reflectance for one or more wavelength widths (e.g., about 10 nanometers, about 20 nanometers, about 30 nanometers, about 40 nanometers, about 50 nanometers, about 60 nanometers, about 75 nanometers, or about 100 nanometers) in the range from 380 to 740 nanometers. For the ranges not selected in a particular configuration, the minimum reflectivity is lower than that for the selected range, for example, the minimum reflectivity is lower than that for the selected range by about 10 percent or more, about 20 percent or more, about 30 percent or more, about 40 percent or more, or about 50 percent or more. In an aspect, the reflective layer can be Al or AlOₓ, where the structural color is iridescent. In another example, the reflective layer can Ti or TiOₓ, where the structural color can be one or more hues of blue or one or more hues of green, or a combination thereof.

The optical element can be a coating on the surface of the article. The coating can be chemically bonded (e.g., covalently bonded, ionically bonded, hydrogen bonded, and the like) to the surface of the article. The coating has been found to bond well to a surface made of a polymeric material. In an example, the surface of the article can be made of a polymeric material such as a polyurethane, including a thermoplastic polyurethane (TPU), as those described herein.

The material of the optical element can be uncolored (e.g., no pigments or dyes added to the structure or its layers), colored (e.g., pigments and/or dyes are added to the structure or its layers (e.g., dark or black color)). The surface of the component upon which the optical element is disposed can be uncolored (e.g., no pigments or dyes added to the material), colored (e.g., pigments and/or dyes are added to the material (e.g., dark or black color)), reflective, and/or transparent (e.g., percent transmittance of 75 percent or more).

The layers can be formed in a layer-by-layer manner, where each layer has a different index of refraction. Each of layers can be formed using known techniques such as those described above and herein.

As mentioned above, the optical element can include one or more layers in addition to the reflective layer(s) and/or the constituent layer(s). The optical element has a first side and a second side, where the first side or the second side is adjacent the surface of the component. The one or more other layers of the optical element can be on the first side and/or the second side of the optical element. For example, the optical element can include a protective layer and/or a polymeric layer such as a thermoplastic polymeric layer, where the protective layer and/or the polymeric layer can be on one or both of the first side and the second side of the optical element. One or more of the optional other layers can include a textured surface. Alternatively or in addition to, one or more of the reflective layer(s) and/or one or more constituent layer(s) of the optical element can include a textured surface.

A protective layer can be disposed on the first and/or second side of the optical element, on the outside most layer to protect the optical element. The protective layer is more durable or more abrasion resistant than the other layers. The protective layer is optically transparent to visible light. The protective layer can be on the first side and/or the second side of the optical element to protect the other layers on the respective side. All or a portion of the protective layer can include a dye or pigment in order to alter an appearance of the structural color. The protective layer can include silicon dioxide, glass, combinations of metal oxides, or mixtures of polymers. The protective layer can have a thickness of about 3 nanometers to 1 millimeter.

The protective layer can be formed using physical vapor deposition, chemical vapor deposition, pulsed laser deposition, evaporative deposition, sputtering deposition (e.g., radio frequency, direct current, reactive, non-reactive), plasma enhanced chemical vapor deposition, electron beam deposition, cathodic arc deposition, low pressure chemical vapor deposition and wet chemistry techniques such as layer by layer deposition, sol-gel deposition, Langmuir blodgett, and the like. Alternatively or in addition, the protective layer can be applied by spray coating, dip coating, brushing, spin coating, doctor blade coating, and the like.

A polymeric layer can be disposed on the first and/or the second side of the optical element. The polymeric layer can be used to dispose the optical element onto an article, such as, for example, when the article does not include a thermoplastic material to adhere the optical element. The polymeric layer can comprise a polymeric adhesive material, such as a hot melt adhesive. The polymeric layer can be a thermoplastic material and can include one or more layers. The thermoplastic material can be any one of the thermoplastic material described herein. The polymeric layer can be applied using various methodologies, such as spin coating, dip coating, doctor blade coating, and so on. The polymeric layer can have a thickness of about 3 nanometer to 1 millimeter.

Having described aspects, additional details will now be described for the optional textured surface. As described herein, the article includes the optical element that optionally include a textured surface, where the textured surface is distinct from the protrusions and indentations as described herein. The textured surface can be a surface of a textured structure or a textured layer. The textured surface may be provided as part of the optical element. For example, the optical element may comprise a textured layer or a textured structure that comprises the textured surface. The textured surface may be provided as part of the article to which the optical element is disposed. For example, the element may be disposed onto the surface of the article where the surface of the article is a textured surface, or the surface of the article includes a textured structure or a textured layer affixed to it.

The textured surface (or a textured structure or textured layer including the textured surface) may be provided as a feature on or part of another medium, such as a transfer medium, and imparted to a side or layer of the optical element or to the surface of the component. For example, a mirror image or relief form of the textured surface may be provided on the side of a transfer medium, and the transfer medium contacts a side of the optical element or the surface of the component in a way that imparts the textured surface to the optical element or article. While the various embodiments herein may be described with respect to a textured surface of the optical element, it will be understood that the features of the textured surface, or a textured structure or textured layer, may be imparted in any of these ways.

The textured surface can contribute to the structural color resulting from the optical element. As described herein, structural coloration is imparted, at least in part, due to optical effects caused by physical phenomena such as scattering, diffraction, reflection, interference or unequal refraction of light rays from an optical element. The textured surface (or its mirror image or relief) can include a plurality of profile features and flat or planar areas, which are distinct from the protrusions and indentions described herein. For example, the textured surface (e.g., profile features, flat or planar areas) are superimposed on the protrusions and indentations. In general, the size of the protrusions and indentations is larger than the profile features. The plurality of profile features included in the textured surface, including their size, shape, orientation, spatial arrangement, etc., can affect the light scattering, diffraction, reflection, interference and/or refraction resulting from the optical element. The flat or planar areas included in the textured surface, including their size, shape, orientation, spatial arrangement, etc., can affect the light scattering, diffraction, reflection, interference and/or refraction resulting from the optical element. The desired structural color can be designed, at least in part, by adjusting one or more of properties of the profile features and/or flat or planar areas of the textured surface.

The profile features can extend from a side of the flat areas, so as to provide the appearance of projections and/or depressions therein. A flat area can be a flat planar area. A profile feature may include various combinations of projections and depressions, which are distinct from the protrusions and indentations. For example, a profile feature may include a projection with one or more depressions therein, a depression with one or more projections therein, a projection with one or more further projections thereon, a depression with one or more further depressions therein, and the like. The flat areas do not have to be completely flat and can include texture, roughness, and the like. The texture of the flat areas may not contribute much, if any, to the imparted structural color. The texture of the flat areas typically contributes to the imparted structural color. For clarity, the profile features and flat areas are described in reference to the profile features extending above the flat areas, but the inverse (e.g., dimensions, shapes, and the like) can apply when the profile features are depressions in the textured surface.

The textured surface can comprise a thermoplastic material. The profile features and the flat areas can be formed using a thermoplastic material. For example, when the thermoplastic material is heated above its softening temperature a textured surface can be formed in the thermoplastic material such as by molding, stamping, printing, compressing, cutting, etching, vacuum forming, etc., the thermoplastic material to form profile features and flat areas therein. The textured surface can be imparted on a side of a thermoplastic material. The textured surface can be formed in a layer of thermoplastic material. The profile features and the flat areas can be made of the same thermoplastic material or a different thermoplastic material.

The textured surface generally has a length dimension extending along an x-axis, and a width dimension extending along a z-axis, and a thickness dimension extending along a y-axis. The textured surface has a generally planar portion extending in a first plane that extends along the x-axis and the z-axis. A profile feature can extend outward from the first plane, so as to extend above or below the plane x. A profile feature may extend generally orthogonal to the first plane, or at an angle greater to or less than 90 degrees to the first plane.

The dimensional measurements in reference to the profile features (e.g., length, width, height, diameter, and the like) described herein refer to an average dimensional measurement of profile features in 1 square centimeter in the optical element.

The dimension (e.g., length, width, height, diameter, depending upon the shape of the profile feature) of each profile feature can be within the nanometer to micrometer range. A textured surface can have a profile feature and/or flat area with a dimension of about 10 nanometers to about 500 micrometers. The profile feature can have dimensions in the nanometer range, e.g., from about 10 nanometers to about 1000 nanometers. All of the dimensions of the profile feature (e.g., length, width, height, diameter, depending on the geometry) can be in the nanometer range, e.g., from about 10 nanometers to about 1000 nanometers. The textured surface can have a plurality of profile features having dimensions that are 1 micrometer or less. In this context, the phrase “plurality of the profile features” is meant to mean that about 50 percent or more, about 60 percent or more, about 70 percent or more, about 80 percent or more, about 90 percent or more, or about 99 percent or more of the profile features have a dimension in this range. The profile features can have a ratio of width:height and/or length:height dimensions of about 1:2 and 1:100, or 1:5 and 1:50, or 1:5 and 1:10.

The textured surface can have a profile feature and/or flat area with a dimension within the micrometer range of dimensions. A textured surface can have a profile feature and/or flat area with a dimension of about 1 micrometer to about 500 micrometers. All of the dimensions of the profile feature (e.g., length, width, height, diameter, depending on the geometry) can be in the micrometer range, e.g., from about 1 micrometer to about 500 micrometers. The textured surface can have a plurality of profile features having dimensions that are from about 1 micrometer to about 500 micrometer. In this context, the phrase “plurality of the profile features” is meant to mean that about 50 percent or more, about 60 percent or more, about 70 percent or more, about 80 percent or more, about 90 percent or more, or about 99 percent or more of the profile features have a dimension in this range. The height of the profile features (or depth if depressions) can be about 0.1 and 50 micrometers, about 1 to 5 micrometers, or 2 to 3 micrometers. The profile features can have a ratio of width:height and/or length:height dimensions of about 1:2 and 1:100, or 1:5 and 1:50, or 1:5 and 1:10.

A textured surface can have a plurality of profile features having a mixture of size dimensions within the nanometer to micrometer range (e.g., a portion of the profile features are on the nanometer scale and a portion of the profile features are on the micrometer scale). A textured surface can have a plurality of profile features having a mixture of dimensional ratios. The textured surface can have a profile feature having one or more nanometer-scale projections or depressions on a micrometer-scale projection or depression.

The profile feature can have height and width dimensions that are within a factor of three of each other (0.33w ≤ h ≤ 3w where w is the width and h is the height of the profile feature) and/or height and length dimensions that are within a factor of three of each other (0.33l ≤ h ≤ 3l where l is the length and h is the height of the profile feature). The profile feature can have a ratio of length:width that is from about 1:3 to about 3:1, or about 1:2 to about 2:1, or about 1:1.5 to about 1.5:1, or about 1:1.2 to about 1.2:1, or about 1:1. The width and length of the profile features can be substantially the same or different.

It should be stated that while the broad range of the dimensions of the profile features and protrusions and indentations overlap, these dimensions would not overlap in a particular application. The one or more of the dimensions of the protrusions and indentations would be a factor of 10, 15, 20, 50 or 100 or more than one or more of the dimensions of the profile features.

In another aspect, the textured surface can have a profile feature and/or flat area with at least one dimension in the mid-micrometer range and higher (e.g., greater than 500 micrometers). The profile feature can have at least one dimension (e.g., the largest dimension such as length, width, height, diameter, and the like depending upon the geometry or shape of the profile feature) of greater than 500 micrometers, greater than 600 micrometers, greater than 700 micrometers, greater than 800 micrometers, greater than 900 micrometers, greater than 1000 micrometers, greater than 2 millimeters, greater than 10 millimeters, or more. For example, the largest dimension of the profile feature can range from about 600 micrometers to about 2000 micrometers, or about 650 micrometers to about 1500 micrometers, or about 700 micrometers to about 1000 micrometers. At least one or more of the dimensions of the profile feature (e.g., length, width, height, diameter, depending on the geometry) can be in the micrometer range, while one or more of the other dimensions can be in the nanometer to micrometer range (e.g., less than 500 micrometers, less than 100 micrometers, less than 10 micrometers, or less than 1 micrometer). The textured surface can have a plurality of profile features having at least one dimension that is in the mid-micrometer or more range (e.g., 500 micrometers or more). In this context, the phrase “plurality of the profile features” is meant to mean that about 50 percent or more, about 60 percent or more, about 70 percent or more, about 80 percent or more, about 90 percent or more, or about 99 percent or more of the profile features have at least one dimension that is greater than 500 micrometers. In particular, at least one of the length and width of the profile feature is greater than 500 micrometers or both the length and the width of the profile feature is greater than 500 micrometers. In another example, the diameter of the profile feature is greater than 500 micrometers. In another example, when the profile feature is an irregular shape, the longest dimension is greater than 500 micrometers.

In aspects, the height of the profile features can be greater than 50 micrometers. In this context, the phrase “plurality of the profile features” is meant to mean that about 50 percent or more, about 60 percent or more, about 70 percent or more, about 80 percent or more, about 90 percent or more, or about 99 percent or more of the profile features have at height that is greater than 50 micrometers. The height of the profile feature can be 50 micrometers, about 60 micrometers, about 70 micrometers, about 80 micrometers, about 90 micrometers, or about 100 micrometers to about 60 micrometers, about 70 micrometers, about 80 micrometers, about 90 micrometers, about 100 micrometers, about 150 micrometers, about 250 micrometers, about 500 micrometers or more. For example, the ranges can include 50 micrometers to 500 micrometers, about 60 micrometers to 250 micrometers, about 60 micrometers to about 150 micrometers, and the like. One or more of the other dimensions (e.g., length, width, diameter, or the like) can be in the nanometer to micrometer range (e.g., less than 500 micrometers, less than 100 micrometers, less than 10 micrometers, or less than 1 micrometer). In particular, at least one of the length and width of the profile feature is less than 500 micrometers or both the length and the width of the profile feature is less than 500 micrometers, while the height is greater than 50 micrometers. One or more of the other dimensions (e.g., length, width, diameter, or the like) can be in the micrometer to millimeter range (e.g., greater than 500 micrometers to 10 millimeters).

The dimension (e.g., length, width, height, diameter, depending upon the shape of the profile feature) of each profile feature can be within the nanometer to micrometer range. The textured surface can have a profile feature and/or flat area with a dimension of about 10 nanometers to about 500 micrometers or higher (e.g., about 1 millimeter, about 2 millimeters, about 5 millimeters, or about 10 millimeters). At least one of the dimensions of the profile feature (e.g., length, width, height, diameter, depending on the geometry) can be in the nanometer range (e.g., from about 10 nanometers to about 1000 nanometers), while at least one other dimension (e.g., length, width, height, diameter, depending on the geometry) can be in the micrometer range (e.g., 5 micrometers to 500 micrometers or more (e.g., about 1 to 10 millimeters)). The textured surface can have a plurality of profile features having at least one dimension in the nanometer range (e.g., about 10 to 1000 nanometers) and the other in the micrometer range (e.g., 5 micrometers to 500 micrometers or more). In this context, the phrase “plurality of the profile features” is meant to mean that about 50 percent or more, about 60 percent or more, about 70 percent or more, about 80 percent or more, about 90 percent or more, or about 99 percent or more of the profile features have at least one dimension in the nanometer range and at least one dimension in the micrometer range. In particular, at least one of the length and width of the profile feature is in the nanometer range, while the other of the length and the width of the profile feature is in the micrometer range.

In aspects, the height of the profile features can be greater than 250 nanometers. In this context, the phrase “plurality of the profile features” is meant to mean that about 50 percent or more, about 60 percent or more, about 70 percent or more, about 80 percent or more, about 90 percent or more, or about 99 percent or more of the profile features have at height that is greater than 250 nanometers. The height of the profile feature can be 250 nanometers, about 300 nanometers, about 400 nanometers, or about 500 nanometers, to about 300 nanometers, about 400 nanometers, about 500 nanometers, or about 1000 nanometers or more. For example, the range can be 250 nanometers to about 1000 nanometers, about 300 nanometers to 500 nanometers, about 400 nanometers to about 1000 nanometers, and the like. One or more of the other dimensions (e.g., length, width, diameter, or the like) can be in the micrometer to millimeter range (e.g., greater than 500 micrometers to 10 millimeters). In particular, at least one of the length and width of the profile feature is in the nanometer range (e.g., about 10 to 1000 nanometers) and the other in the micrometer range (e.g., 5 micrometers to 500 micrometers or more), while the height is greater than 250 nanometers.

The profile features can have a certain spatial arrangement. The spatial arrangement of the profile features may be uniform, such as spaced evenly apart or forming a pattern. The spatial arrangement can be random. Adjacent profile features can be about 10 to 500 nanometers apart, about 100 to 1000 nanometers apart, about 1 to 100 micrometers apart or about 5 to 100 micrometers apart. Adjacent profile features can overlap one another or be adjacent one another so little or no flat regions are positioned there between. The desired spacing can depend, at least in part, on the size and/or shape of the profile structures and the desired structural color effect.

The profile features can have a certain cross-sectional shape (with respect to a plane parallel the first plane). The textured surface can have a plurality of profile features having the same or similar cross-sectional shape. The textured surface has a plurality of profile features having a mixture of different cross-sectional shapes. The cross-sectional shapes of the profile features can include polygonal (e.g., square or triangle or rectangle cross section), circular, semi-circular, tubular, oval, random, high and low aspect ratios, overlapping profile features, and the like.

The profile feature (e.g., about 10 nanometers to 500 micrometers) can include an upper, flat surface. The profile feature (e.g., about 10 nanometers to 500 micrometers) can include an upper, concavely curved surface. The concave curved surface may extend symmetrically either side of an uppermost point. The concave curved surface may extend symmetrically across only 50 percent of the uppermost point. The profile feature (e.g., about 10 nanometers to 500 micrometers) can include an upper, convexly curved surface. The curved surface may extend symmetrically either side of an uppermost point. The curved surface may extend symmetrically across only 50 percent of the uppermost point.

The profile feature can include protrusions from the textured surface. The profile feature can include indents (hollow areas) formed in the textured surface. The profile feature can have a smooth, curved shape (e.g., a polygonal cross-section with curved corners).

The profile features (whether protrusions or depressions) can be approximately conical or frusto-conical (i.e. the projections or indents may have horizontally or diagonally flattened tops) or have an approximately part-spherical surface (e.g., a convex or concave surface respectively having a substantially even radius of curvature).

The profile features may have one or more sides or edges that extend in a direction that forms an angle to the first plane of the textured surface. The angle between the first plane and a side or edge of the profile feature is about 45 degrees or less, about 30 degrees or less, about 25 degrees or less, or about 20 degrees or less. The one or more sides or edges may extend in a linear or planar orientation, or may be curved so that the angle changes as a function of distance from the first plane. The profile features may have one or more sides that include step(s) and/or flat side(s). The profile feature can have one or more sides (or portions thereof) that can be orthogonal or perpendicular to the first plane of the textured surface, or extend at an angle of about 10 degrees to 89 degrees to the first plane (90 degrees being perpendicular or orthogonal to the first plane)). The profile feature can have a side with a stepped configuration, where portions of the side can be parallel to the first plane of the textured surface or have an angle of about 1 degrees to 179 degrees (0 degrees being parallel to the first plane)).

The textured surface can have profile features with varying shapes (e.g., the profile features can vary in shape, height, width and length among the profile features) or profile features with substantially uniform shapes and/or dimensions. The structural color produced by the textured surface can be determined, at least in part, by the shape, dimensions, spacing, and the like, of the profile features.

The profile features can be shaped so as to result in a portion of the surface (e.g., about 25 to 50 percent or more) being about normal to the incoming light when the light is incident at the normal to the first plane of the textured surface. The profile features can be shaped so as to result in a portion of the surface (e.g., about 25 to 50 percent or more) being about normal to the incoming light when the light is incident at an angle of up to 45 degrees to the first plane of the textured surface.

The spatial orientation of the profile features on the textured surface can be used to produce the structural color, or to effect the degree to which the structural color shifts at different viewing angles. The spatial orientation of the profile features on the textured surface can be random, a semi-random pattern, or in a set pattern. A set pattern of profile features is a known set up or configuration of profile features in a certain area (e.g., about 50 nanometers squared to about 10 millimeters squared depending upon the dimensions of the profile features (e.g., any increment between about 50 nanometers and about 10 millimeters is included)). A semi-random pattern of profile features is a known set up of profile features in a certain area (e.g., about 50 nanometers squared to 10 millimeters squared) with some deviation (e.g., 1 to 15% deviation from the set pattern), while random profile features are present in the area but the pattern of profile features is discernable. A random spatial orientation of the profile features in an area produces no discernable pattern in a certain area, (e.g., about 50 nanometers squared to 10 millimeters squared).

The spatial orientation of the profile features can be periodic (e.g., full or partial) or non-periodic. A periodic spatial orientation of the profile features is a recurring pattern at intervals. The periodicity of the periodic spatial orientation of the profile features can depend upon the dimensions of the profile features but generally are periodic from about 50 nanometers to 100 micrometers. For example, when the dimensions of the profile features are submicron, the periodicity of the periodic spatial orientation of the profile features can be in the 50 to 500 nanometer range or 100 to 1000 nanometer range. In another example, when the dimensions of the profile features are at the micron level, the periodicity of the periodic spatial orientation of the profile features can be in the 10 to 500 micrometer range or 10 to 1000 micrometer range. Full periodic pattern of profile features indicates that the entire pattern exhibits periodicity, whereas partial periodicity indicates that less than all of the pattern exhibits periodicity (e.g., about 70-99 percent of the periodicity is retained). A non-periodic spatial orientation of profile features is not periodic and does not show periodicity based on the dimensions of the profile features, in particular, no periodicity in the 50 to 500 nanometer range or 100 to 1000 nanometer range where the dimensions are of the profile features are submicron or no periodicity in the 10 to 500 micrometer range or 10 to 1000 micrometer range where the dimensions are of the profile features are in the micron range.

In an aspect, the spatial orientation of the profile features on the textured surface can be set to reduce distortion effects, e.g., caused by the interference of one profile feature with another in regard to the structural color of the article. Since the shape, dimension, relative orientation of the profile features can vary considerably across the textured surface, the desired spacing and/or relative positioning for a particular area (e.g., in the micrometer range or about 1 to 10 square micrometers) having profile features can be appropriately determined. As discussed herein, the shape, dimension, relative orientation of the profile features affect the contours of the reflective layer(s) and/or constituent layer(s), so the dimensions (e.g., thickness), index of refraction, number of layers in the optical element (e.g., reflective layer(s) and constituent layer(s)) are considered when designing the textured side of the texture layer.

The profile features are located in nearly random positions relative to one another across a specific area of the textured surface (e.g., in the micrometer range or about 1 to 10 square micrometers to centimeter range or about 0.5 to 5 square centimeters, and all range increments therein), where the randomness does not defeat the purpose of producing the structural color. In other words, the randomness is consistent with the spacing, shape, dimension, and relative orientation of the profile features, the dimensions (e.g., thickness), index of refraction, and number of layers (e.g., the reflective layer(s), the constituent layer(s), and the like, with the goal to achieve the structural color.

The profile features are positioned in a set manner relative to one another across a specific area of the textured surface to achieve the purpose of producing the structural color. The relative positions of the profile features do not necessarily follow a pattern, but can follow a pattern consistent with the desired structural color. As mentioned above and herein, various parameters related to the profile features, flat areas, and reflective layer(s) and/or the constituent layer can be used to position the profile features in a set manner relative to one another.

The textured surface can include micro and/or nanoscale profile features that can form gratings (e.g., a diffractive grating), photonic crystal structure, a selective mirror structure, crystal fiber structures, deformed matrix structures, spiraled coiled structures, surface grating structures, and combinations thereof. The textured surface can include micro and/or nanoscale profile features that form a grating having a periodic or non-periodic design structure to impart the structural color. The micro and/or nanoscale profile features can have a peak-valley pattern of profile features and/or flat areas to produce the desired structural color. The grading can be an Echelette grating.

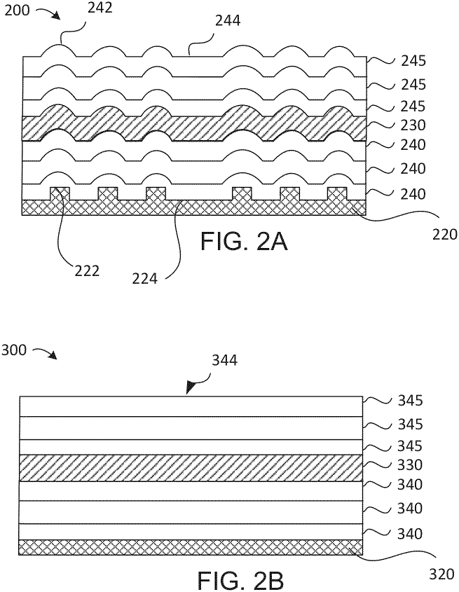

The profile features and the flat areas of the textured surface in the optical element can appear as topographical undulations in each layer (e.g., reflective layer(s) and/or the constituent layer(s)). For example, referring to FIG. 2A, an optical element 200 includes a textured structure 220 having a plurality of profile features 222 and flat areas 224. As described herein, one or more of the profile features 222 can be projections from a surface of the textured structure 220, and/or one or more of the profile features can be depressions in a surface of the textured structure 220 (not shown). One or more constituent layers 240 are disposed on the textured structure 220 and then a reflective layer 230 (optionally present) and one or more constituent layers 245 are disposed on the preceding layers. Adjacent layers (constituent layers and reflective layer) are made of different types of materials. In some embodiments, the resulting topography of the textured structure 220 and the one or more constituent layers 240 and 245 and the reflective layer 230 are not identical, but rather, the one or more constituent layers 240 and 245 and the reflective layer 230 can have elevated or depressed regions 242 which are either elevated or depressed relative to the height of the planar regions 244 and which roughly correspond to the location of the profile features 222 of the textured structure 220. The one or more constituent layers 240 and 245 and the reflective layer 230 have planar regions 244 that roughly correspond to the location of the flat areas 224 of the textured structure 220. Due to the presence of the elevated or depressed regions 242 and the planar regions 244, the resultant overall topography of the one or more constituent layers 240 and 245 and the reflective layer 230 can be that of an undulating or wave-like structure. The dimension, shape, and spacing of the profile features along with the number of layers of the constituent layer, the reflective layer, the thickness of each of the layers, refractive index of each layer, and the type of material, can be used to produce an optical element which results in a particular structural color.

While the textured surface can produce the structural color in some embodiments, or can affect the degree to which the structural color shifts at different viewing angles, in other embodiments, a “textured surface” or surface with texture may not produce the structural color, or may not affect the degree to which the structural color shifts at different viewing angles. The structural color can be produced by the design of the optical element with or without the textured surface. As a result, the optical element can include the textured surface having profile elements of dimensions in the nanometer to millimeter range, but the structural color or the shifting of the structural color is not attributable to the presence or absence of the textured surface. In other words, the optical element imparts the same structural color where or not the textured surface is present The design of the textured surface can be configured to not affect the structural color imparted by the optical element, or not affect the shifting of the structural color imparted by the optical element. The shape of the profile features, dimensions of the shapes, the spatial orientation of the profile features relative to one another, and the like can be selected so that the textured surface does not affect the structural color attributable to the optical element.

In another embodiment, the structural color can be imparted by the optical element without the textured surface. The surface of the layers of the optical element are substantially flat (or substantially three dimensional flat planar surface) or flat (or three dimensional flat planar surface) at the microscale (e.g., about 1 to 500 micrometers) and/or nanoscale (e.g., about 50 to 500 nanometers). In regard to substantially flat or substantially planar the surface can include some minor topographical features (e.g., nanoscale and/or microscale) such as those that might be caused due to unintentional imperfections, slight undulations that are unintentional, other topographical features (e.g., extensions above the plane of the layer or depressions below or into the plane of the layer) caused by the equipment and/or process used and the like that are unintentionally introduced. The topographical features do not resemble profile features of the textured surface. In addition, the substantially flat (or substantially three dimensional flat planar surface) or flat (or three dimensional flat planar surface) may include curvature as the dimensions of the optical element increase, for example about 500 micrometers or more, about 10 millimeter or more, about 10 centimeters or more, depending upon the dimensions of the optical element, as long as the surface is flat or substantially flat and the surface only includes some minor topographical features.

FIG. 2B is a transverse cross-section illustration of a substantially flat (or substantially three-dimensional flat planar surface) or flat (or three-dimensional flat planar surface) optical element 300. The optical element 300 includes one or more constituent layers 340 are disposed on the flat or three-dimensional flat planar surface structure 320 and then a reflective layer 330 (optionally present) and one or more constituent layers 345 are disposed on the preceding layers. Adjacent layers (constituent layers and reflective layer) are made of different types of materials. The material that makes up the constituent layers and the reflective layer, number of layers of the constituent layer, the reflective layer, the thickness of each of the layers, refractive index of each layer, and the like, can produce an optical element which results in a particular structural color.

In an aspect, the surface of the article is a textured surface and the optical element is on the textured surface. Reference to “structural color” includes the first structural color, second structural color, third or more structural colors, and any combination of these. A hue of the structural color, an intensity of the structural color, a viewing angle at which the structural color is visible, or any combination thereof, can be altered by the textured surface (or optionally the textured surface does not alter any one or a combination of these), as determined by comparing the optical element comprising the textured surface of a substantially identical optical element (e.g., material used, thickness, and the like) on a surface of a substantially identical article (e.g., material used, design, and the like) which is free of the textured surface.

In an aspect, the surface of the article is a textured surface and the optical element is on the textured surface. The textured surface reduces (e.g., by about 80% to 99%, about 85 to 99%, about 90 to 99%, about 95 to 99%, or about 98 to 99%) or eliminates shift of the structural color as a viewing angle is varied from a first viewing angle to a second viewing angle, as compared to a substantially identical optical element (e.g., material used, thickness, and the like) on a surface of a substantially identical article (e.g., material used, design, and the like) which is free of the texture.

In an aspect, the surface of the article is a textured surface and the optical element is on the textured surface. A hue of the structural color, an intensity of the structural color, a viewing angle at which the structural color is visible, or any combination thereof, is unaffected by or substantially unaffected (e.g., affected by about 1% or less, about 0.1 to 2%, about 0.1 to 3%, about 0.1 to 5%, or about 0.1 to 7.5%) by the textured surface, as determined by comparing the optical element comprising the textured surface to a substantially identical optical element (e.g., material used, thickness, and the like) on a surface of a substantially identical article (e.g., material used, design, and the like) which is free of the textured surface.

In an aspect, the surface of the article is a textured surface and the optical element is on the textured surface. The shift of the structural color is unaltered by or substantially the same (e.g., by about 80% to 99%, about 85 to 99%, about 90 to 99%, about 95 to 99%, or about 98 to 99% the same) as a viewing angle is varied from a first viewing angle to a second viewing angle, as compared to a substantially identical optical element (e.g., material used, thickness, and the like) on a surface of a substantially identical article (e.g., material used, design, and the like) which is free of the textured surface.

In an aspect, the textured surface includes a plurality of profile features and flat planar areas, where the profile features extend above the flat areas of the textured surface. The dimensions of the profile features, a shape of the profile features, a spacing among the plurality of the profile features, or any combination thereof, in combination with the optical element, affect a hue of the structural color, an intensity of the structural color, a viewing angle at which the structural color is visible, shift of the structural color as a viewing angle is varied from a first viewing angle to a second viewing angle, or any combination thereof.

In an aspect, a hue of the structural color, an intensity of the structural color, a viewing angle at which the structural color is visible, shift of the structural color as a viewing angle is varied from a first viewing angle to a second viewing angle, or any combination thereof, are unaffected or substantially unaffected (e.g., affected by about 1% or less, about 0.1 to 2%, about 0.1 to 3%, about 0.1 to 5%, or about 0.1 to 7.5%) by dimensions of the profile features, a shape of the profile features, a spacing among the plurality of the profile features, or any combination thereof, of the textured surface.

In an aspect, the profile features of the textured surface are in random positions relative to one another within a specific area. The spacing between the profile features, in combination with the optical element, affects a hue of the structural color, an intensity of the structural color, a viewing angle at which the structural color is visible, shift of the structural color as a viewing angle is varied from a first viewing angle to a second viewing angle, or any combination thereof.

In an aspect, a hue of the structural color, an intensity of the structural color, a viewing angle at which the structural color is visible, shift of the structural color as a viewing angle is varied from a first viewing angle to a second viewing angle, or any combination thereof, is unaffected by, or substantially unaffected (e.g., affected by about 1% or less, about 0.1 to 2%, about 0.1 to 3%, about 0.1 to 5%, or about 0.1 to 7.5%) by, spacing between the profile features in combination with the optical element.

In an aspect, the profile features and the flat areas result in at least one layer of the optical element having an undulating topography across the textured surface and where there is a planar region between neighboring profile features that is planar with the flat planar areas of the textured surface.

In an aspect, the dimensions of the planar region relative to the profile features affect a hue of the structural color, an intensity of the structural color, a viewing angle at which the structural color is visible, shift of the structural color as a viewing angle is varied from a first viewing angle to a second viewing angle, or any combination thereof.

In an aspect, a hue of the structural color, an intensity of the structural color, a viewing angle at which the structural color is visible, shift of the structural color as a viewing angle is varied from a first viewing angle to a second viewing angle, or any combination thereof, is unaffected by or substantially unaffected (e.g., affected by about 1% or less, about 0.1 to 2%, about 0.1 to 3%, about 0.1 to 5%, or about 0.1 to 7.5%) by dimensions of the planar region relative to the profile features.

In an aspect, the profile features and the flat areas result in each layer of the optical element having an undulating topography across the textured surface. The undulating topography of the optical element affects a hue of the structural color, an intensity of the structural color, a viewing angle at which the structural color is visible, shift of the structural color as a viewing angle is varied from a first viewing angle to a second viewing angle, or any combination thereof. A hue of the structural color, an intensity of the structural color, a viewing angle at which the structural color is visible, shift of the structural color as a viewing angle is varied from a first viewing angle to a second viewing angle, or any combination thereof, is unaffected by or substantially unaffected (e.g., affected by about 1% or less, about 0.1 to 2%, about 0.1 to 3%, about 0.1 to 5%, or about 0.1 to 7.5%) by the undulating topography of the optical element.

Additional details are provided regarding the polymeric materials referenced herein for example, the polymers described in reference to the article, components of the article, structures, layers, films, bladders, foams, coating, and like the. The polymer can be a thermoset polymer or a thermoplastic polymer. The polymer can be an elastomeric polymer, including an elastomeric thermoset polymer or an elastomeric thermoplastic polymer. The polymer can be selected from: polyurethanes (including elastomeric polyurethanes, thermoplastic polyurethanes (TPUs), and elastomeric TPUs), polyesters, polyethers, polyamides, vinyl polymers (e.g., copolymers of vinyl alcohol, vinyl esters, ethylene, acrylates, methacrylates, styrene, and so on), polyacrylonitriles, polyphenylene ethers, polycarbonates, polyureas, polystyrenes, co-polymers thereof (including polyester-polyurethanes, polyether-polyurethanes, polycarbonate-polyurethanes, polyether block polyamides (PEBAs), and styrene block copolymers), and any combination thereof, as described herein. The polymer can include one or more polymers selected from the group consisting of polyesters, polyethers, polyamides, polyurethanes, polyolefins copolymers of each, and combinations thereof.

The term “polymer” refers to a chemical compound formed of a plurality of repeating structural units referred to as monomers. Polymers often are formed by a polymerization reaction in which the plurality of structural units become covalently bonded together. When the monomer units forming the polymer all have the same chemical structure, the polymer is a homopolymer. When the polymer includes two or more monomer units having different chemical structures, the polymer is a copolymer. One example of a type of copolymer is a terpolymer, which includes three different types of monomer units. The co-polymer can include two or more different monomers randomly distributed in the polymer (e.g., a random co-polymer). Alternatively, one or more blocks containing a plurality of a first type of monomer can be bonded to one or more blocks containing a plurality of a second type of monomer, forming a block copolymer. A single monomer unit can include one or more different chemical functional groups.

Polymers having repeating units which include two or more types of chemical functional groups can be referred to as having two or more segments. For example, a polymer having repeating units of the same chemical structure can be referred to as having repeating segments. Segments are commonly described as being relatively harder or softer based on their chemical structures, and it is common for polymers to include relatively harder segments and relatively softer segments bonded to each other in a single monomeric unit or in different monomeric units. When the polymer includes repeating segments, physical interactions or chemical bonds can be present within the segments or between the segments or both within and between the segments. Examples of segments often referred to as hard segments include segments including a urethane linkage, which can be formed from reacting an isocyanate with a polyol to form a polyurethane. Examples of segments often referred to as soft segments include segments including an alkoxy functional group, such as segments including ether or ester functional groups, and polyester segments. Segments can be referred to based on the name of the functional group present in the segment (e.g., a polyether segment, a polyester segment), as well as based on the name of the chemical structure which was reacted in order to form the segment (e.g., a polyol-derived segment, an isocyanate-derived segment). When referring to segments of a particular functional group or of a particular chemical structure from which the segment was derived, it is understood that the polymer can contain up to 10 mole percent of segments of other functional groups or derived from other chemical structures. For example, as used herein, a polyether segment is understood to include up to 10 mole percent of non-polyether segments.

As previously described, the polymer can be a thermoplastic polymer. In general, a thermoplastic polymer softens or melts when heated and returns to a solid state when cooled. The thermoplastic polymer transitions from a solid state to a softened state when its temperature is increased to a temperature at or above its softening temperature, and a liquid state when its temperature is increased to a temperature at or above its melting temperature. When sufficiently cooled, the thermoplastic polymer transitions from the softened or liquid state to the solid state. As such, the thermoplastic polymer may be softened or melted, molded, cooled, re-softened or re-melted, re-molded, and cooled again through multiple cycles. For amorphous thermoplastic polymers, the solid state is understood to be the “rubbery” state above the glass transition temperature of the polymer. The thermoplastic polymer can have a melting temperature from about 90° C. to about 190° C. when determined in accordance with ASTM D3418-97 as described herein below, and includes all subranges therein in increments of 1 degree. The thermoplastic polymer can have a melting temperature from about 93° C. to about 99° C. when determined in accordance with ASTM D3418-97 as described herein below. The thermoplastic polymer can have a melting temperature from about 112° C. to about 118° C. when determined in accordance with ASTM D3418-97 as described herein below.

The glass transition temperature is the temperature at which an amorphous polymer transitions from a relatively brittle “glassy” state to a relatively more flexible “rubbery” state. The thermoplastic polymer can have a glass transition temperature from about -20° C. to about 30° C. when determined in accordance with ASTM D3418-97 as described herein below. The thermoplastic polymer can have a glass transition temperature (from about -13 degree C to about -7° C. when determined in accordance with ASTM D3418-97 as described herein below. The thermoplastic polymer can have a glass transition temperature from about 17° C. to about 23° C. when determined in accordance with ASTM D3418-97 as described herein below.

The thermoplastic polymer can have a melt flow index from about 10 to about 30 cubic centimeters per 10 minutes (cm3/10 min) when tested in accordance with ASTM D1238-13 as described herein below at 160° C. using a weight of 2.16 kilograms (kg). The thermoplastic polymer can have a melt flow index from about 22 cm3/10 min to about 28 cm3/10 min when tested in accordance with ASTM D1238-13 as described herein below at 160° C. using a weight of 2.16 kg.

The thermoplastic polymer can have a cold Ross flex test result of about 120,000 to about 180,000 cycles without cracking or whitening when tested on a thermoformed plaque of the thermoplastic polymer in accordance with the cold Ross flex test as described herein below. The thermoplastic polymer can have a cold Ross flex test result of about 140,000 to about 160,000 cycles without cracking or whitening when tested on a thermoformed plaque of the thermoplastic polymer in accordance with the cold Ross flex test as described herein below.

The thermoplastic polymer can have a modulus from about 5 megaPascals (MPa) to about 100 MPa when determined on a thermoformed plaque in accordance with ASTM D412-98 Standard Test Methods for Vulcanized Rubber and Thermoplastic Rubbers and Thermoplastic Elastomers-Tension with modifications described herein below. The thermoplastic polymer can have a modulus from about 20 MPa to about 80 MPa when determined on a thermoformed plaque in accordance with ASTM D412-98 Standard Test Methods for Vulcanized Rubber and Thermoplastic Rubbers and Thermoplastic Elastomers-Tension with modifications described herein below.

The polymer can be a thermoset polymer. As used herein, a “thermoset polymer” is understood to refer to a polymer which cannot be heated and melted, as its melting temperature is at or above its decomposition temperature. A “thermoset material” refers to a material which comprises at least one thermoset polymer. The thermoset polymer and/or thermoset material can be prepared from a precursor (e.g., an uncured or partially cured polymer or material) using thermal energy and/or actinic radiation (e.g., ultraviolet radiation, visible radiation, high energy radiation, infrared radiation) to form a partially cured or fully cured polymer or material which no longer remains fully thermoplastic. In some cases, the cured or partially cured polymer or material may remain thermoelastic properties, in that it is possible to partially soften and mold the polymer or material at elevated temperatures and/or pressures, but it is not possible to melt the polymer or material. The curing can be promoted, for example, with the use of high pressure and/or a catalyst. In many examples, the curing process is irreversible since it results in cross-linking and/or polymerization reactions of the precursors. The uncured or partially cured polymers or materials can be malleable or liquid prior to curing. In some cases, the uncured or partially cured polymers or materials can be molded into their final shape, or used as adhesives. Once hardened, a thermoset polymer or material cannot be re-melted in order to be reshaped. The textured surface can be formed by partially or fully curing an uncured precursor material to lock in the textured surface.

### Polyurethane

The polymer can be a polyurethane, such as a thermoplastic polyurethane (also referred to as “TPU”). Alternatively, the polymer can be a thermoset polyurethane. Additionally, polyurethane can be an elastomeric polyurethane, including an elastomeric TPU or an elastomeric thermoset polyurethane. The elastomeric polyurethane can include hard and soft segments. The hard segments can comprise or consist of urethane segments (e.g., isocyanate-derived segments). The soft segments can comprise or consist of alkoxy segments (e.g., polyol-derived segments including polyether segments, or polyester segments, or a combination of polyether segments and polyester segments). The polyurethane can comprise or consist essentially of an elastomeric polyurethane having repeating hard segments and repeating soft segments.

One or more of the polyurethanes can be produced by polymerizing one or more isocyanates with one or more polyols to produce polymer chains having carbamate linkages. The portions of the polyurethane polymer chain formed by the segments derived from isocyanates can be referred to as the hard segments, while the portions derived from polyols can be referred to as soft segments. Optionally,the isocyanates can also be chain extended with one or more chain extenders to bridge two or more isocyanates, increasing the length of the hard segments.

Examples of suitable aliphatic diisocyanates for producing the polyurethane polymer chains include hexamethylene diisocyanate (HDI), isophorone diisocyanate (IPDI), butylenediisocyanate (BDI), bisisocyanatocyclohexylmethane (HMDI), 2,2,4-trimethylhexamethylene diisocyanate (TMDI), bisisocyanatomethylcyclohexane, bisisocyanatomethyltricyclodecane, norbornane diisocyanate (NDI), cyclohexane diisocyanate (CHDI), 4,4′-dicyclohexylmethane diisocyanate (H12MDI), diisocyanatododecane, lysine diisocyanate, and combinations thereof.

The isocyanate-derived segments can include segments derived from aliphatic diisocyanate. A majority of the isocyanate-derived segments can comprise segments derived from aliphatic diisocyanates. At least 90% of the isocyanate-derived segments are derived from aliphatic diisocyanates. The isocyanate-derived segments can consist essentially of segments derived from aliphatic diisocyanates. The aliphatic diisocyanate-derived segments can be derived substantially (e.g., about 50 percent or more, about 60 percent or more, about 70 percent or more, about 80 percent or more, about 90 percent or more) from linear aliphatic diisocyanates. At least 80% of the aliphatic diisocyanate-derived segments can be derived from aliphatic diisocyanates that are free of side chains. The segments derived from aliphatic diisocyanates can include linear aliphatic diisocyanates having from 2 to 10 carbon atoms.

Examples of suitable aromatic diisocyanates for producing the polyurethane polymer chains include toluene diisocyanate (TDI), TDI adducts with trimethyloylpropane (TMP), methylene diphenyl diisocyanate (MDI), xylene diisocyanate (XDI), tetramethylxylylene diisocyanate (TMXDI), hydrogenated xylene diisocyanate (HXDI), naphthalene 1,5-diisocyanate (NDI), 1,5-tetrahydronaphthalene diisocyanate, para-phenylene diisocyanate (PPDI), 3,3′ - dimethyldipheny1-4, 4′ -diisocyanate (DDDI), 4,4 ′-dibenzyl diisocyanate (DBDI), 4-chloro-1,3-phenylene diisocyanate, and combinations thereof. The polymer chains can be substantially free of aromatic groups.

The polyurethane polymer chains can be produced from diisocyanates including HMDI, TDI, MDI, H12 aliphatics, and combinations thereof. For example, the polyurethane can comprise one or more polyurethane polymer chains produced from diisocyanates including HMDI, TDI, MDI, H12 aliphatics, and combinations thereof.

Polyurethane chains which are at least partially crosslinked or which can be crosslinked, can be used in accordance with the present disclosure. It is possible to produce crosslinked or crosslinkable polyurethane chains by reacting multi-functional isocyanates to form the polyurethane. Examples of suitable triisocyanates for producing the polyurethane chains include TDI, HDI, and IPDI adducts with trimethyloylpropane (TMP), uretdiones (i.e., dimerized isocyanates), polymeric MDI, and combinations thereof.

### Polyamides

The polymer can comprise a polyamide, such as a thermoplastic polyamide, or a thermoset polyamide. The polyamide can be an elastomeric polyamide, including an elastomeric thermoplastic polyamide or an elastomeric thermoset polyamide. The polyamide can be a polyamide homopolymer having repeating polyamide segments of the same chemical structure. Alternatively, the polyamide can comprise a number of polyamide segments having different polyamide chemical structures (e.g., polyamide 6 segments, polyamide 11 segments, polyamide 12 segments, polyamide 66 segments, etc.). The polyamide segments having different chemical structure can be arranged randomly, or can be arranged as repeating blocks.

The polyamide can be a co-polyamide (i.e., a co-polymer including polyamide segments and non-polyamide segments). The polyamide segments of the co-polyamide can comprise or consist of polyamide 6 segments, polyamide 11 segments, polyamide 12 segments, polyamide 66 segments, or any combination thereof. The polyamide segments of the co-polyamide can be arranged randomly, or can be arranged as repeating segments. The polyamide segments can comprise or consist of polyamide 6 segments, or polyamide 12 segments, or both polyamide 6 segment and polyamide 12 segments. In the example where the polyamide segments of the co-polyamide include of polyamide 6 segments and polyamide 12 segments, the segments can be arranged randomly. The non-polyamide segments of the co-polyamide can comprise or consist of polyether segments, polyester segments, or both polyether segments and polyester segments. The co-polyamide can be a block co-polyamide, or can be a random co-polyamide. The copolyamide can be formed from the polycondensation of a polyamide oligomer or prepolymer with a second oligomer prepolymer to form a copolyamide (i.e., a co-polymer including polyamide segments. Optionally, the second prepolymer can be a hydrophilic prepolymer.

The polyamide can be a polyamide-containing block co-polymer. For example, the block co-polymer can have repeating hard segments, and repeating soft segments. The hard segments can comprise polyamide segments, and the soft segments can comprise non-polyamide segments. The polyamide-containing block co-polymer can be an elastomeric co-polyamide comprising or consisting of polyamide-containing block co-polymers having repeating hard segments and repeating soft segments. In block co-polymers, including block co-polymers having repeating hard segments and soft segments, physical crosslinks can be present within the segments or between the segments or both within and between the segments.

The polyamide itself, or the polyamide segment of the polyamide-containing block co-polymer can be derived from the condensation of polyamide prepolymers, such as lactams, amino acids, and/or diamino compounds with dicarboxylic acids, or activated forms thereof. The resulting polyamide segments include amide linkages (—(CO)NH—). The term “amino acid” refers to a molecule having at least one amino group and at least one carboxyl group. Each polyamide segment of the polyamide can be the same or different.

The polyamide or the polyamide segment of the polyamide-containing block co-polymer can be derived from the polycondensation of lactams and/or amino acids.

The polyamide can be a thermoplastic polyamide and the constituents of the polyamide block and their proportion can be chosen in order to obtain a melting temperature of less than 150° C., such as a melting point of from about 90° C. to about 135° C. The various constituents of the thermoplastic polyamide block and their proportion can be chosen in order to obtain a melting point of less than 150° C., such as from about and 90° C. to about 135° C.

Exemplary commercially available copolymers include, but are not limited to, those available under the tradenames of “VESTAMID” (Evonik Industries, Essen, Germany); “PLATAMID” (Arkema, Colombes, France), e.g., product code H2694; “PEBAX” (Arkema), e.g., product code “PEBAX MH1657” and “PEBAX MV1074”; “PEBAX RNEW” (Arkema); “GRILAMID” (EMS-Chemie AG, Domat-Ems, Switzerland), or also to other similar materials produced by various other suppliers.

The polyamide can be physically crosslinked through, e.g., nonpolar or polar interactions between the polyamide groups of the polymers. In examples where the polyamide is a copolyamide, the copolyamide can be physically crosslinked through interactions between the polyamide groups, and optionally by interactions between the copolymer groups. When the co-polyamide is physically crosslinked through interactions between the polyamide groups, the polyamide segments can form the portion of the polymer referred to as the hard segment, and copolymer segments can form the portion of the polymer referred to as the soft segment. For example, when the copolyamide is a poly(ether-block-amide), the polyamide segments form the hard segments of the polymer, and polyether segments form the soft segments of the polymer. Therefore, in some examples, the polymer can include a physically crosslinked polymeric network having one or more polymer chains with amide linkages.

The polyamide segment of the co-polyamide can include polyamide-11 or polyamide-12 and the polyether segment can be a segment selected from the group consisting of polyethylene oxide, polypropylene oxide, and polytetramethylene oxide segments, and combinations thereof.

The polyamide can be partially or fully covalently crosslinked, as previously described herein. In some cases, the degree of crosslinking present in the polyamide is such that, when it is thermally processed, e.g., in the form of a yarn or fiber to form the articles of the present disclosure, the partially covalently crosslinked thermoplastic polyamide retains sufficient thermoplastic character that the partially covalently crosslinked thermoplastic polyamide is melted during the processing and re-solidifies. In other cases, the crosslinked polyamide is a thermoset polymer.

### Polyesters

The polymers can comprise a polyester. The polyester can comprise a thermoplastic polyester, or a thermoset polyester. Additionally, the polyester can be an elastomeric polyester, including a thermoplastic polyester or a thermoset elastomeric polyester. The polyester can be formed by reaction of one or more carboxylic acids, or its ester-forming derivatives, with one or more bivalent or multivalent aliphatic, alicyclic, aromatic or araliphatic alcohols or a bisphenol. The polyester can be a polyester homopolymer having repeating polyester segments of the same chemical structure. Alternatively, the polyester can comprise a number of polyester segments having different polyester chemical structures (e.g., polyglycolic acid segments, polylactic acid segments, polycaprolactone segments, polyhydroxyalkanoate segments, polyhydroxybutyrate segments, etc.). The polyester segments having different chemical structure can be arranged randomly, or can be arranged as repeating blocks.

Exemplary carboxylic acids that can be used to prepare a polyester include, but are not limited to, adipic acid, pimelic acid, suberic acid, azelaic acid, sebacic acid, nonane dicarboxylic acid, decane dicarboxylic acid, undecane dicarboxylic acid, terephthalic acid, isophthalic acid, alkyl-substituted or halogenated terephthalic acid, alkyl-substituted or halogenated isophthalic acid, nitro-terephthalic acid, 4,4′-diphenyl ether dicarboxylic acid, 4,4′-diphenyl thioether dicarboxylic acid, 4,4′-diphenyl sulfone-dicarboxylic acid, 4,4′-diphenyl alkylenedicarboxylic acid, naphthalene-2,6-dicarboxylic acid, cyclohexane-1,4-dicarboxylic acid and cyclohexane-1,3-dicarboxylic acid. Exemplary diols or phenols suitable for the preparation of the polyester include, but are not limited to, ethylene glycol, diethylene glycol, 1,3-propanediol, 1,4-butanediol, 1,6-hexanediol, 1,8-octanediol, 1,10-decanediol, 1,2-propanediol, 2,2-dimethyl-1,3-propanediol, 2,2,4-trimethylhexanediol, p-xylenediol, 1,4-cyclohexanediol, 1,4-cyclohexane dimethanol, and bis-phenol A.

The polyester can be a polybutylene terephthalate (PBT), a polytrimethylene terephthalate, a polyhexamethylene terephthalate, a poly-1,4-dimethylcyclohexane terephthalate, a polyethylene terephthalate (PET), a polyethylene isophthalate (PEI), a polyarylate (PAR), a polybutylene naphthalate (PBN), a liquid crystal polyester, or a blend or mixture of two or more of the foregoing.

The polyester can be a co-polyester (i.e., a co-polymer including polyester segments and non-polyester segments). The co-polyester can be an aliphatic co-polyester (i.e., a co-polyester in which both the polyester segments and the non-polyester segments are aliphatic). Alternatively, the co-polyester can include aromatic segments. The polyester segments of the co-polyester can comprise or consist essentially of polyglycolic acid segments, polylactic acid segments, polycaprolactone segments, polyhydroxyalkanoate segments, polyhydroxybutyrate segments, or any combination thereof. The polyester segments of the co-polyester can be arranged randomly, or can be arranged as repeating blocks.

For example, the polyester can be a block co-polyester having repeating blocks of polymeric units of the same chemical structure which are relatively harder (hard segments), and repeating blocks of the same chemical structure which are relatively softer (soft segments). In block co-polyesters, including block co-polyesters having repeating hard segments and soft segments, physical crosslinks can be present within the blocks or between the blocks or both within and between the blocks. The polymer can comprise or consist essentially of an elastomeric co-polyester having repeating blocks of hard segments and repeating blocks of soft segments.

The non-polyester segments of the co-polyester can comprise or consist essentially of polyether segments, polyamide segments, or both polyether segments and polyamide segments. The co-polyester can be a block co-polyester, or can be a random co-polyester. The co-polyester can be formed from the polycondensation of a polyester oligomer or prepolymer with a second oligomer prepolymer to form a block copolyester. Optionally, the second prepolymer can be a hydrophilic prepolymer. For example, the co-polyester can be formed from the polycondensation of terephthalic acid or naphthalene dicarboxylic acid with ethylene glycol, 1,4-butanediol, or 1,3-propanediol. Examples of co-polyesters include polyethylene adipate, polybutylene succinate, poly(3-hydroxbutyrate-co-3-hydroxyvalerate), polyethylene terephthalate, polybutylene terephthalate, polytrimethylene terephthalate, polyethylene napthalate, and combinations thereof. The co-polyamide can comprise or consist of polyethylene terephthalate.

The polyester can be a block copolymer comprising segments of one or more of polybutylene terephthalate (PBT), a polytrimethylene terephthalate, a polyhexamethylene terephthalate, a poly-1,4-dimethylcyclohexane terephthalate, a polyethylene terephthalate (PET), a polyethylene isophthalate (PEI), a polyarylate (PAR), a polybutylene naphthalate (PBN), and a liquid crystal polyester. For example, a suitable polyester that is a block copolymer can be a PET/PEI copolymer, a polybutylene terephthalate/tetraethylene glycol copolymer, a polyoxyalkylenediimide diacid/polybutylene terephthalate copolymer, or a blend or mixture of any of the foregoing.

### Polyolefins

The polymers can comprise or consist essentially of a polyolefin. The polyolefin can be a thermoplastic polyolefin or a thermoset polyolefin. Additionally, the polyolefin can be an elastomeric polyolefin, including a thermoplastic elastomeric polyolefin or a thermoset elastomeric polyolefin. Exemplary polyolefins can include polyethylene, polypropylene, and olefin elastomers (e.g.,metallocene-catalyzed block copolymers of ethylene and α-olefins having 4 to about 8 carbon atoms). The polyolefin can be a polymer comprising a polyethylene, an ethylene-α-olefin copolymer, an ethylene-propylene rubber (EPDM), a polybutene, a polyisobutylene, a poly-4-methylpent-1-ene, a polyisoprene, a polybutadiene, a ethylene-methacrylic acid copolymer, and an olefin elastomer such as a dynamically crosslinked polymer obtained from polypropylene (PP) and an ethylene-propylene rubber (EPDM), and blends or mixtures of the foregoing. Further exemplary polyolefins include polymers of cycloolefins such as cyclopentene or norbornene.

It is to be understood that polyethylene, which optionally can be crosslinked, is inclusive a variety of polyethylenes, including low density polyethylene (LDPE), linear low density polyethylene (LLDPE), (VLDPE) and (ULDPE), medium density polyethylene (MDPE), high density polyethylene (HDPE), high density and high molecular weight polyethylene (HDPE-HMW), high density and ultrahigh molecular weight polyethylene (HDPE-UHMW), and blends or mixtures of any the foregoing polyethylenes. A polyethylene can also be a polyethylene copolymer derived from monomers of monolefins and diolefins copolymerized with a vinyl, acrylic acid, methacrylic acid, ethyl acrylate, vinyl alcohol, and/or vinyl acetate. Polyolefin copolymers comprising vinyl acetate-derived units can be a high vinyl acetate content copolymer, e.g., greater than about 50 weight percent vinyl acetate-derived composition.

The polyolefin can be a mixture of polyolefins, such as a mixture of two or more polyolefins disclosed herein above. For example, a suitable mixture of polyolefins can be a mixture of polypropylene with polyisobutylene, polypropylene with polyethylene (for example PP/HDPE, PP/LDPE) or mixtures of different types of polyethylene (for example LDPE/HDPE).

The polyolefin can be a copolymer of suitable monolefin monomers or a copolymer of a suitable monolefin monomer and a vinyl monomer. Exemplary polyolefin copolymers include ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, propylene/butadiene copolymers, isobutylene/isoprene copolymers, ethylene/alkyl acrylate copolymers, ethylene/alkyl methacrylate copolymers, ethylene/vinyl acetate copolymers and their copolymers with carbon monoxide or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.

The polyolefin can be a polypropylene homopolymer, a polypropylene copolymers, a polypropylene random copolymer, a polypropylene block copolymer, a polyethylene homopolymer, a polyethylene random copolymer, a polyethylene block copolymer, a low density polyethylene (LDPE), a linear low density polyethylene (LLDPE), a medium density polyethylene, a high density polyethylene (HDPE), or blends or mixtures of one or more of the preceding polymers.

The polyolefin can be a polypropylene. The term “polypropylene,” as used herein, is intended to encompass any polymeric composition comprising propylene monomers, either alone or in mixture or copolymer with other randomly selected and oriented polyolefins, dienes, or other monomers (such as ethylene, butylene, and the like). Such a term also encompasses any different configuration and arrangement of the constituent monomers (such as atactic, syndiotactic, isotactic, and the like). Thus, the term as applied to fibers is intended to encompass actual long strands, tapes, threads, and the like, of drawn polymer. The polypropylene can be of any standard melt flow (by testing); however, standard fiber grade polypropylene resins possess ranges of Melt Flow Indices between about 1 and 1000.

The polyolefin can be a polyethylene. The term “polyethylene,” as used herein, is intended to encompass any polymeric composition comprising ethylene monomers, either alone or in mixture or copolymer with other randomly selected and oriented polyolefins, dienes, or other monomers (such as propylene, butylene, and the like). Such a term also encompasses any different configuration and arrangement of the constituent monomers (such as atactic, syndiotactic, isotactic, and the like). Thus, the term as applied to fibers is intended to encompass actual long strands, tapes, threads, and the like, of drawn polymer. The polyethylene can be of any standard melt flow (by testing); however, standard fiber grade polyethylene resins possess ranges of Melt Flow Indices between about 1 and 1000.

The thermoplastic and/or thermosetting material can further comprise one or more processing aids. The processing aid can be a non-polymeric material. These processing aids can be independently selected from the group including, but not limited to, curing agents, initiators, plasticizers, mold release agents, lubricants, antioxidants, flame retardants, dyes, pigments, reinforcing and non-reinforcing fillers, fiber reinforcements, and light stabilizers.

In articles that include a textile, the optical element and the transition region (as noted above, the optical element will be listed but this also includes reference to the transition region) can be disposed onto the textile (e.g., the optical element is likely in the “on its side” configuration unless the textile is thin or otherwise the first side of the optical element can be illuminated). The textile or at least an outer layer of the textile can include a thermoplastic material that the optical element can disposed onto. The textile can be a nonwoven textile, a synthetic leather, a knit textile, or a woven textile. The textile can comprise a first fiber or a first yarn, where the first fiber or the first yarn can include at least an outer layer formed of the first thermoplastic material. A region of the first or second side of the structure onto which the optical element is disposed can include the first fiber or the first yarn in a non-filamentous conformation. The optical element can be disposed onto the textile or the textile can be processed so that the optical element can be disposed onto the textile. The textured surface can be made of or formed from the textile surface. The textile surface can be used to form the textured surface, and either before or after this, the optical element can be applied to the textile.

A “textile” may be defined as any material manufactured from fibers, filaments, or yarns characterized by flexibility, fineness, and a high ratio of length to thickness. Textiles generally fall into two categories. The first category includes textiles produced directly from webs of filaments or fibers by randomly interlocking to construct non-woven fabrics and felts. The second category includes textiles formed through a mechanical manipulation of yarn, thereby producing a woven fabric, a knitted fabric, a braided fabric, a crocheted fabric, and the like.

The terms “filament,” “fiber,” or “fibers” as used herein refer to materials that are in the form of discrete elongated pieces that are significantly longer than they are wide. The fiber can include natural, manmade or synthetic fibers. The fibers may be produced by conventional techniques, such as extrusion, electrospinning, interfacial polymerization, pulling, and the like. The fibers can include carbon fibers, boron fibers, silicon carbide fibers, titania fibers, alumina fibers, quartz fibers, glass fibers, such as E, A, C, ECR, R, S, D, and NE glasses and quartz, or the like. The fibers can be fibers formed from synthetic polymers capable of forming fibers such as poly(ether ketone), polyimide, polybenzoxazole, poly(phenylene sulfide), polyesters, polyolefins (e.g., polyethylene, polypropylene), aromatic polyamides (e.g., an aramid polymer such as para-aramid fibers and meta-aramid fibers), aromatic polyimides, polybenzimidazoles, polyetherimides, polytetrafluoroethylene, acrylic, modacrylic, poly(vinyl alcohol), polyamides, polyurethanes, and copolymers such as polyether-polyurea copolymers, polyester-polyurethanes, polyether block amide copolymers, or the like. The fibers can be natural fibers (e.g., silk, wool, cashmere, vicuna, cotton, flax, hemp, jute, sisal). The fibers can be man-made fibers from regenerated natural polymers, such as rayon, lyocell, acetate, triacetate, rubber, and poly(lactic acid).

The fibers can have an indefinite length. For example, man-made and synthetic fibers are generally extruded in substantially continuous strands. Alternatively, the fibers can be staple fibers, such as, for example, cotton fibers or extruded synthetic polymer fibers can be cut to form staple fibers of relatively uniform length. The staple fiber can have a have a length of about 1 millimeter to 100 centimeters or more as well as any increment therein (e.g., 1 millimeter increments).

The fiber can have any of a variety of cross-sectional shapes. Natural fibers can have a natural cross-section, or can have a modified cross-sectional shape (e.g., with processes such as mercerization). Man-made or synthetic fibers can be extruded to provide a strand having a predetermined cross-sectional shape. The cross-sectional shape of a fiber can affect its properties, such as its softness, luster, and wicking ability. The fibers can have round or essentially round cross sections. Alternatively, the fibers can have non-round cross sections, such as flat, oval, octagonal, rectangular, wedge-shaped, triangular, dog-bone, multi-lobal, multi-channel, hollow, core-shell, or other shapes.

The fiber can be processed. For example, the properties of fibers can be affected, at least in part, by processes such as drawing (stretching) the fibers, annealing (hardening) the fibers, and/or crimping or texturizing the fibers.

In some cases a fiber can be a multi-component fiber, such as one comprising two or more co-extruded polymeric materials. The two or more co-extruded polymeric materials can be extruded in a core-sheath, islands-in-the-sea, segmented-pie, striped, or side-by-side configuration. A multi-component fiber can be processed in order to form a plurality of smaller fibers (e.g., microfibers) from a single fiber, for example, by remove a sacrificial material.

The fiber can be a carbon fiber such as TARIFYL produced by Formosa Plastics Corp. of Kaohsiung City, Taiwan, (e.g., 12,000, 24,000, and 48,000 fiber tows, specifically fiber types TC-35 and TC-35R), carbon fiber produced by SGL Group of Wiesbaden, Germany (e.g., 50,000 fiber tow), carbon fiber produced by Hyosung of Seoul, South Korea, carbon fiber produced by Toho Tenax of Tokyo, Japan, fiberglass produced by Jushi Group Co., LTD of Zhejiang, China (e.g., E6, 318, silane-based sizing, filament diameters 14, 15, 17, 21,and 24 micrometers), and polyester fibers produced by Amann Group of Bonningheim, Germany (e.g., SERAFILE 200/2 non-lubricated polyester filament and SERAFILE COMPHIL 200/2 lubricated polyester filament).

A plurality of fibers includes 2 to hundreds or thousands or more fibers. The plurality of fibers can be in the form of bundles of strands of fibers, referred to as tows, or in the form of relatively aligned staple fibers referred to as sliver and roving. A single type fiber can be used either alone or in combination with one or more different types of fibers by co-mingling two or more types of fibers. Examples of co-mingled fibers include polyester fibers with cotton fibers, glass fibers with carbon fibers, carbon fibers with aromatic polyimide (aramid) fibers, and aromatic polyimide fibers with glass fibers.

As used herein, the term “yarn” refers to an assembly formed of one or more fibers, wherein the strand has a substantial length and a relatively small cross-section, and is suitable for use in the production of textiles by hand or by machine, including textiles made using weaving, knitting, crocheting, braiding, sewing, embroidery, or ropemaking techniques. Thread is a type of yarn commonly used for sewing.

Yarns can be made using fibers formed of natural, man-made and synthetic materials. Synthetic fibers are most commonly used to make spun yarns from staple fibers, and filament yarns. Spun yarn is made by arranging and twisting staple fibers together to make a cohesive strand. The process of forming a yarn from staple fibers typically includes carding and drawing the fibers to form sliver, drawing out and twisting the sliver to form roving, and spinning the roving to form a strand. Multiple strands can be plied (twisted together) to make a thicker yarn. The twist direction of the staple fibers and of the plies can affect the final properties of the yarn. A filament yarn can be formed of a single long, substantially continuous filament, which is conventionally referred to as a “monofilament yarn,” or a plurality of individual filaments grouped together. A filament yarn can also be formed of two or more long, substantially continuous filaments which are grouped together by grouping the filaments together by twisting them or entangling them or both. As with staple yarns, multiple strands can be plied together to form a thicker yarn.

Once formed, the yarn can undergo further treatment such as texturizing, thermal or mechanical treating, or coating with a material such as a synthetic polymer. The fibers, yarns, or textiles, or any combination thereof, used in the disclosed articles can be sized. Sized fibers, yarns, and/or textiles are coated on at least part of their surface with a sizing composition selected to change the absorption or wear characteristics, or for compatibility with other materials. The sizing composition facilitates wet-out and wet-through of the coating or resin upon the surface and assists in attaining desired physical properties in the final article. An exemplary sizing composition can comprise, for example, epoxy polymers, urethane-modified epoxy polymers, polyester polymers, phenol polymers, polyamide polymers, polyurethane polymers, polycarbonate polymers, polyetherimide polymers, polyamideimide polymers, polystylylpyridine polymers, polyimide polymers bismaleimide polymers, polysulfone polymers, polyethersulfone polymers, epoxy-modified urethane polymers, polyvinyl alcohol polymers, polyvinyl pyrrolidone polymers, and mixtures thereof.

Two or more yarns can be combined, for example, to form composite yarns such as single- or double-covered yarns, and corespun yarns. Accordingly, yarns may have a variety of configurations that generally conform to the descriptions provided herein.

The yarn can comprise at least one thermoplastic material (e.g., one or more of the fibers can be made of thermoplastic material). The yarn can be made of a thermoplastic material. The yarn can be coated with a layer of a material such as a thermoplastic material.

The linear mass density or weight per unit length of a yarn can be expressed using various units, including denier (D) and tex. Denier is the mass in grams of 9000 meters of yarn. The linear mass density of a single filament of a fiber can also be expressed using denier per filament (DPF). Tex is the mass in grams of a 1000 meters of yarn. Decitex is another measure of linear mass, and is the mass in grams for a 10,000 meters of yarn.

As used herein, tenacity is understood to refer to the amount of force (expressed in units of weight, for example: pounds, grams, centinewtons or other units) needed to break a yarn (i.e., the breaking force or breaking point of the yarn), divided by the linear mass density of the yarn expressed, for example, in (unstrained) denier, decitex, or some other measure of weight per unit length. The breaking force of the yarn is determined by subjecting a sample of the yarn to a known amount of force, for example, using a strain gauge load cell such as an INSTRON brand testing system (Norwood, MA, USA). Yarn tenacity and yarn breaking force are distinct from burst strength or bursting strength of a textile, which is a measure of how much pressure can be applied to the surface of a textile before the surface bursts.

Generally, in order for a yarn to withstand the forces applied in an industrial knitting machine, the minimum tenacity required is approximately 1.5 grams per Denier. Most yarns formed from commodity polymeric materials generally have tenacities in the range of about 1.5 grams per Denier to about 4 grams per Denier. For example, polyester yarns commonly used in the manufacture of knit uppers for footwear have tenacities in the range of about 2.5 to about 4 grams per Denier. Yarns formed from commodity polymeric materials which are considered to have high tenacities generally have tenacities in the range of about 5 grams per Denier to about 10 grams per Denier. For example, commercially available package dyed polyethylene terephthalate yarn from National Spinning (Washington, NC, USA) has a tenacity of about 6 grams per Denier, and commercially available solution dyed polyethylene terephthalate yarn from Far Eastern New Century (Taipei, Taiwan) has a tenacity of about 7 grams per Denier. Yarns formed from high performance polymeric materials generally have tenacities of about 11 grams per Denier or greater. For example, yarns formed of aramid fiber typically have tenacities of about 20 grams per Denier, and yarns formed of ultra-high molecular weight polyethylene (UHMWPE) having tenacities greater than 30 grams per Denier are available from Dyneema (Stanley, NC, USA) and Spectra (Honeywell-Spectra, Colonial Heights, VA, USA).

Various techniques exist for mechanically manipulating yarns to form a textile. Such techniques include, for example, interweaving, intertwining and twisting, and interlooping. Interweaving is the intersection of two yarns that cross and interweave at right angles to each other. The yarns utilized in interweaving are conventionally referred to as “warp” and “weft.” A woven textile includes include a warp yarn and a weft yarn. The warp yarn extends in a first direction, and the weft strand extends in a second direction that is substantially perpendicular to the first direction. Intertwining and twisting encompasses various procedures, such as braiding and knotting, where yarns intertwine with each other to form a textile. Interlooping involves the formation of a plurality of columns of intermeshed loops, with knitting being the most common method of interlooping. The textile may be primarily formed from one or more yarns that are mechanically-manipulated, for example, through interweaving, intertwining and twisting, and/or interlooping processes, as mentioned above.

The textile can be a nonwoven textile. Generally, a nonwoven textile or fabric is a sheet or web structure made from fibers and/or yarns that are bonded together. The bond can be a chemical and/or mechanical bond, and can be formed using heat, solvent, adhesive or a combination thereof. Exemplary nonwoven fabrics are flat or tufted porous sheets that are made directly from separate fibers, molten plastic and/or plastic film. They are not made by weaving or knitting and do not necessarily require converting the fibers to yarn, although yarns can be used as a source of the fibers. Nonwoven textiles are typically manufactured by putting small fibers together in the form of a sheet or web (similar to paper on a paper machine), and then binding them either mechanically (as in the case of felt, by interlocking them with serrated or barbed needles, or hydro-entanglement such that the inter-fiber friction results in a stronger fabric), with an adhesive, or thermally (by applying binder (in the form of powder, paste, or polymer melt) and melting the binder onto the web by increasing temperature). A nonwoven textile can be made from staple fibers (e.g., from wetlaid, airlaid, carding/crosslapping processes), or extruded fibers (e.g., from meltblown or spunbond processes, or a combination thereof), or a combination thereof. Bonding of the fibers in the nonwoven textile can be achieved with thermal bonding (with or without calendering), hydro-entanglement, ultrasonic bonding, needlepunching (needlefelting), chemical bonding (e.g., using binders such as latex emulsions or solution polymers or binder fibers or powders), meltblown bonding (e.g., fiber is bonded as air attenuated fibers intertangle during simultaneous fiber and web formation).

Now having described various aspects of the present disclosure, additional discussion is provided regarding when the optical element and the transition region (as noted above, the optical element will be listed but this also includes reference to the transition region) is used in conjunction with a bladder. The bladder can be unfilled, partially inflated, or fully inflated when the optical element is disposed onto the bladder. The bladder is a bladder capable of including a volume of a fluid. An unfilled bladder is a fluid-fillable bladder and a filled bladder that has been at least partially inflated with a fluid at a pressure equal to or greater than atmospheric pressure. When disposed onto or incorporated into an article of footwear, apparel, or sports equipment, the bladder is generally, at that point, a fluid-filled bladder. The fluid be a gas or a liquid. The gas can include air, nitrogen gas (N₂), or other appropriate gas.

The bladder can have a gas transmission rate for nitrogen gas, for example, where a bladder wall of a given thickness has a gas transmission rate for nitrogen that is at least about ten times lower than the gas transmission rate for nitrogen of a butyl rubber layer of substantially the same thickness as the thickness of the bladder described herein. The bladder can have a first bladder wall having a first bladder wall thickness (e.g., about 0.1 to 40 mils). The bladder can have a first bladder wall that can have a gas transmission rate (GTR) for nitrogen gas of less than about 15 cm³/m²·atm·day, less than about 10 m³/m²·atm·day, less than about 5 cm³/m²·atm·day, less than about 1 cm³/m²·atm·day (e.g., from about 0.001 cm³/m²·atm·day to about 1 cm³/m²·atm·day, about 0.01 cm³/m²·atm·day to about 1 cm³/m²·atm·day or about 0.1 cm³/m²·atm·day to about 1 cm³/m²·atm·day) for an average wall thickness of 20 mils. The bladder can have a first bladder wall having a first bladder wall thickness, where the first bladder wall has a gas transmission rate of 15 cm³/m²·atm·day or less for nitrogen for an average wall thickness of 20 mils.

In an aspect, the bladder has a bladder wall having an interior-facing side and an exterior (or externally)-facing side, where the interior (or internally)-facing side defines at least a portion of an interior region of the bladder. The optical element having a first side and a second opposing side can be disposed on the exterior-facing side of the bladder, the interior-facing side of the bladder, or both. The optical element can be disposed in-line or on its side. Where the optical element is disposed on its side, the optical element is disposed on the interior-facing side or the exterior-facing side on its side configuration as opposed to in line configuration.

The exterior-facing side of the bladder, the interior-facing side of the bladder, or both can optionally include a plurality of topographical structures (or profile features) extending from the exterior-facing side of the bladder wall, the interior-facing side of the bladder, or both, where the first side or the second side of the optical element is disposed on the exterior-facing side of the bladder wall and covering the plurality of topographical structures, the interior-facing side of the bladder wall and covering the plurality of topographical structures, or both, and wherein the optical element imparts a structural color to the bladder wall.

In a particular aspect, the bladder can include a top wall operably secured to the footwear upper, a bottom wall opposite the top wall, and one or more sidewalls extending between the top wall and the bottom wall of the inflated bladder. The top wall, the bottom wall, and the one or more sidewalls collectively define an interior region of the inflated bladder, and wherein the one or more sidewalls each comprise an exterior-facing side. The optical element having a first side and a second opposing side can be disposed on the exterior-facing side of the bladder, the interior-facing side of the bladder, or both. Optionally, the exterior-facing side of the bladder, the interior-facing side of the bladder, or both can include a plurality of topographical structures extending from the exterior-facing side of the bladder wall, the interior-facing side of the bladder, or both, where the first side or the second side of the optical element is disposed on the exterior-facing side of the bladder wall and covering the plurality of topographical structures, the interior-facing side of the bladder wall and covering the plurality of topographical structures, or both, and wherein the optical element imparts a structural color to the bladder wall.

An accepted method for measuring the relative permeance, permeability, and diffusion of inflated bladders is ASTM D-1434-82-V. See, e.g., U.S. Pat. No. 6,127,026, which is incorporated by reference as if fully set forth herein. According to ASTM D-1434-82-V, permeance, permeability and diffusion are measured by the following formulae:

Permeance

$$\begin{matrix}\left(\text{quantity of gas}\right) / \left[\left(\text{area}\right) \times \left(\text{time}\right) \times \left(\text{pressure} \text{difference}\right)\right] = \\ \text{permeance} \left(\text{GTR}\right) / \left(\text{pressure difference}\right) \\ = {\text{cm}}^{3} {\text{/m}}^{2} \cdot \text{atm} \cdot \text{day} \left(\text{i} \text{.e} \text{.,} \text{24} \text{hours}\right)\end{matrix}$$

Permeability

$$\begin{matrix}\left[\left(\text{quantity of gas}\right) \times \left(\text{film} \text{thickness}\right)\right] \\ \left[\left(\text{area}\right) \times \left(\text{time}\right) \times \left(\text{pressure} \text{difference}\right)\right] = \text{permeability} \\ \left[\left(\text{GTR}\right) \times \left(\text{film} \text{thickness}\right)\right] / \left(\text{pressure difference}\right) \\ = \left[\left({\text{cm}}^{3}\right) \left(\text{mil}\right)\right] {\text{/m}}^{2} \cdot \text{atm} \cdot \text{day} \left(\text{i} \text{.e} \text{.,} \text{24} \text{hours}\right)\end{matrix}$$

Diffusion at one atmosphere

$$\begin{matrix}\left(\text{quantity of gas}\right) / \left[\left(\text{area}\right) \times \left(\text{time}\right)\right] = \text{GTR} \\ = {\text{cm}}^{3} {\text{/m}}^{2} \cdot \text{day} \left(\text{i} \text{.e} \text{.,} \text{24} \text{hours}\right)\end{matrix}$$

The bladder can include a bladder wall that includes a film including at least one polymeric layer or at least two or more polymeric layers. Each of the polymeric layers can be about 0.1 to 40 mils in thickness.

The polymeric layer can be formed of polymer material such as a thermoplastic material as described above and herein and can be the thermoplastic layer upon which the optical element can be disposed and optionally upon which the textured layer can be disposed or the thermoplastic layer can be used to form the textured layer, and the like. The thermoplastic material can include an elastomeric material, such as a thermoplastic elastomeric material. The thermoplastic materials can include thermoplastic polyurethane (TPU), such as those described above and herein. The thermoplastic materials can include polyester-based TPU, polyether-based TPU, polycaprolactone-based TPU, polycarbonate-based TPU, polysiloxane-based TPU, or combinations thereof. Non-limiting examples of thermoplastic material that can be used include: “PELLETHANE” 2355-85ATP and 2355-95AE (Dow Chemical Company of Midland, MI., USA), “ELASTOLLAN” (BASF Corporation, Wyandotte, MI, USA) and “ESTANE” (Lubrizol, Brecksville, OH, USA), all of which are either ester or ether based. Additional thermoplastic material can include those described in U.S. Pat. Nos. 5,713,141; 5,952,065; 6,082,025; 6,127,026; 6,013,340; 6,203,868; and 6,321,465, which are incorporated herein by reference.

The polymeric layer can be formed of one or more of the following: ethylene-vinyl alcohol copolymers (EVOH), poly(vinyl chloride), polyvinylidene polymers and copolymers (e.g., polyvinylidene chloride), polyamides (e.g., amorphous polyamides), acrylonitrile polymers (e.g., acrylonitrile-methyl acrylate copolymers), polyurethane engineering plastics, polymethylpentene resins, ethylene-carbon monoxide copolymers, liquid crystal polymers, polyethylene terephthalate, polyether imides, polyacrylic imides, and other polymeric materials known to have relatively low gas transmission rates. Blends and alloys of these materials as well as with the TPUs described herein and optionally including combinations of polyimides and crystalline polymers, are also suitable. For instance, blends of polyimides and liquid crystal polymers, blends of polyamides and polyethylene terephthalate, and blends of polyamides with styrenics are suitable.

Specific examples of polymeric materials of the polymeric layer can include acrylonitrile copolymers such as “BAREX” resins, available from Ineos (Rolle, Switzerland); polyurethane engineering plastics such as “ISPLAST” ETPU available from Lubrizol (Brecksville, OH, USA); ethylene-vinyl alcohol copolymers marketed under the tradenames “EVAL” by Kuraray (Houston, TX, USA), “SOARNOL” by Nippon Gohsei (Hull, England), and “SELAR OH” by DuPont (Wilmington, DE, USA); polyvinylidiene chloride available from S.C. Johnson (Racine, WI, USA) under the tradename “SARAN”, and from Solvay (Brussels, Belgium) under the tradename “IXAN”; liquid crystal polymers such as “VECTRA” from Celanese (Irving, TX, USA) and “XYDAR” from Solvay; “MDX6” nylon, and amorphous nylons such as “NOVAMID” X21 from Koninklijke DSM N.V (Heerlen, Netherlands), “SELAR PA” from DuPont; polyetherimides sold under the tradename “ULTEM” by SABIC (Riyadh, Saudi Arabia); poly(vinyl alcohol)s; and polymethylpentene resins available from Mitsui Chemicals (Tokyo, Japan) under the tradename “TPX”.

Each polymeric layer of the film can be formed of a thermoplastic material which can include a combination of thermoplastic polymers. In addition to one or more thermoplastic polymers, the thermoplastic material can optionally include a colorant, a filler, a processing aid, a free radical scavenger, an ultraviolet light absorber, and the like. Each polymeric layer of the film can be made of a different of thermoplastic material including a different type of thermoplastic polymer.

The bladder can be made by applying heat, pressure and/or vacuum to a film. In this regard, the optical element and optionally the textured layer, and the like can be disposed, formed from, or the like prior to, during, and/or after these steps. The bladder (e.g., one or more polymeric layers) can be formed using one or more polymeric materials, and forming the bladder using one or more processing techniques including, for example, extrusion, blow molding, injection molding, vacuum molding, rotary molding, transfer molding, pressure forming, heat sealing, casting, low-pressure casting, spin casting, reaction injection molding, radio frequency (RF) welding, and the like. The bladder can be made by co-extrusion followed by heat sealing or welding to give an inflatable bladder, which can optionally include one or more valves (e.g., one way valves) that allows the bladder to be filled with the fluid (e.g., gas).

Now having described the optical element, transition region, and the optional textured surface, and methods of making the article are now described. In an aspect, the method includes forming layers using one or more techniques described herein.

In general, the method includes forming the optical element in a layer-by-layer manner on a surface of an article such as a textile, film, fiber, or monofilament yarn, where the surface can optionally be the textured surface. The limits of the deposition process can form the transition region or abrasion forces can be intentional applied (or the transition region can be formed by abrasion forces at a later time). Another embodiment of the present disclosure includes disposing the optical element (that was already formed) on the substrate.

The method can include forming the optical element(s) on the surface of the article in a layer-by-layer manner in one or more areas, where an area without an optical element can be optionally be included (e.g., covered by a mask).

The transition region of the optical element can be formed by masking at least a portion of the surface of the substrate. Masking can include disposing, positioning, or applying a masking element onto a surface of the substrate or a certain distance (e.g., nanometers, micrometers, millimeters, or centimeters away based on the desired design and goal) from the substrate. Subsequently, the at least a portion of the surface of the article can be unmasked (e.g., removing the masking element). The masking element can include traditional masking element or can include a film, a fiber, a filament, or a yarn.

In an aspect, the masking step can include directly contacting the surface with the masking element during the disposing of the layers. Subsequently, removing the masking element comprises exposing the optical element. The masking element can be affixed to the surface of the substrate with an adhesive, for example.

In another aspect, masking can include disposing the optical element at a distance from the surface of the substrate and between the surface of the substrate and a source disposing the optical element, such that, during the disposing, the masking element partially blocks a portion of the surface of the substrate, or casts a shadow onto a portion of the surface of the substrate (e.g., this process may be used form the transition region). The masking element can be disposed or positioned at least 1 millimeter away from the surface of the substrate during the disposing of the layers. Optionally, the distance from the surface of the substrate to the masking element can vary during the disposing; or the distance from the surface of the substrate to the masking element can be substantially constant during the disposition of the layers.

The method can provide for the layers of the optical element being formed on the textured surface. Alternatively, the textured surface can be formed in/on the layer adjacent the surface of the article, and then the remaining layers are disposed thereon to form the optical element and the transitional region. As described herein, the optical element can be formed in a layer-by-layer manner, where each layer has a different index of refraction. As each layer is formed the undulations and flat regions are altered. The combination of the optional textured surface (e.g., dimensions, shape, and/or spacing of the profile elements) and the layers of the optical element (e.g., number of layers, thickness of layers, material of the layers) and the resultant undulations and planar areas impart the structural color when exposed to visible light. The method includes optionally forming a protective layer over the optical element to protect the optical element. Each layer of the optical element can be formed in turn, where each layer can be formed then after an appropriate amount of time, additional processing, cooling, or the like, the next layer of the optical element can be formed.

Measurements for visible light transmittance and visible light reflectance were performed using a Shimadzu UV-2600 Spectrometer (Shimadzu Corporation, Japan). The spectrometer was calibrated using a standard prior to the measurements. The incident angle for all measurements was zero.

The visible light transmittance was the measurement of visible light (or light energy) that was transmitted through a sample material when visible light within the spectral range of 300 nanometers to 800 nanometers was directed through the material. The results of all transmittance over the range of 300 nanometers to 800 nanometers was collected and recorded. For each sample, a minimum value for the visible light transmittance was determined for this range.

The visible light reflectance was a measurement of the visible light (or light energy) that was reflected by a sample material when visible light within the spectral range of 300 nanometers to 800 nanometers was directed through the material. The results of all reflectance over the range of 300 nanometers to 800 nanometers was collected and recorded. For each sample, a minimum value for the visible light reflectance was determined for this range.

It should be emphasized that the above-described aspects of the present disclosure are merely possible examples of implementations, and are set forth only for a clear understanding of the principles of the disclosure. Many variations and modifications may be made to the above-described aspects of the disclosure without departing substantially from the spirit and principles of the disclosure. All such modifications and variations are intended to be included herein within the scope of this disclosure.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1 percent to about 5 percent” should be interpreted to include not only the explicitly recited concentration of about 0.1 weight percent to about 5 weight percent but also include individual concentrations (e.g., 1 percent, 2 percent, 3 percent, and 4 percent) and the sub-ranges (e.g., 0.5 percent, 1.1 percent, 2.2 percent, 3.3 percent, and 4.4 percent) within the indicated range. The term “about” can include traditional rounding according to significant figures of the numerical value. In addition, the phrase “about ‘x’ to ‘y’” includes “about ‘x’ to about ‘y’”.

The term “providing”, such as for “providing an article” and the like, when recited in the claims, is not intended to require any particular delivery or receipt of the provided item. Rather, the term “providing” is merely used to recite items that will be referred to in subsequent elements of the claim(s), for purposes of clarity and ease of readability.

Many variations and modifications may be made to the above-described aspects. All such modifications and variations are intended to be included herein within the scope of this disclosure and protected by the following claims.

We claim:

1. An article comprising:
a substrate on at least a portion of an exterior-facing surface of the article, the substrate having a first surface and an opposing second surface, wherein the first surface of the substrate includes a first substrate area, a second substrate area, and a third substrate area, each of which is distinct from the other, wherein the first substrate area has a first substrate area color;
an optical element comprising two or more optical layers, wherein the optical element is disposed on the first surface of the substrate in the second substrate area and the third substrate area, wherein the optical element includes an optical element main body disposed on the third substrate area and a transition region disposed on the second substrate area, wherein the optical element main body imparts a main body color to the third substrate area and the transition region imparts a transition region color to the second substrate area, and wherein the main body color is a first structural color; and
wherein the main body color and the transition region color differ in at least one of hue, value, and chroma when illuminated under the same lighting conditions at the same observation angle, or
wherein the main body color and the transition region color differ in at least one of hue, value and chroma when illuminated under the same lighting conditions at different two different observation angles at least 60 degrees apart, or both.

2. The article of claim 1, wherein the difference in at least one of the hue, the value, and the chroma of the main body color and the transition region color are detectable when the article is viewed by someone with 20/20 visual acuity from a distance of about 1 meter from the article.

3. The article of claim 2, wherein the transition region color is a second structural color.

4. The article of claim 3, wherein the transition region of the optical element includes at least one less optical layer than the main body of the optical element, or the transition region includes at least one optical layer having a thinner cross-sectional height than a corresponding optical layer of the main body optical element, or both.

5. The article of claim 3, wherein the first substrate area color differs from the main body color, or differs from the transition region color, or differs from both the main body color and the transition region color, in at least one of hue, value and chroma.

6. The article of claim 1, wherein the first substrate area abuts the second substrate area and the third substrate area abuts the second substrate area on the side opposite of the first substrate area.

7. The article of claim 1, wherein the second substrate area is spaced apart from the third substrate area, wherein the article includes exposed first substrate area is between the first substrate area and the second substrate area.

8. The article of claim 1, wherein the transition region includes at least two fewer optical layers than the main body of the optical element.

9. The article of claim 1, wherein the transition region includes only one optical layer.

10. The article of claim 1, wherein the transition region is less than 1 millimeter wide.

11. The article of claim 1, wherein the transition region is about 1 to 3 millimeters wide.

12. The article of claim 1, wherein the transition region includes a first transition region and a second transition region along the length of the transition region, wherein first transition region and the second transition region are different in one or more of the following: the number of layers, the thickness of the layers, the width of the layers.

13. The article of claim 1, wherein the transition region includes a first transition region and a second transition region, wherein the first transition region has a first transition region color and a second transition region has a second transition region color, wherein the first transition region color and the second transition region color differ in a hue, a value, a chroma, or any combination thereof when viewed by someone with 20 20 visual acuity from a distance of about 1 meter from the article under the same lighting conditions and from the same observation angle.

14. The article of claim 1, wherein the first transition region has a first transition sector that has a first transition sector color, wherein the first transition region has a second transition sector that has a second transition sector color, wherein a first side of the first transition sector abuts the main body of the optical element and the second transition sector is on a second side of the first transition sector that is opposite the first side of the first transition sector, wherein the first transition sector color and the second transition sector color are different in a hue, a value, a chroma, or any combination thereof when viewed by someone with 20 20 visual acuity from a distance of about 1 meter from the article under the same lighting conditions and from the same observation angle.

15. The article of claim 1, wherein the surface of the article is made of a material is selected from: a thermoplastic polymer or, a thermoset polymer.

16. The article of claim 1, wherein the optical element is an inorganic optical element.

17. The article of claim 1, wherein the optical element is organic optical element.

18. The article of claim 1, wherein the optical element main body has 4 to 20 layers.

19. A method of making an article, comprising: disposing the optical element of claim 1 onto the surface of the article.

20. An article comprising: a product of the method of claim 19.
